(19) United States
(12) Patent Application Publication
(10) Pub. No.: US 2024/0322676 A1
(43) Pub. Date: Sep. 26, 2024

(54) POWER CONVERTER INTEGRATED CIRCUIT

(71) Applicant: Cirrus Logic International Semiconductor Ltd., Edinburgh (GB)

(72) Inventors: Seunguk YANG, Gyeonggi-do (KR); Seungjae BAEK, Seoul (KR); SeHyung JEON, Seoul (KR)

(73) Assignee: Cirrus Logic International Semiconductor Ltd., Edinburgh (GB)

(21) Appl. No.: 18/188,270

(22) Filed: Mar. 22, 2023

(51) Int. Cl. H02M 3/07; H02J 7/00

(52) U.S. Cl. CPC H02M 3/07; H02J 7/007; H02J 50/10; H02J 2207/20

(57) ABSTRACT

A power converter integrated circuit comprising: a switch network having coupling nodes for coupling the switch network to: a first capacitor; a second capacitor, a third capacitor; and an inductor, wherein the power converter integrated circuit is operable in a first forward mode as switched capacitor power converter circuitry and in a second forward mode as inductive converter circuitry, wherein: in the first forward mode, the switch network is operative to: couple the first and second capacitors in series in a first phase of operation; and couple the second capacitor and the third capacitor in parallel in a second phase of operation; and in the second forward mode, the switch network is operative to: couple the first and second capacitors in series and couple a series combination of the inductor and the third capacitor in parallel with the second capacitor in a phase of operation; and couple the first and second capacitors in parallel with the series combination of the inductor and the third capacitor in a subsequent phase of operation.

### FIELD OF THE INVENTION

The present disclosure relates to a power converter integrated circuit, and in particular to a power converter integrated circuit for use in a battery charging system of a portable electronic device.

### BACKGROUND

Portable electronic devices such as smartphones, tablet and laptop computers are typically powered by a rechargeable battery or battery pack. Such devices typically also include charging circuitry for charging the battery or battery pack from an external power supply such as a USB (Universal Serial Bus) charging device or a mains adapter that converts a mains AC voltage from a domestic electrical outlet to a DC voltage that can be used by the charging circuitry.

An increasing number of such portable electronic devices support wireless charging, i.e. the ability to charge the device battery or battery pack from an external supply without requiring a physical (e.g. plug and socket) connection between the device and an external power supply. In such devices power can be transferred to the device from a wireless charger (e.g. a mat or pad) by means of inductive coupling between a transmitting coil of the wireless charger and a coil of the charging circuitry of the device.

Some such devices also support “reverse wireless charging”, which is the ability of the device to transfer electrical power to another device without requiring a physical connection between the power-supplying device and the power-receiving device. In such devices this transfer of power is typically achieved by means of inductive coupling between a coil of the power-supplying device and a coil of the charging circuitry of the power-receiving device. As will be appreciated, in devices that support reverse wireless charging, the coil of the charging circuitry is used as a receiving coil to receive power from a charger when the device is being charged, and is used as transmitting coil to transmit power when the device is transferring power to another device.

### SUMMARY

According to a first aspect, the invention provides a power converter integrated circuit comprising: a switch network having coupling nodes for coupling the switch network to: a first capacitor; a second capacitor, a third capacitor; and an inductor, wherein the power converter integrated circuit is operable in a first forward mode as switched capacitor power converter circuitry and in a second forward mode as inductive converter circuitry, wherein: in the first forward mode, the switch network is operative to: couple the first and second capacitors in series in a first phase of operation; and couple the second capacitor and the third capacitor in parallel in a second phase of operation; and in the second forward mode, the switch network is operative to: couple the first and second capacitors in series and couple a series combination of the inductor and the third capacitor in parallel with the second capacitor in a phase of operation; and couple the first and second capacitors in parallel with the series combination of the inductor and the third capacitor in a subsequent phase of operation.

The switch network may be operable with a duty cycle of less than 0.5 in the second forward mode.

The switch network may be operative to couple the inductor in parallel with the output capacitor in a further phase of operation.

The switch network may be operable with a duty cycle greater than 0.5 in the second forward mode.

The switch network may be operative to decouple the series combination of the inductor and the third capacitor from the first and second capacitors in a further phase of operation.

The switch network may be operable with a fixed duty cycle of 0.5 in the first forward mode.

The power converter integrated circuit may be operable in a first reverse mode as switched capacitor converter circuitry and in a second reverse mode as inductive boost

In operation of the power converter integrated circuit in the first reverse mode, the switch network may be operative to: couple the second capacitor and the third capacitor in parallel in a first phase of operation; and couple the second capacitor and the third capacitor in series in a second phase of operation.

In operation of the power converter integrated circuit in the first reverse mode, the switch network may be operative to: couple the first and second capacitors and the third capacitor in parallel in a first phase of operation; and couple the first capacitor in series with a parallel combination of the flying capacitor and the third capacitor in a second phase of operation.

The switch network may be operable with a fixed duty cycle of 0.5 in the first reverse mode.

In operation of the power converter integrated circuit in the second reverse mode, the switch network may be operative to: couple the first and second capacitors in parallel with the series combination of the inductor and the third capacitor in a phase of operation; and couple the first and second capacitors in series and couple the series combination of the inductor and the third capacitor in parallel with the second capacitor in a subsequent phase of operation.

The switch network may be operable with a duty cycle of less than 0.5 in the second reverse mode.

The switch network may be operative to couple the inductor in parallel with the third capacitor in a subsequent phase of operation.

The switch network may be operable with a duty cycle greater than 0.5 in the second reverse mode.

The switch network may be operative to decouple the series combination of the inductor and the third capacitor from the first and second capacitors in a further phase of operation.

The switch network may comprise first to ninth switches. In use of the power converter integrated circuit it may be that: the first switch is coupled between a reference voltage supply node of the switch network and the second switch; the second switch is coupled between the first switch and the third switch; the third switch is coupled between the second switch and the fourth switch; the fourth switch is coupled between the third switch and a switch network input node; the fifth switch is coupled between the reference voltage supply node of the switch network and the sixth switch; the sixth switch is coupled between the fifth switch and the seventh switch; the seventh switch is coupled between the sixth switch and a switch network node between the second switch and the third switch; the eighth switch is coupled between the switch network node between the second switch and the third switch and a first terminal of the inductor; the ninth switch is coupled between the first terminal of the inductor and the reference voltage supply node of the switch network; a first terminal of the first capacitor is coupled to a first switch network node between the third and fourth switches; a second terminal of the first capacitor is coupled to a second switch network node between the first and second switches; a first terminal of the second capacitor is coupled to the switch network node between the second switch and the third switch; a second terminal of the second capacitor is coupled to a third switch network node between the fifth and sixth switches; a second terminal of the inductor is couplable to an output node of the power converter integrated circuit; and the third capacitor is coupled to the output node of the power converter integrated circuit.

The seventh switch may comprise a first MOSFET device and a second MOSFET device, wherein a source terminal of the first MOSFET device is coupled to a source terminal of the second MOSFET device such that an anode of a body diode of the first MOSFET device is coupled to an anode of a body diode of the second MOSFET device.

The switch network ay comprises first to eleventh switches and may further comprise a set of one or more coupling nodes for coupling the switch network to a fourth capacitor. In use of the power converter integrated circuit, it may be that: the first switch is coupled between a reference voltage supply node of the switch network and the second switch; the second switch is coupled between the first switch and the third switch; the third switch is coupled between the second switch and the fourth switch; the fourth switch is coupled between the third switch and a switch network input node; the fifth switch is coupled between the reference voltage supply node of the switch network and the sixth switch; the sixth switch is coupled between the fifth switch and the seventh switch; the seventh switch is coupled between the sixth switch and the eighth switch; the eighth switch is coupled between the seventh switch and a switch network node between the second switch and the third switch; the ninth switch is coupled between the switch network node between the second switch and the third switch and a first terminal of the inductor; the tenth switch is coupled between the first terminal of the inductor and the reference voltage supply node of the switch network; the eleventh switch is coupled between the switch network input node and the first terminal of the inductor; a first terminal of the first capacitor is coupled to a first switch network node between the third and fourth switches; a second terminal of the first capacitor is coupled to a second switch network node between the first and second switches; a first terminal of the second capacitor is coupled to a third switch network node between the seventh and eighth switches; a second terminal of the second capacitor is coupled to a fourth switch network node between the fifth and sixth switches; a second terminal of the inductor is couplable to an output node of the power converter integrated circuit; the third capacitor is coupled to the output node of the power converter integrated circuit; and the fourth capacitor is coupled to the switched network node between the second switch and the third switch and a first terminal of the inductor.

The eighth switch and/or the ninth switch may comprise a first MOSFET device and a second MOSFET device, wherein a source terminal of the first MOSFET device is coupled to a source terminal of the second MOSFET device such that an anode of a body diode of the first MOSFET device is coupled to an anode of a body diode of the second MOSFET device.

The power converter integrated circuit may further comprise an input switch coupled between an input node of the power converter integrated circuit and the switch network.

According to a second aspect, the invention provides power converter circuitry comprising switched capacitor power converter circuitry and inductive buck or inductive boost converter circuitry, the power converter circuitry comprising: a switch network configured to be coupled, in use of the power converter circuitry to: first and second flying capacitors; an output capacitor; and an inductor, wherein, in use of the power converter circuitry, the switch network, the first and second flying capacitors and the output capacitor are common to both the switched capacitor power converter circuitry and the inductive buck or inductive boost converter circuitry.

According to a third aspect, the invention provides a battery charging system comprising the power converter integrated circuit of the first aspect or the second aspect.

According to a fourth aspect, the invention provides a host device comprising the power converter integrated circuit of the first aspect or the second aspect, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the invention will now be described, strictly by way of example only, with reference to the accompanying drawings, of which:

FIG. 1a is schematic representation of a charging system of a portable electronic device;

FIG. 1b is a schematic representation of switched capacitor converter circuitry suitable for use in the charging system of FIG. 1a;

FIG. 1c is a schematic representation of inductive buck converter circuitry suitable for use in the charging system of FIG. 1a;

FIG. 1d is a schematic representation of alternative switched capacitor converter circuitry suitable for use in the charging system of FIG. 1a;

FIG. 2 is a schematic representation of power converter circuitry according to the present disclosure;

FIG. 3 illustrates a switch arrangements for one or more of the switches of the power converter circuitry of the present disclosure when the power converter circuitry is used as a forward 3-level inductive buck converter;

FIGS. 4a-4b illustrate operation of the circuitry of FIG. 2 as a forward switched capacitor power converter with a 3:1 input voltage to output voltage ratio;

FIGS. 5a-5b illustrate operation of the circuitry of FIG. 2 as a forward switched capacitor power converter with a 2:1 input voltage to output voltage ratio;

FIGS. 6a-6d illustrate operation of the circuitry of FIG. 2 as a forward three-level inductive buck converter with a duty cycle of less than 0.5;

FIGS. 7a-7d illustrate operation of the circuitry of FIG. 2 as a forward three-level inductive buck converter with a duty cycle greater than 0.5;

FIGS. 8a-8b illustrate operation of the circuitry of FIG. 2 as a reverse switched capacitor power converter with a 1:3 input voltage to output voltage ratio;

FIGS. 9a-9b illustrate operation of the circuitry of FIG. 2 as a reverse switched capacitor power converter with a 1:2 input voltage to output voltage ratio;

FIGS. 10a-10d illustrate operation of the circuitry of FIG. 2 as a reverse three-level inductive boost converter with a duty cycle of less than 0.5;

FIGS. 11a-11d illustrate operation of the circuitry of FIG. 2 as a reverse three-level inductive boost converter with a duty cycle greater than 0.5;

FIG. 12 is a schematic representation of alternative power converter circuitry according to the present disclosure;

FIGS. 13a-13b illustrate operation of the circuitry of FIG. 12 as a forward switched capacitor power converter with a 4:1 input voltage to output voltage ratio;

FIGS. 14a-14b illustrate operation of the circuitry of FIG. 12 as a forward switched capacitor power converter with a 2:1 input voltage to output voltage ratio;

FIGS. 15a-15d illustrate operation of the circuitry of FIG. 12 as a forward three-level inductive buck converter with a duty cycle of less than 0.5;

FIGS. 16a-16d illustrate operation of the circuitry of FIG. 12 as a forward three-level inductive buck converter with a duty cycle greater than 0.5;

FIGS. 17a-17b illustrate operation of the circuitry of FIG. 12 as a reverse switched capacitor power converter with a 1:4 input voltage to output voltage ratio;

FIGS. 18a-18b illustrate operation of the circuitry of FIG. 12 as a reverse switched capacitor power converter with a 1:2 input voltage to output voltage ratio;

FIGS. 19a-19d illustrate operation of the circuitry of FIG. 12 as a reverse three-level inductive boost converter with a duty cycle of less than 0.5; and

FIGS. 20a-20d illustrate operation of the circuitry of FIG. 12 as a reverse three-level inductive boost converter with a duty cycle greater than 0.5.

### DETAILED DESCRIPTION

A common strategy charging a battery or battery pack (hereinafter referred to as a battery, for conciseness) in a portable electronic device uses two distinct stages. In a first stage a fast charging approach is used, in which a constant voltage is supplied to the battery to charge it until a first threshold battery voltage or state of charge is reached. When the threshold battery voltage or state of charge has been reached, the first stage ends, and a second stage commences. In the second stage a constant voltage-constant current (CC-CV) approach is used, in which a constant voltage and a constant current are supplied to the battery to charge it, until a second threshold battery voltage or state of charge is reached, at which point the charging process ends.

To implement a two-stage charging strategy of this kind, the charging circuitry of the device typically includes switched capacitor power converter circuitry to generate the constant voltage required for the first, fast charging stage, and inductive buck converter circuitry to generate the constant voltage and constant current required for the second, CC-CV charging stage.

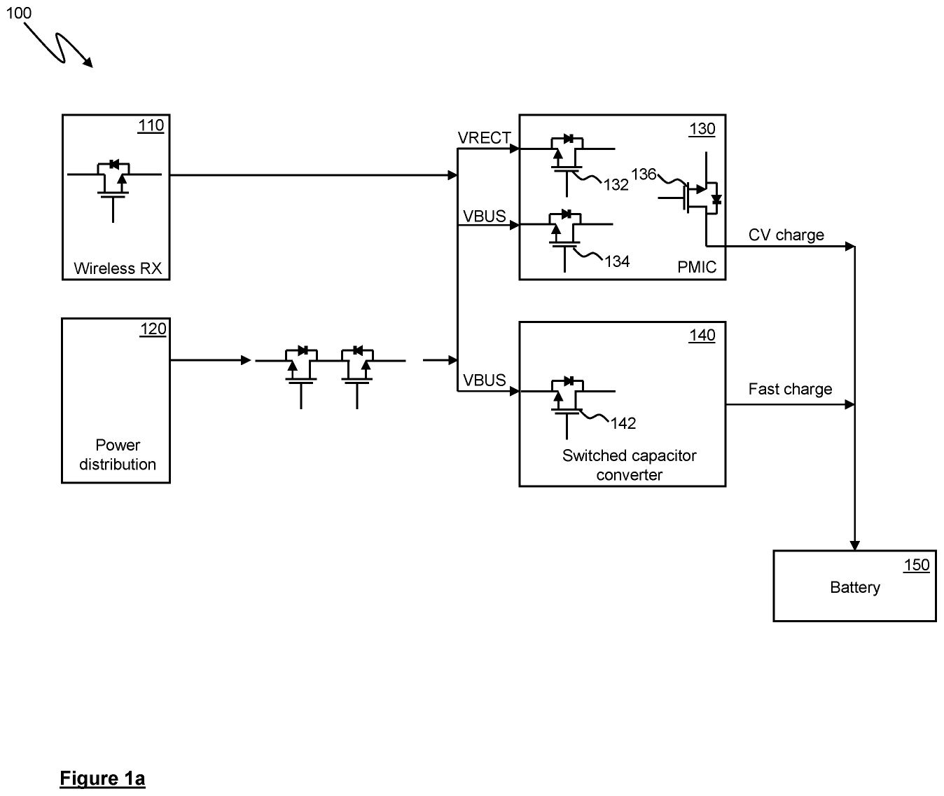

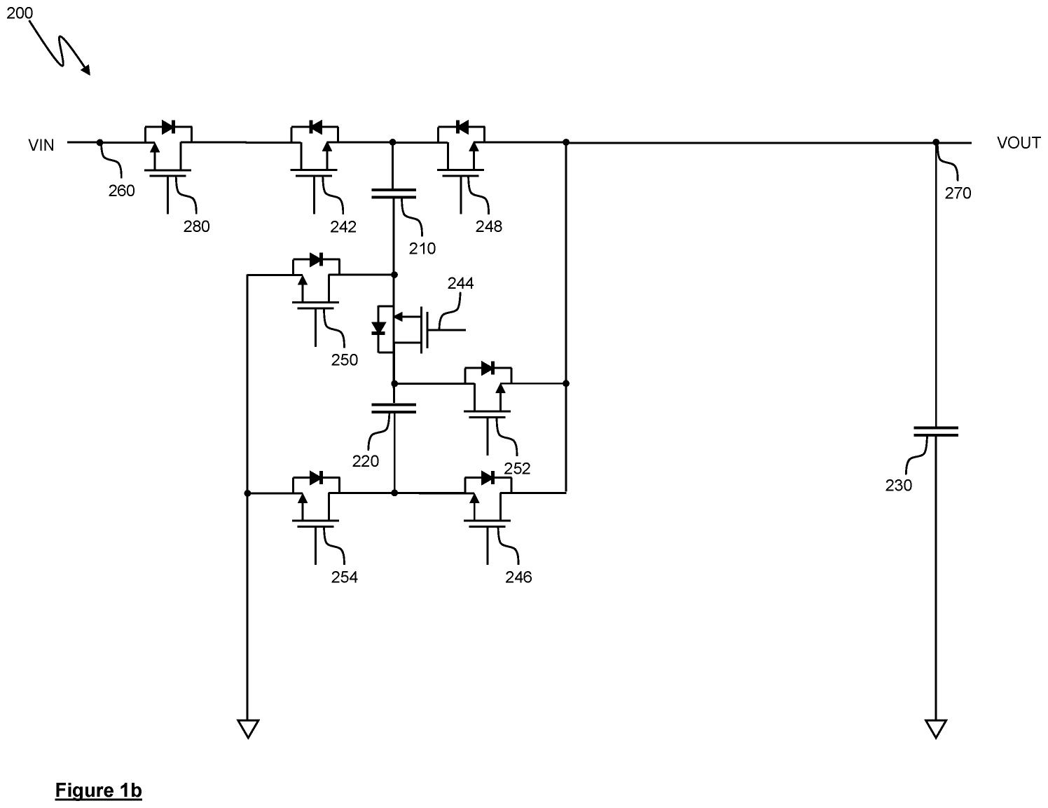

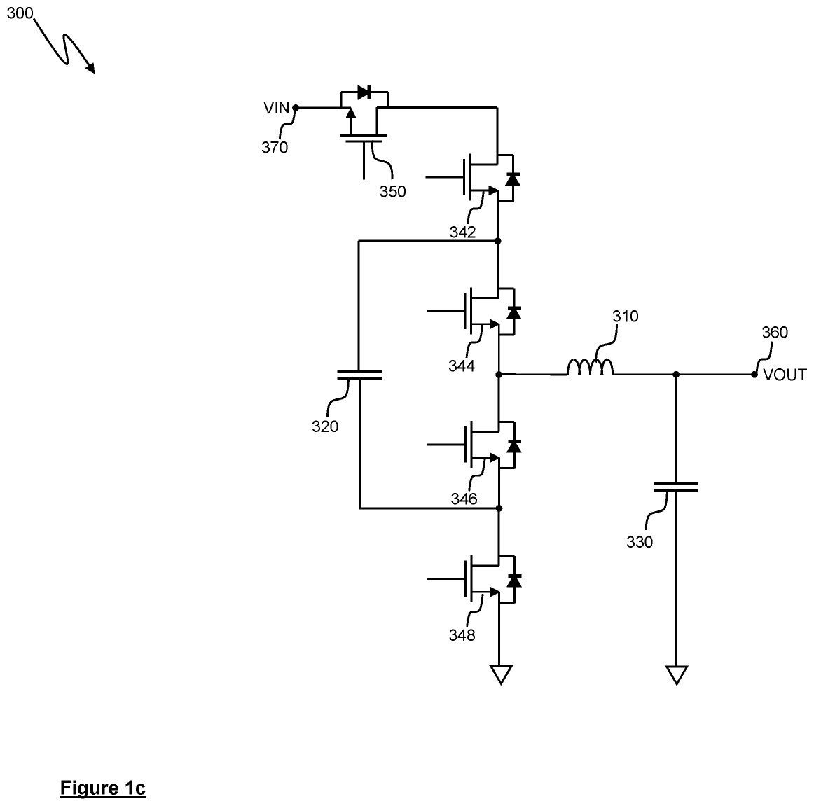

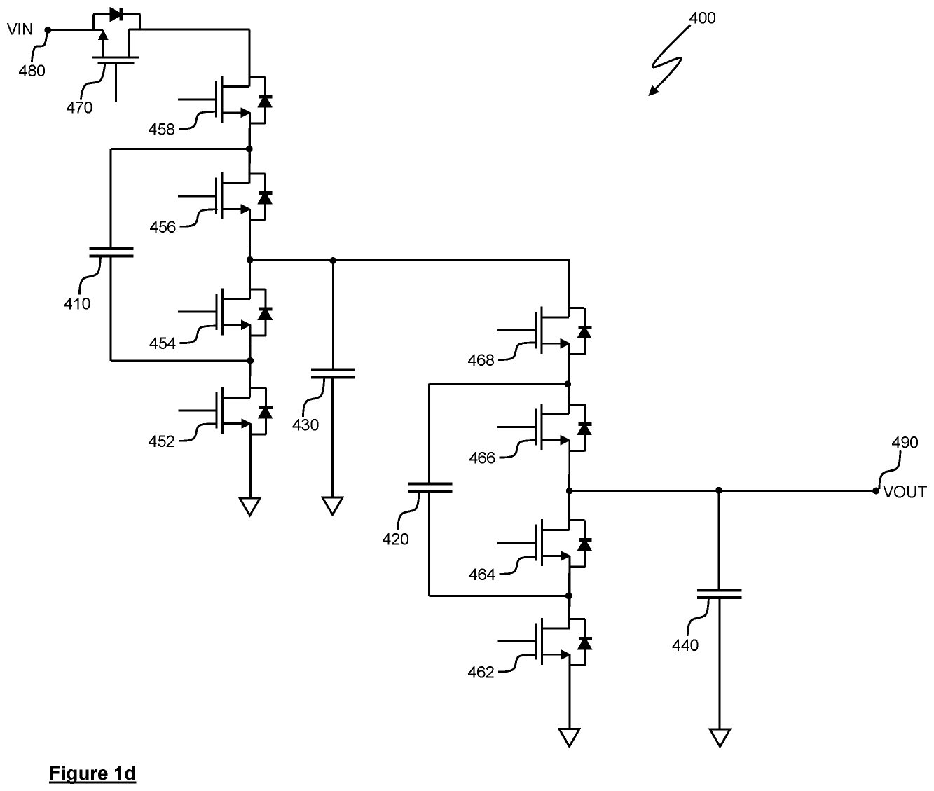

FIG. 1a is a schematic diagram illustrating an example charging system having charging circuitry including switched-capacitor power converter circuitry and inductive buck converter circuitry.

The charging system in this example (shown generally at 100 in FIG. 1a) includes wireless power receiving circuitry 110, which is configured to receive power from a wireless charging device such as a charging pad, mat or the like, and to output a rectified voltage VRECT. The rectified voltage VRECT may have a magnitude of the order of 15V DC, for example.

The charging system 100 further includes power distribution circuitry 120 configured to receive power from an external source such as a USB (Universal Serial Bus) interface and to output a DC bus voltage VBUS. The DC bus voltage VBUS may have a magnitude of the order of 15V, for example.

The charging system 100 further includes a power management integrated circuit (PMIC) 130, which implements 2-level or 3-level inductive buck converter circuitry for converting the rectified voltage VRECT and the DC bus voltage VBUS to a lower voltage magnitude (e.g. 5V) suitable for charging a battery 150 in a constant voltage-constant current (CC-CV) charging mode. 3-level inductive buck converter circuitry is generally more efficient than 2-level inductive buck converter circuitry, and may thus be preferred for use in the charging system 100 of FIG. 1a.

The PMIC 130 includes a first leakage blocking transistor 132, which in the illustrated example is a MOSFET device having a body diode that blocks reverse current flow from the PMIC 130 to the wireless power receiving circuitry 110. The PMIC 130 further includes a second leakage blocking transistor 134, which in the illustrated example is a MOSFET device having a body diode that blocks reverse current flow from the PMIC 130 to the power distribution circuitry 120. The first and second leakage blocking transistors 132, 134 thus prevent discharge of the battery 150 into the wireless power receiving circuitry 110 or the power distribution circuitry 120.

The PMIC 130 further includes a battery controller transistor 136 (which in the illustrated example is a MOSFET device) which is turned on when the charging system 100 is operating in the CC-CV charging mode to allow current flow from the PMIC 130 to the battery 150. This has the effect of reducing the efficiency of the inductive buck converter circuitry implemented by the PMIC, because some power is dissipated as heat in the on-resistance (e.g. the drain to source resistance) of the battery controller transistor 136.

The charging system 100 further includes switched capacitor power converter circuitry 140 configured to convert the rectified voltage VRECT and the DC bus voltage VBUS to a lower voltage magnitude (e.g. 5V) suitable for charging the battery 150 in a fast charging mode. In contrast to the PMIC 130, in use of the charging system 100, an output node of the switched capacitor power converter circuitry 140 is coupled directly to the battery 150, to prevent unnecessary power losses (as heat) arising from the on resistance (e.g. the drain to source resistance) of the battery controller transistor 136.

The switched capacitor power converter circuitry 140 includes a leakage blocking transistor 142, which in the illustrated example is a MOSFET device having a body device that blocks reverse current flow from the switched capacitor power converter circuitry 140 to the wireless power receiving circuitry 110 and the power distribution circuitry 120, thus preventing discharge of the battery 150 into the wireless power receiving circuitry 110 or the power distribution circuitry 120.

In use, the charging system 100 initially operates in a fast charging mode in which the battery 150 is charged to a first predetermined threshold level (e.g. 80% or 85% of its nominal or rated terminal voltage) by the switched capacitor power converter circuitry 140.

When the battery has reached the first predetermined threshold level, the charging system 100 switches into a CC-CV mode in which the switched capacitor power converter circuitry 140 is turned off or disabled and the PMIC 130 supplies a constant current and constant voltage to the battery 150, via the battery controller transistor 136 (which is turned on).

When the battery 150 has reached a second predefined threshold level (e.g. when the battery 150 has reached its nominal or rated terminal voltage) the battery controller transistor 136 is turned off, such that the PMIC 130 can no longer supply a charging current to the battery 150. Thus, charging of the battery 150 stops.

When the battery 150 is not being charged, leakage from the battery 150 to the wireless power receiving circuitry 110 and/or the power distribution circuitry 120 is prevented by the leakage blocking transistors 132, 134, 142.

The wireless power receiving circuitry 110 includes a coil for wirelessly receiving power from the wireless charging device (charging pad, mat or the like). As will be appreciated, a temperature of the coil is related to the current flowing through it. Thus, to avoid excessive heat dissipation in the coil (which could adversely affect the performance, stability or safety of the battery 150), the current flowing through the coil should be minimised. To achieve this, the switched capacitor power converter circuitry 140 may have a relatively high input voltage to output voltage ratio.

However, the use of a relatively high input voltage to output voltage ratio in the switched capacitor power converter circuitry 140 in the charging system 100 of FIG. 1 prevents integration of the switched capacitor power converter circuitry 140 and the PMIC 130 in a single integrated circuit. Thus, in a typical charging system of the kind shown in FIG. 1, the PMIC 130 and the switched capacitor power converter circuitry 140 are implemented as separate integrated circuits.

FIG. 1b is a schematic diagram illustrating example switched capacitor power converter circuitry suitable for use as the switched capacitor power converter circuitry 140 in the charging system 100 of FIG. 1a.

The switched capacitor power converter circuitry, shown generally at 200 in FIG. 1b, includes a first flying capacitor 210, a second flying capacitor 220 and an output capacitor 230. The switched capacitor power converter circuitry 200 further includes a switch network comprising, in this example, first to seventh switches 242-254 (which in this example are MOSFET devices), which can be selectively opened and closed to couple the first and second flying capacitors 210, 220 to an input node 260 and an output node 270 of the switched capacitor power converter circuitry 200 to generate an output voltage VOUT at a desired magnitude from an input voltage VIN. The switched capacitor power converter circuitry 200 further includes an input switch 280 (which in this example is a MOSFET device) that is operable to activate and deactivate the switched capacitor power converter circuitry 200 by selectively coupling the first switch 242 to, and decoupling the first switch 242 from, the input node 260 at which the input voltage VIN is received.

In this example the switched capacitor power converter circuitry 200 is operable with an input voltage to output voltage ratio of 2:1 or 3:1, such that the magnitude of the output voltage VOUT is either one half of the magnitude of the input voltage or one-third of the magnitude of the magnitude of the input voltage VIN.

As can be seen from FIG. 1b, in this example the switched capacitor power converter circuitry 200 includes seven switches (switches 242-254 of the switch network) for coupling the flying capacitors 210, 220 to the input and output nodes 260, 270, a further switch (input switch 280) for controlling an operational state (activated/deactivated) of the switched capacitor power converter circuitry 200, and three capacitors (first and second flying capacitors 210, 220 and output capacitor 230).

FIG. 1c is a schematic diagram illustrating inductive buck converter circuitry suitable for use as the inductive buck converter circuitry implemented by the PMIC 130 in the system of FIG. 1a.

The inductive buck converter circuitry, shown generally at 300 in FIG. 1c, includes an inductor 310, a flying capacitor 320 and an output capacitor 330. The inductive buck converter circuitry 300 further includes a switch network comprising, in this example, first to fourth switches 342-348 (which in this example are MOSFET devices) for selectively coupling the inductor 310 to the flying capacitor 320 or to an output node 360 of the inductive buck converter circuitry 300. The inductive buck converter circuitry 300 also includes an input switch 350 (which in this example is a MOSFET device) that is operable to activate and deactivate the inductive buck converter circuitry 300 by selectively coupling the first switch 342 to, and decoupling the first switch 342 from, an input node 370 at which the input voltage VIN is received.

As can be seen from FIG. 1c, in this example the inductive buck converter circuitry 300 includes four switches (switches 342-348 of the switch network) for coupling the inductor 310 to the flying capacitor 320 or the output node 360, a further switch (input switch 350) for controlling an operational state (activated/deactivated) of the inductive buck converter circuitry 300, and two capacitors (flying capacitor 320 and output capacitor 330).

Although not shown in FIG. 1c, as those of ordinary skill in the art will be aware, the inductive buck converter circuitry 300 also requires additional control circuitry to ensure that the voltage of the flying capacitor 320 remains balanced.

Thus, in a charging system of the kind shown in FIG. 1 in which the PMIC 130 and the switched capacitor power converter circuitry 140 are provided as separate circuits of the kind shown in FIGS. 1b and 1c, a total of thirteen switches and five capacitors are required to implement the inductive buck converter circuitry and the switched capacitor power converter circuitry 140.

FIG. 1d is a schematic diagram illustrating alternative example switched capacitor power converter circuitry suitable for use as the switched capacitor power converter circuitry 140 in the charging system 100 of FIG. 1a.

The switched capacitor power converter circuitry, shown generally at 400 in FIG. 1d, includes a first flying capacitor 410, a second flying capacitor 420, a first output capacitor 430 and second output capacitor 440. The switched capacitor power converter circuitry 400 further includes a switch network comprising, in this example, first to eighth switches 452-468 (which in this example are MOSFET devices), which can be selectively opened and closed to couple the first and second flying capacitors 410, 420 to an input node 480 and an output node 490 of the switched capacitor power converter circuitry 400 to generate an output voltage VOUT at a desired magnitude from an input voltage VIN. The switched capacitor power converter circuitry 400 further includes an input switch 470 (which in this example is a MOSFET device) that is operable to activate and deactivate the switched capacitor power converter circuitry 400 by selectively coupling the fourth switch 458 to, and decoupling the fourth switch 458 from, the input node 480 at which the input voltage VIN is received.

In this example the switched capacitor power converter circuitry 400 is operable with an input voltage to output voltage ratio of 4:1, such that the magnitude of the output voltage VOUT is either one quarter of the magnitude of the input voltage or one-third of the magnitude of the magnitude of the input voltage VIN.

As can be seen from FIG. 1d, in this example the switched capacitor power converter circuitry 200 includes eight switches (switches 452-468 of the switch network) for coupling the flying capacitors 410, 420 to the input and output nodes 480, 490, a further switch (input switch 470) for controlling an operational state (activated/deactivated) of the switched capacitor power converter circuitry 400, and four capacitors (first and second flying capacitors 410, 420 and first and second output capacitors 430, 440).

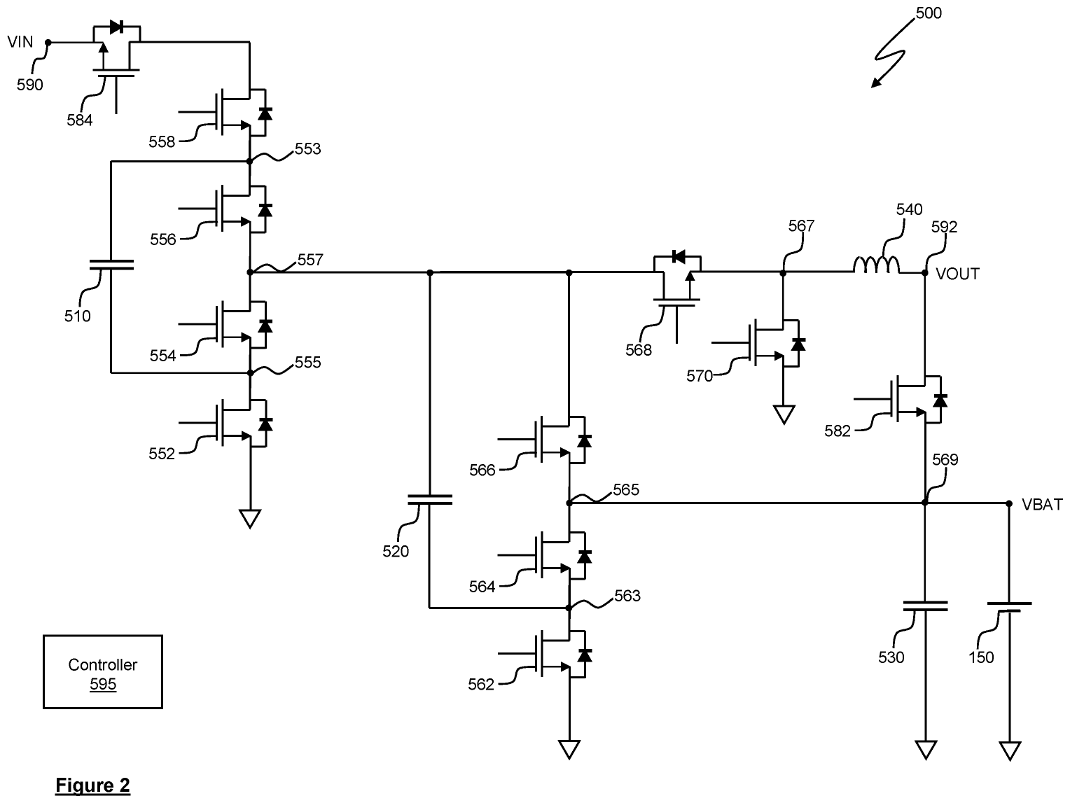

FIG. 2 is a schematic representation of example power converter circuitry according to the present disclosure, which combines inductive buck converter circuitry and switched capacitor power converter circuitry into a single circuit. The power converter circuitry of FIG. 2 may thus be referred to as a combined power converter circuit (or combined power converter circuitry).

The power converter circuitry, shown generally at 500 in FIG. 2, is operable in a first forward mode as switched capacitor converter circuitry and in a second forward mode as inductive buck converter circuitry. In the first and second forward modes, the power converter circuitry 500 is operative to step down an input voltage to generate an output voltage.

The power converter circuitry 500 is also operable in a first reverse mode as switched capacitor power converter circuitry, and in a second reverse mode as inductive boost converter circuitry. In the first and second reverse modes, the power converter circuitry 500 is operative to step up an input voltage to generate an output voltage.

The power converter circuitry 500 in the illustrated example includes a first capacitor 510 (which is also referred to herein as a first flying capacitor 510), a second capacitor 520 (also referred to herein as a second flying capacitor 520), a third capacitor 530 (which may also be referred to as an output capacitor when the power converter circuitry 500 is operating in its forward modes, and as an input capacitor when the power converter circuitry 500 is operating in its reverse modes) and an inductor 540. The first, second and third capacitors 510, 520, 530 may be of equal capacitance.

The power converter circuitry 500 further includes a switch network comprising, in this example, first to ninth switches 552-570. The switch network is configured to be coupled to the first and second flying capacitors 510, 520, the third capacitor 530 and the inductor 540.

In the example shown in FIG. 2, an output switch 582, which in this example is a MOSFET device, is coupled between the inductor 540 and a battery coupling node 569 to which a first terminal of the third capacitor 530 and, in use of the power converter circuitry 500 in a battery charging application, a battery 150, are coupled. In other examples, the output switch 582 may be omitted, and the inductor 540 may instead be coupled to the battery coupling node 569.

The output switch 582 (where provided) fulfils the function of the battery controller transistor 136 of FIG. 1a, and is thus operable to selectively couple the battery 150 to the inductor 540 when the power converter circuitry 500 is operating as inductive buck converter or inductive boost converter circuitry, as will be explained in more detail below.

An input switch 584, which in this example is a MOSFET device, is coupled between the fourth switch 558 of the switch network and an input node 590 at which an input voltage VIN is received. The input switch 584 is operable to activate and deactivate the power converter circuitry 500 by selectively coupling the switch network to, and decoupling the switch network from, the input node 590.

The power converter circuitry 500 further includes controller circuitry 595, which is configured to control operation of the switch network to cause the power converter circuitry 500 to operate in a desired mode, as described in more detail below. The controller circuitry 595 may be implemented in discrete circuitry or integrated circuitry, or may be implemented by a microprocessor, microcontroller, sate machine or the like, executing suitable instructions.

The power converter circuitry 500 may be said to comprise switched capacitor power converter circuitry and inductive buck or boost converter circuitry, with the switch network, the first and second flying capacitors 510, 520 and the third capacitor 530 being common to or shared by the switched capacitor power converter circuitry and the inductive buck or boost converter circuitry.

In some examples, the power converter circuitry 500 is implemented in a single integrated circuit. In such examples, the first and second flying capacitors 510, 520, the third capacitor 530, the inductor 540, the switch network, the output switch 582, the input switch 584 and the controller circuitry 595 are provided as part of the integrated circuit, i.e. are provided on-chip.

In other examples, the first and second flying capacitors 510, 520, third capacitor 530 and inductor 540 may be provided externally of the integrated circuit (i.e. off-chip), and the switch network, the output switch 582, the input switch 584 and the controller circuitry 595 may be implemented in a single integrated circuit. In such examples, the integrated circuit may comprise a first set of one or more terminals (pins, pads, balls or the like) by means of which an external (i.e. off-chip) first flying capacitor 510 can be coupled to a first set of one or more coupling nodes of the switch network. Similarly, the integrated circuit may comprise a second set of one or more terminals (pins, pads, balls or the like) by means of which an external (i.e. off-chip) second flying capacitor 520 can be coupled to a second set of one or more coupling nodes of the switch network, a third set of one or more terminals (pins, pads, balls or the like) by means of which an external (i.e. off-chip) third capacitor 530 can be coupled to a third set of one or more coupling nodes of the switch network, and a fourth set of one or more terminals (pins, pads, balls or the like) by means of which an external (i.e. off-chip) inductor 540 can be coupled to a fourth set of one or more coupling nodes of the switch network. The coupling nodes of the switch network are described in more detail below.

As shown in FIG. 2, the first to fourth switches 552-558 of the switch network are coupled in series between the ground (or other reference voltage supply) terminal or coupling node and the input switch 584. The fifth to seventh switches 562-566 are coupled in series between the ground (or other reference voltage supply) terminal or coupling node and a node (referred to as the third node 557) between the second and third switches 554, 556.

In use of the power converter circuitry 500, a first terminal of the first flying capacitor 510 is coupled to a first node 553 of the switch network, between the third switch 556 and the fourth switch 558. A second terminal of the first flying capacitor 510 is coupled to a second node 555 of the switch network, between the first switch 552 and the second switch 554. Thus, the first node 553 and the second node 555 of the switch network constitute a set of coupling nodes for the first flying capacitor 510.

A first terminal of the second flying capacitor 520 is coupled to a third node 557 of the switch network, between the second switch 554 and the third switch 556. A second terminal of the second flying capacitor 520 is coupled to a fourth node 563 of the switch network, between the fifth switch 562 and the sixth switch 564. The third node 557 and the fourth node 563 thus constitute a set of coupling nodes for the second flying capacitor 520.

The battery coupling node 569 is coupled to a fifth node 565 of the switch network, between the sixth switch 564 and the seventh switch 566. Thus, when the output switch 582 is switched on (or where the output switch 584 is omitted), the output node 592 is coupled to the fifth node 565.

The switch network further includes an eighth switch 568 (which is a MOSFET device, in the illustrated example) coupled between the third node 557 and a sixth node 567. In use of the power converter circuitry 500, the sixth node 567 is coupled to a first terminal of the inductor 540. The sixth node 567 thus constitutes a first coupling node for the inductor 540.

The switch network further includes a ninth switch 570 (which is also a MOSFET device, in the illustrated example) coupled between the sixth node 567 and a ground (or other reference voltage) supply terminal or node.

In use of the power converter circuitry 500, a first terminal of the third capacitor 530 is coupled to the battery coupling node 569 and hence to the fifth node 565. A second terminal of the third capacitor 530 is coupled to the ground (or other reference voltage) terminal or coupling node. The fifth node 565 thus constitutes a first coupling node for the third capacitor 530.

In examples in which the output switch 582 is provided, the output switch 582 is coupled between the battery coupling node 569 and the output node 592. In examples in which the output switch is 582 not provided, the second terminal of the inductor 540 is coupled to the battery coupling node 569 and thus also to the fifth node 565. In both examples, the second terminal of the inductor 540 is also coupled to the output node 592, such that the output node 592 constitutes a second coupling node for the inductor 540.

Thus, as will be appreciated, the combination of the first to seventh switches 552-566, the first and second flying capacitors 510, 520 and the third capacitor 530 of the power converter circuitry 500 constitutes switched capacitor power converter circuitry, and the combination of the switch network, the first and second flying capacitors 510, 520, the third capacitor 530 and the inductor 540 constitutes inductive buck or boost converter circuitry. Thus, the power converter circuitry 500 may be said to comprise switched capacitor power converter circuitry and inductive buck or boost converter circuitry, with the switch network, the first and second flying capacitors 510, 520 and the third capacitor 530 being common to or shared by the switched capacitor power converter circuitry and the inductive buck or boost converter circuitry.

As will be apparent from FIG. 2, the power converter circuitry 500 in the example illustrated in FIG. 2 includes a total of eleven switches, three capacitors and one inductor. However, in some examples the input switch 584 and/or the output switch 582 may be omitted. In such examples there may only be ten or nine switches.

In contrast, in a charging system of the kind shown in FIG. 1a in which the switched capacitor power converter circuitry 140 and the inductive buck converter circuitry implemented by the PMIC are provided as separate circuits of the kind shown in FIGS. 1b and 1c respectively, a total of thirteen switches (or eleven, if the input switch 280 and the battery controller transistor 136 are omitted) and five capacitors are required to implement the inductive buck converter circuitry and the switched capacitor power converter circuitry 140. Thus, the power converter circuitry 500 of FIG. 2 requires two fewer switches and two fewer capacitors than a charging system of the kind shown in FIG. 1a in which the switched capacitor power converter circuitry 140 and the inductive buck converter circuitry implemented by the PMIC and are provided as separate circuits of the kind shown in FIGS. 1b and 1c respectively.

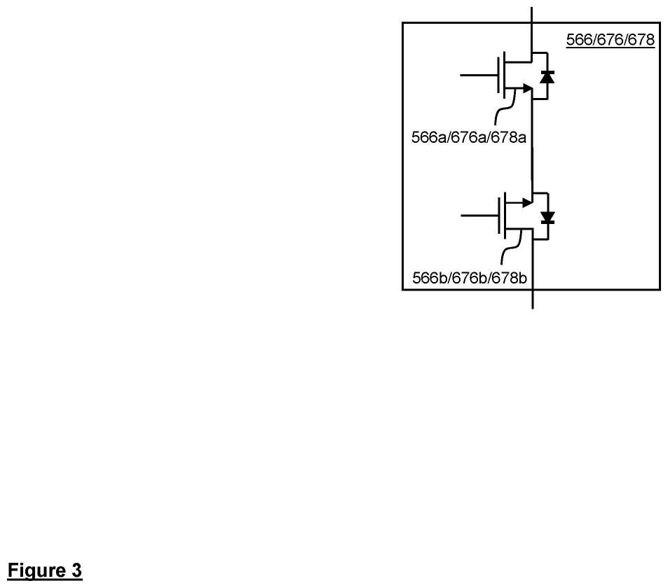

In the example shown in FIG. 2, the switches 552-570 of the switch network are shown as being implemented by single MOSFET devices. However, in some implementations, the seventh switch 566 may be implemented as two back-to-back connected MOSFET devices, as shown in FIG. 3.

As shown in FIG. 3, the seventh switch 566 may be implemented by a combination of a first MOSFET device 566a and a second MOSFET device 556b, with source terminals of the first and second MOSFET devices 556a, 556b being coupled together such that, in the illustrated example, an anode of a body diode of the first MOSFET device 556a is coupled to an anode of a body diode of the second MOSFET device 556a. As will be appreciated by those of ordinary skill in the art, in other examples the first and second MOSFET devices 556a and 556b may be connected so that the direction of the body diodes are reversed, in comparison with the example of FIG. 3, according to the structure of the gate driver for driving the switches.

As noted above, the power converter circuitry 500 is operable in a first forward mode as switched capacitor power converter circuitry and in a second forward mode as inductive buck converter circuitry. The power converter circuitry 500 is also operable in a first reverse mode as switched capacitor power converter circuitry, and in a second reverse mode as or inductive boost converter circuitry.

When operating in the first forward mode as switched capacitor power converter circuitry, the power converter circuitry 500 can operate as a forward switched capacitor power converter with either a 3:1 a 2:1 input voltage to output voltage ratio to supply power to a component coupled to its output node 592, e.g. to supply power to charge a battery 150. Thus, when operating in the first forward mode (i.e. in a forward switched capacitor converter mode), the power converter circuitry 500 is operative to generate the output voltage VOUT by applying a substantially integer step-down conversion factor (i.e. the input voltage VIN is an integer multiple of the output voltage VOUT) to the input voltage VIN.

When operating in the second forward mode as inductive buck converter circuitry, the power converter circuitry 500 operates as a forward 3-level inductive buck converter to supply power to a component coupled to its output node 592, e.g. to supply power to charge a battery 150. Thus, when operating in the second forward mode (i.e. in an inductive buck converter mode), the power converter circuitry 500 is operative to generate the output voltage VOUT by applying a substantially non-integer step-down conversion factor (i.e. the input voltage VIN is a non-integer multiple of the output voltage VOUT) to the input voltage VIN.

When operating in the first reverse mode as switched capacitor power converter circuitry, the power converter circuitry 500 can operate as a reverse switched capacitor power converter with a 1:3 or 1:2 input voltage to output voltage ratio to supply power from a component such as a battery 150 coupled to its output node 592 to a component or subsystem (e.g. a wireless charging subsystem or a power supply subsystem that is coupled to the power converter circuitry by means of a USB cable or the like) coupled to its input node 590. Thus, when operating in the first reverse mode (i.e. in a reverse switched capacitor converter mode), the power converter circuitry 500 is operative to generate the output voltage VOUT by applying a substantially integer step-up conversion factor (i.e. the output voltage VOUT is an integer multiple of the input voltage VIN) to the input voltage VIN.

When operating in the second reverse mode as inductive boost converter circuitry, the power converter circuitry 500 operates as reverse 3-level inductive boost converter to supply power from a component such as a battery 150 coupled to its output node 592 to a component or subsystem (e.g. a wireless charging subsystem or a power supply subsystem that is coupled to the power converter circuitry by means of a USB cable or the like) coupled to its input node 590. Thus, when operating in the second reverse mode (i.e. in an inductive boost converter mode), the power converter circuitry 500 is operative to generate the output voltage VOUT by applying a non-integer step-up conversion factor (i.e. the output voltage VOUT is a non-integer multiple of the input voltage VIN) to the input voltage VIN.

The ability of the power converter circuitry 500 to apply a substantially integer step-down or step-up conversion factor to the input voltage VIN (when operating in the first forward mode and the first reverse mode, respectively) and to apply a non-integer step-down or step up conversion factor to the input voltage VIN (when operating in the second forward mode or the second reverse mode, respectively) allows selection between coarse control of the output voltage VOUT (in the first mode) and finer control of the output voltage VOUT (in the second mode) as required by the application in which the power converter circuitry 500 is used. For example, in a battery charger application, coarse control of the output voltage VOUT (as provided by the power converter circuitry 500 in its first mode) may be sufficient for the first, fast charging stage, whereas in the second, CC-CV stage, finer control of the output voltage VOUT (as provided by the power converter circuitry 500 in its second mode) may be required.

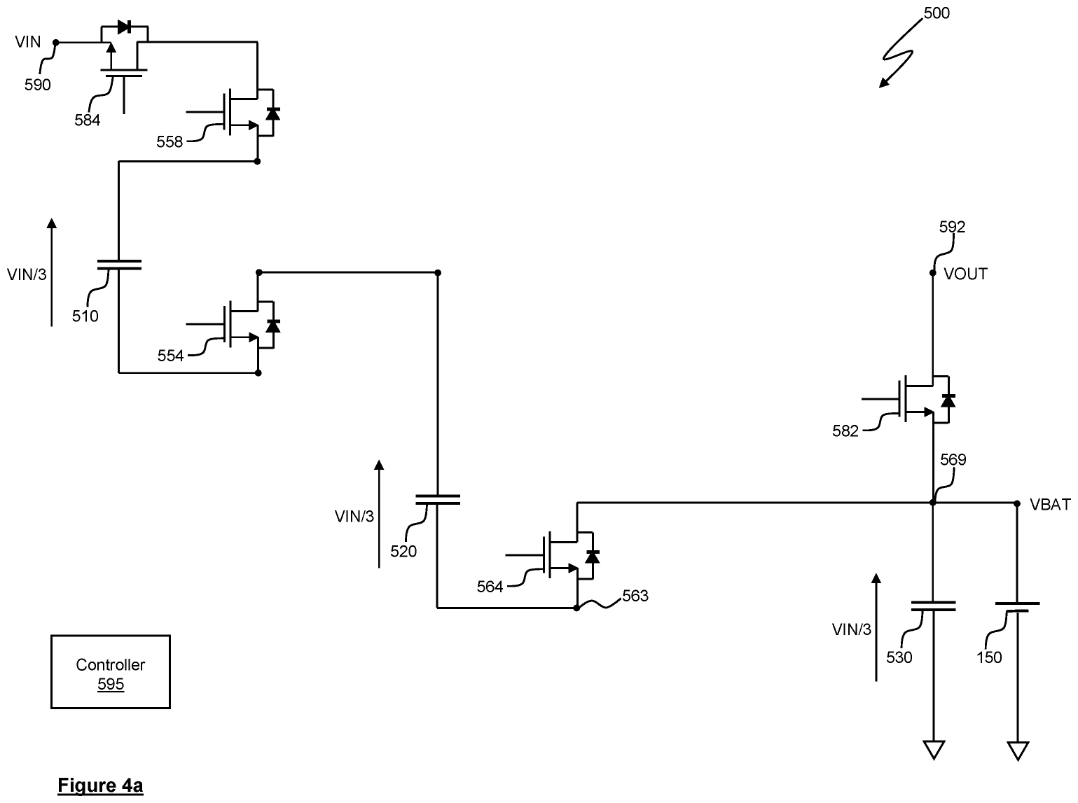

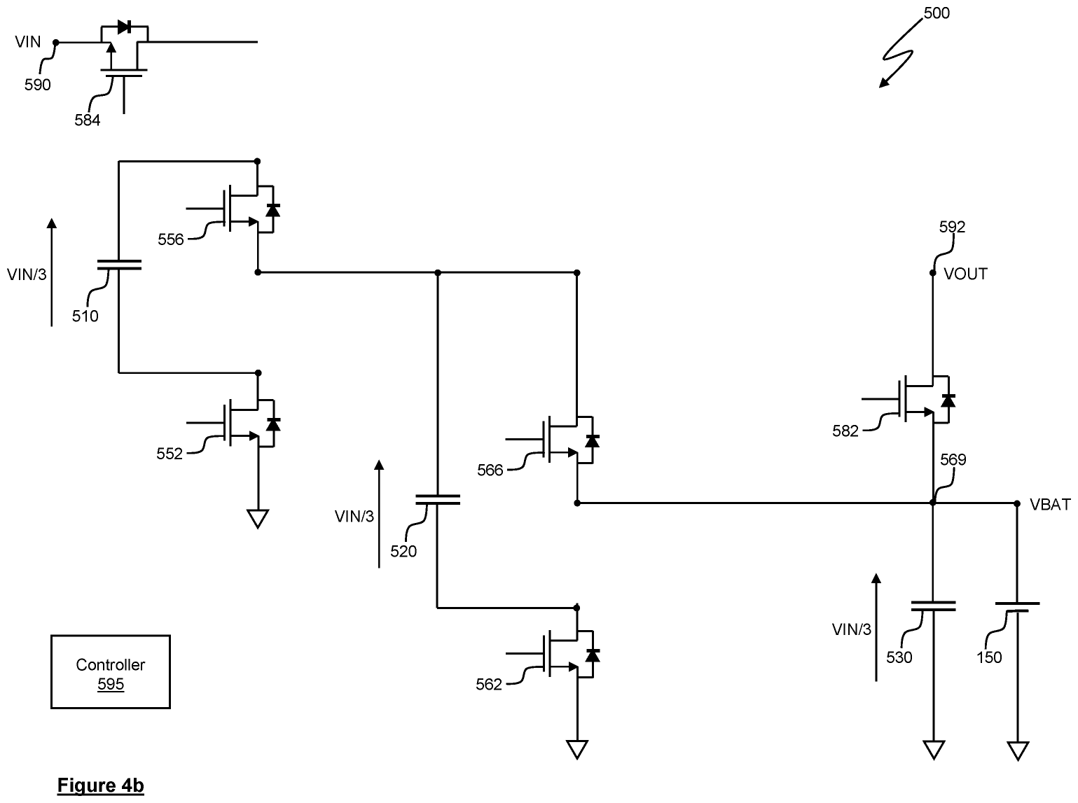

FIGS. 4a and 4b are schematic diagrams illustrating operation of the power converter circuitry 500 in the first forward mode, as switched capacitor power converter circuitry with a 3:1 input voltage to output voltage ratio, i.e. a step-down conversion factor of 3. In this first forward mode the third capacitor 530 may support an output voltage, and may thus be referred to as an output capacitor.

In a first phase of operation, shown in FIG. 4a, the input switch 584 and the second, fourth and sixth switches 554, 558, 564 of the switch network are closed (i.e. switched on) in response to suitable control signals from the controller circuitry 595. The other switches 552, 556, 562 and 566-570 are opened (i.e. switched off) in response to suitable control signals from the controller circuitry 595 (and are thus not shown in FIG. 4a).

With the switch network in this configuration, the first flying capacitor 510, the second flying capacitor 520 and the third capacitor 530 are coupled in series between the input node 590 and the ground (or other reference voltage) supply terminal or coupling node, and the battery coupling node 569 is coupled to the fourth node 563, which is between the series-coupled second flying capacitor 520 and third capacitor 530. Thus, if the first and second flying capacitors 510, 520 and the third capacitor 530 are of equal capacitance, a voltage of VIN/3 develops across each of the first and second flying capacitors 510, 520 and the third capacitor 530. The first and second flying capacitors 510, 520 and the third capacitor 530 thus charge up to VIN/3, and a voltage VBAT at the battery coupling node 569 (to which a battery 150 may be coupled, in a battery charging application) is equal to VIN/3.

In a second phase of operation, shown in FIG. 4b, the second, fourth and sixth switches 552, 556, 564 are opened (i.e. switched off) in response to suitable control signals from the controller circuitry 595 (and are thus not shown in FIG. 4b). The eighth and ninth switches 568, 570 are also opened (i.e. switched off) in response to suitable control signals from the controller circuitry 595. The first, third, fifth and seventh switches 552, 556, 562, 566 are closed (i.e. switched on), in response to suitable control signals from the controller circuitry 595, such that the first and second flying capacitors 510, 520 and the third capacitor 530 are coupled in parallel between the output node 592 and the ground (or other reference voltage supply) terminal or coupling node.

Thus, in the second phase of operation, the peak output voltage VOUT is equal to the voltage that developed across the first and second flying capacitors 510, 520 and the third capacitor 530 during the first phase, and so the peak voltage VBAT at the battery coupling node 569 (and thus supplied to a coupled battery 150) in the second phase of operation is VIN/3.

In operation of the power converter circuitry 500 in the first forward mode as switched capacitor power converter circuitry with a 3:1 input voltage to output voltage ratio, a duty cycle of the power converter circuitry is fixed at 0.5, such that the duration of the first phase is equal to half of a total duration of the first and second phases. As a result of this fixed duty cycle, the voltage across the first and second flying capacitors 510, 520 is maintained at VIN/3, so there is no need for additional circuitry for balancing the voltage of the first and second flying capacitors 510, 520.

As will be appreciated by those of ordinary skill in the art, if the output switch 582 is switched on or is not present, a voltage equal to VIN/3 is also present at the output node 592 as an output voltage VOUT during operation of the power converter circuitry 500 in the first forward mode as switched capacitor power converter circuitry with a 3:1 input voltage to output voltage ratio. The output voltage VOUT can be used as a supply voltage by a system (not shown in FIGS. 4a and 4b) that may be coupled to the output node 582. Thus, when the power converter circuitry 500 is operating in its first forward mode as switched capacitor power converter circuitry with a 3:1 input voltage to output voltage ratio, it can simultaneously supply a charging current to a battery 150 and a supply voltage to an external system.

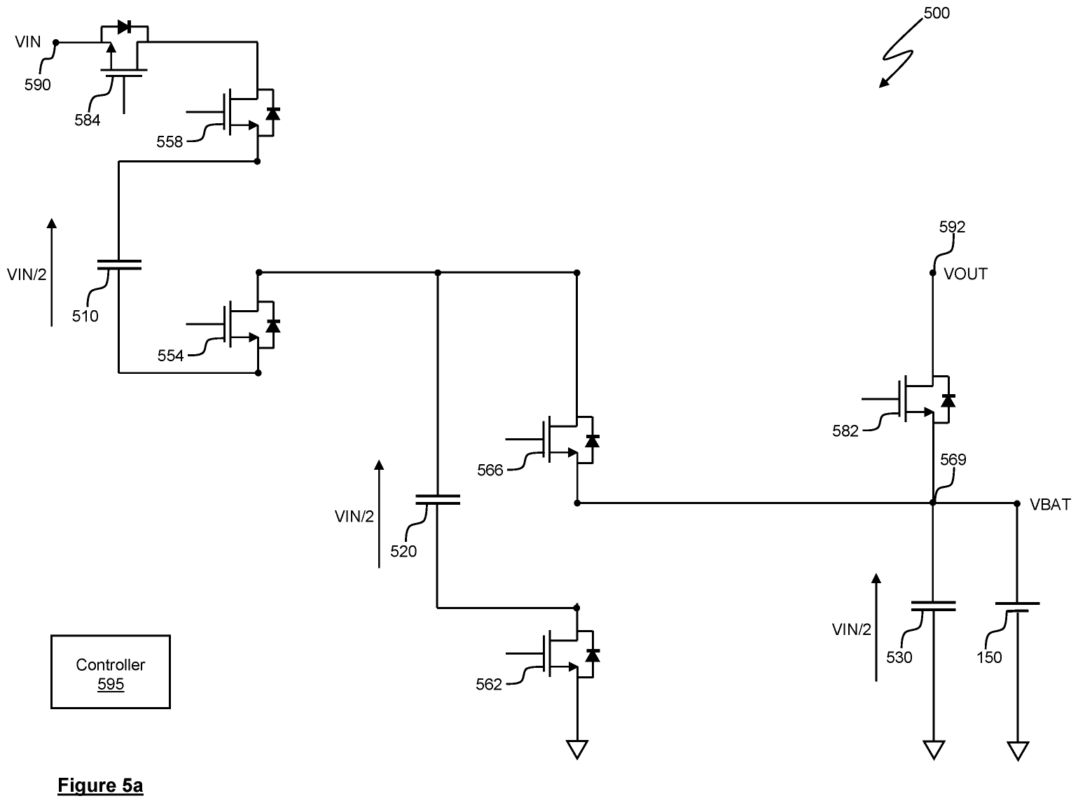

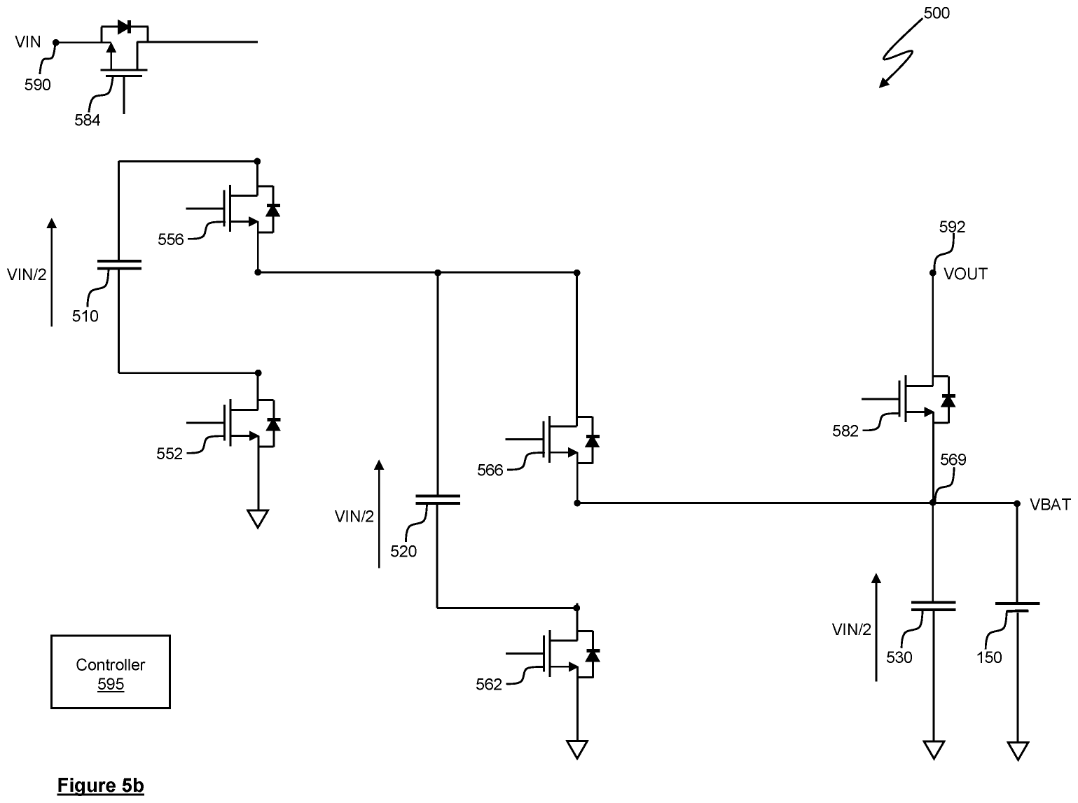

FIGS. 5a and 5b are schematic diagrams illustrating operation of the power converter circuitry 500 in the first forward mode, as switched capacitor power converter circuitry with a 2:1 input voltage to output voltage ratio, i.e. a step-down conversion factor of 2. In this first forward mode the third capacitor 530 may again support an output voltage, and may thus be referred to as an output capacitor 530.

In a first phase of operation, shown in FIG. 5a, the input switch 584 and the second, fourth, fifth and seventh switches 554, 558, 562, 566 of the switch network are closed (i.e. switched on) in response to suitable control signals from the controller circuitry 595. The other switches 552, 556, 564, 568, 570 are opened (i.e. switched off) in response to suitable control signals from the controller circuitry 595 (and are thus not shown in FIG. 5a).

With the switch network in this configuration, the first flying capacitor 510 and the second flying capacitor 520 are coupled in series between the input node 590 and the ground (or other reference voltage) supply terminal or coupling node, and the third capacitor 530 is coupled in parallel with the second flying capacitor 520 between the battery coupling node 569 and the ground (or other reference voltage) supply terminal or coupling node. Thus, if the first and second flying capacitors 510, 520 and the third capacitor 530 are of equal capacitance, a voltage of VIN/2 develops across each of the first and second flying capacitors 510, 520 and the third capacitor 530. The first and second flying capacitors 510, 520 and the third capacitor 530 thus charge up to VIN/2, and the voltage VBAT at the battery coupling node 569 is equal to VIN/2.

In a second phase of operation, shown in FIG. 5b, the second and fourth switches 554, 558 are opened (i.e. switched off) in response to suitable control signals from the controller circuitry 595 (and are thus not shown in FIG. 5b). The eighth and ninth switches 568, 570 are also opened (i.e. switched off) in response to suitable control signals from the controller circuitry 595. The first, third, fifth and seventh switches 552, 556, 562, 566 are closed (i.e. switched on), in response to suitable control signals from the controller circuitry 595, such that the first and second flying capacitors 510, 520 and the third capacitor 530 are coupled in parallel between the output node 592 and the ground (or other reference voltage supply) terminal or coupling node.

Thus, in the second phase of operation, the peak voltage VBAT at the battery coupling node 569 is equal to the voltage that developed across the first and second flying capacitors 510, 520 and the third capacitor 530 during the first phase, and so the peak voltage VBAT at the battery coupling node 569 (and thus supplied to a coupled battery 150) in the second phase of operation is VIN/2.

In operation of the power converter circuitry 500 in the first forward mode as switched capacitor power converter circuitry with a 2:1 input voltage to output voltage ratio, a duty cycle of the power converter circuitry is fixed at 0.5, such that the duration of the first phase is equal to half of a total duration of the first and second phases. As a result of this fixed duty cycle, the voltage across the first and second flying capacitors 510, 520 is maintained at VIN/3, so there is no need for additional circuitry for balancing the voltage of the first and second flying capacitors 510, 520.

As will be appreciated by those of ordinary skill in the art, if the output switch 582 is switched on or is not present, a voltage equal to VIN/2 is also present at the output node 592 as an output voltage VOUT during operation of the power converter circuitry 500 in the first forward mode as switched capacitor power converter circuitry with a 2:1 input voltage to output voltage ratio. The output voltage VOUT can be used as a supply voltage by a system (not shown in FIGS. 5a and 5b) that may be coupled to the output node 582. Thus, when the power converter circuitry 500 is operating in its first forward mode as switched capacitor power converter circuitry with a 2:1 input voltage to output voltage ratio, it can simultaneously supply a charging current to a battery 150 and a supply voltage to an external system.

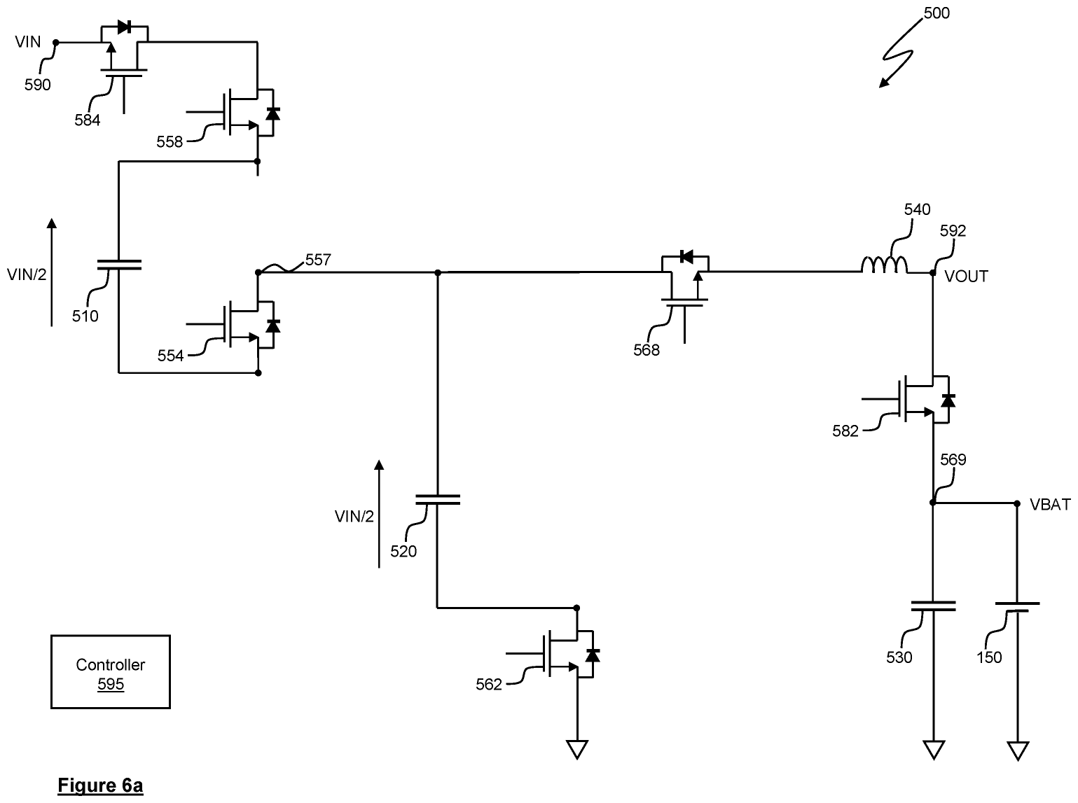

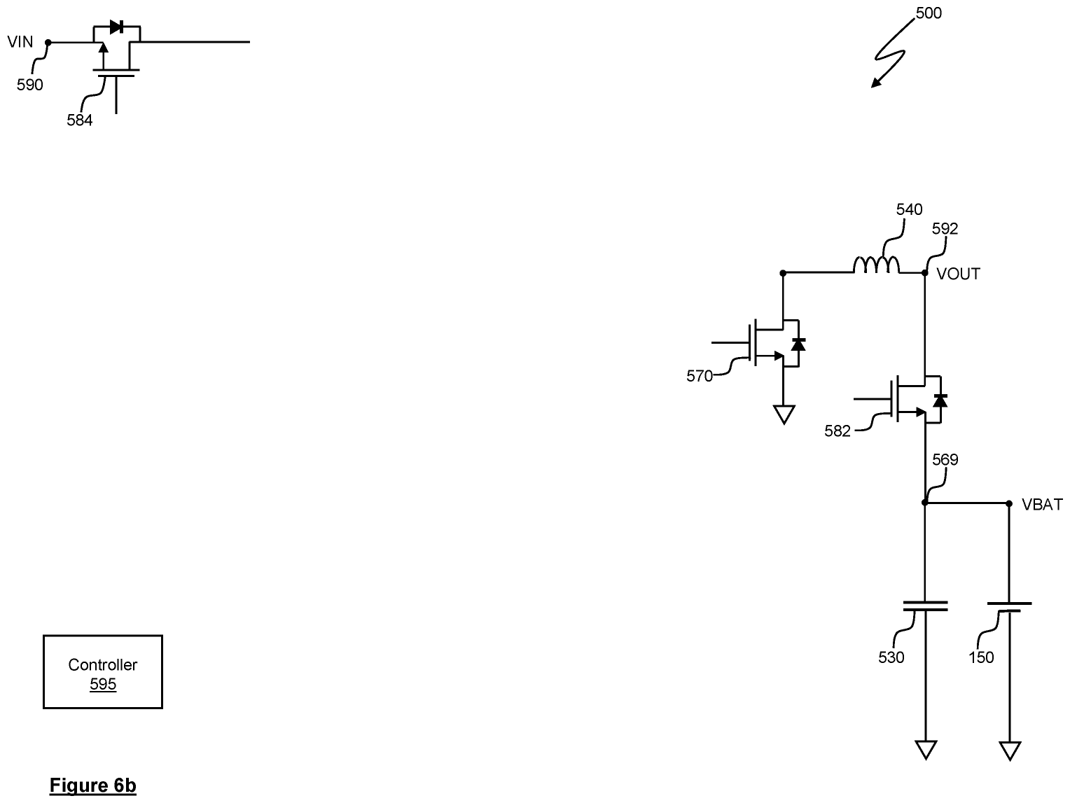

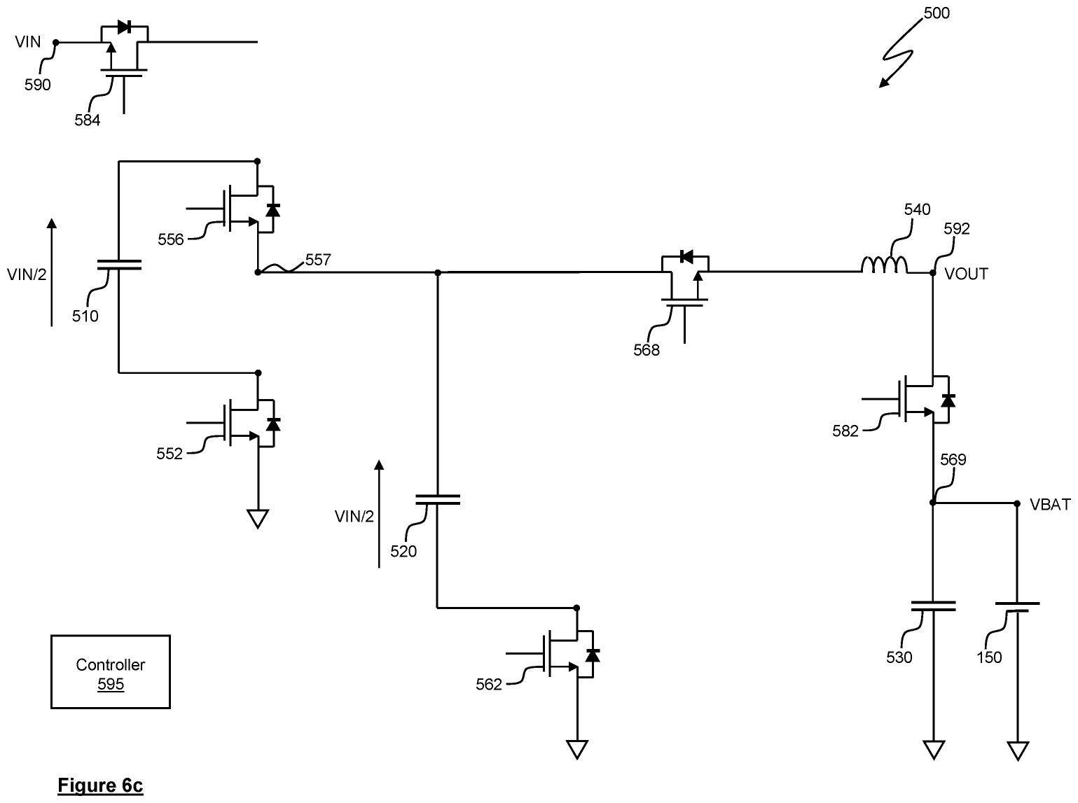

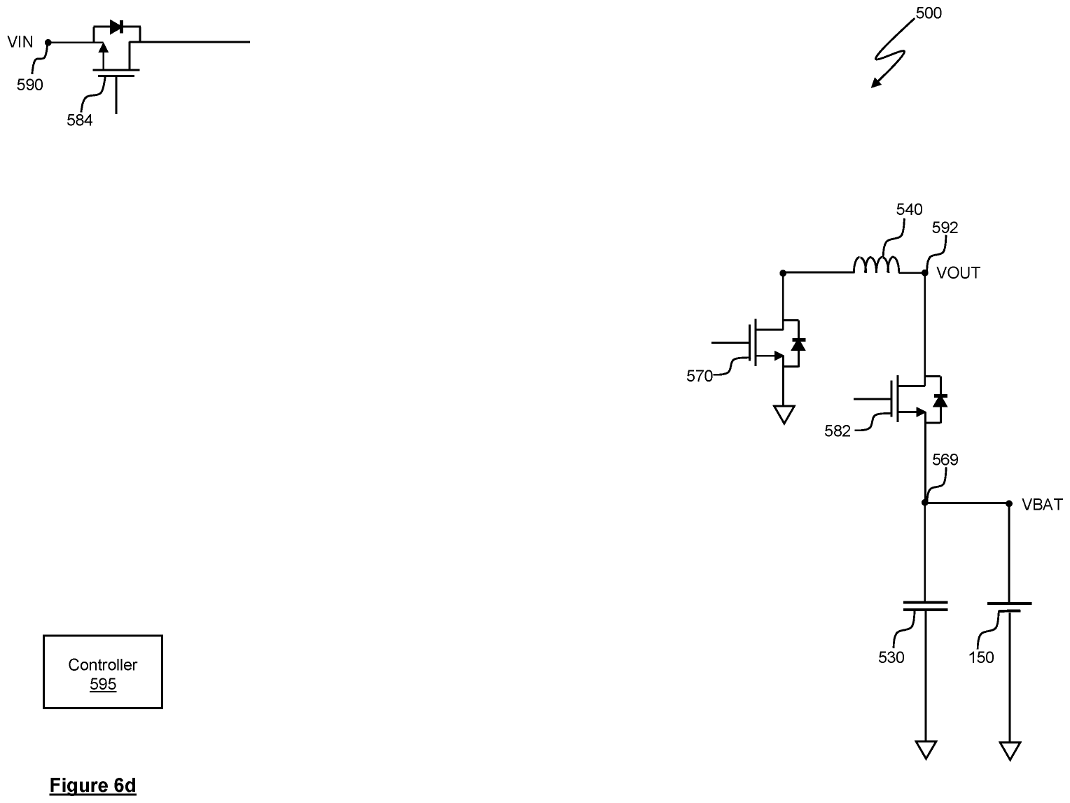

FIGS. 6a-6d are schematic diagrams illustrating operation of the power converter circuitry 500 in the second forward mode, as three-level inductive buck converter circuitry with a duty cycle D of less than 0.5. In this mode the power converter circuitry may apply a non-integer step-down conversion factor to the input voltage VIN to generate the output voltage VOUT. In this second forward mode the third capacitor 530 may again support an output voltage, and thus may be referred to as an output capacitor.

For inductive buck converter circuitry, the duty cycle is defined as the ratio of the on-time of the switch(es) that control a supply of current to the inductor 540 to the total duration of an operational cycle of the inductive buck converter circuitry. Thus, for a duty cycle of less than 0.5, the on-time of the switch(es) that control the supply of current to the inductor 540 is less than half the total duration of an operational cycle of the inductive buck converter circuitry. The duty cycle defines a relationship between the output voltage VOUT and the input voltage VIN of the inductive buck converter circuitry, as D=VOUT/VIN. Thus, when the duty cycle D is less than 0.5, the output voltage VOUT is less than half of VIN.

In a first phase of operation, shown in FIG. 6a, the input switch 584 and the second, fourth, fifth and eighth 554, 558, 562, 568 of the switch network are closed (i.e. switched on) in response to suitable control signals from the controller circuitry 595. The other switches 552, 556, 564, 566, 570 are opened (i.e. switched off) in response to suitable control signals from the controller circuitry 595 (and are thus not shown in FIG. 6a). The output switch 582 (if present) is also closed (i.e. switched on) in response to a suitable control signal from the controller circuitry 595.

With the switch network in this configuration, the first and second flying capacitors 510, 520 are coupled in series between the input node 590 and the ground (or other reference voltage supply) terminal or coupling node. The third capacitor 530 is coupled between the output node 592 and the ground (or other reference voltage supply) terminal or coupling node. The inductor 540 and the third capacitor 530 are coupled in series between the third node 557 and the ground (or other reference voltage) supply terminal or node, and this series combination of the inductor 540 and the third capacitor 530 is thus coupled in parallel with the second flying capacitor 520.

In the first phase of operation the first and second flying capacitors 510, 520 charge up and a voltage of (or close to) VIN/2 develops across each of the first and second flying capacitors 510, 520. As the first terminal of the inductor 540 is coupled to the second flying capacitor 520, and as the output voltage VOUT is less than VIN/2 (because the duty cycle is less than 0.5), the voltage (VIN/2) at the first terminal of the inductor 540 is greater than the voltage at the second terminal of the inductor 540. Current through the inductor 540 thus increases and flows to a load (e.g. a battery 150) coupled to the battery coupling node 569, and to the third capacitor 530. A voltage VBAT, which is less than VIN/2 (because the voltage across the third capacitor 530 cannot increase instantaneously and because the inductor 540 limits the charging current that is supplied to the third capacitor 530), develops at the battery coupling node 569.

It will be noted that no separate flying capacitor is required when the power converter circuitry 500 operates in its second forward mode as three-level inductive buck converter circuitry, because the first and second flying capacitors 510, 520 that are used when the power converter circuitry 500 is operating in its first forward mode as switched capacitor power converter circuitry are also used when the power converter circuitry 500 is operating in its second mode as three-level inductive buck converter circuitry.

In a second phase of operation, shown in FIG. 6b, only the ninth switch 570 of the switch network is closed (i.e. switched on) in response to suitable control signals from the controller circuitry 595. The output switch 582 (if present) is also closed (i.e. switched on) in response to a suitable control signal from the controller circuitry 595. The other switches 552-568 are opened (i.e. switched off) in response to suitable control signals from the controller circuitry 595 (and are thus not shown in FIG. 6b).

With the switch network in this configuration, the inductor 540 and third capacitor 530 are coupled in parallel between the ground (or other reference voltage supply) terminal or coupling node and the output node 592. Thus, in the second phase of operation the inductor 540 receives no input voltage. The current through the inductor 540 thus decreases, flowing to the load that is coupled to the battery coupling node 569. The third capacitor 530 also discharges into the load during this phase, such that the total current supplied to the load is the sum of the inductor current and the output capacitor current. The voltage VBAT at the battery coupling node 569 in this second phase of operation is again less than VIN/2.

In a third phase of operation, shown in FIG. 6c, the first, third, fifth and eighth switches 552, 556, 562, 568 of the switch network are closed (i.e. switched on) in response to suitable control signals from the controller circuitry 595. The output switch 582 (if present) is also closed (i.e. switched on) in response to a suitable control signal from the controller circuitry 595. The other switches 554, 558, 564, 566, 570 are opened (i.e. switched off) in response to suitable control signals from the controller circuitry 595 (and are thus not shown in FIG. 6c).

With the switch network in this configuration, the first and second flying capacitors 510, 520 are coupled in parallel between the ground (or other reference voltage) terminal or coupling node and the third node 557. The third capacitor 530 is coupled between the output node 592 and the ground (or other reference voltage supply) terminal or coupling node. The inductor 540 and the third capacitor 530 are coupled in series between the third node 557 and the ground (or other reference voltage supply) terminal or coupling node, such that this series combination of the inductor 540 and the third capacitor 530 is coupled in parallel with the first and second flying capacitors 510, 520.

Thus, in the third phase of operation, the voltage VIN/2 across the first and second flying capacitors 510, 520 is supplied to the inductor 540, causing current through the inductor 540 to increase again, charging the third capacitor 530 and supplying the load that is coupled to the battery coupling node 569 with a voltage VBAT, which is smaller than VIN/2.

In a fourth phase of operation, shown in FIG. 6d, the switch network again adopts the configuration adopted in the second phase, with only the ninth switch 570 closed (i.e. switched on) in response to suitable control signals from the controller circuitry 595 (and the output switch 582, if present, is also switched on, in response to a suitable control signal from the controller circuitry 595). The other switches 552-568 are opened (i.e. switched off) in response to suitable control signals from the controller circuitry 595 (and are thus not shown in FIG. 6d).

With the switch network in this configuration, the inductor 540 and third capacitor 530 are again coupled in parallel between the ground (or other reference voltage) terminal or coupling node and the output node 592, such that the current through the inductor 540 again decreases, flowing to the load that is coupled to the battery coupling node 569. The third capacitor 530 also discharges into the load during this phase, such that the total current supplied to the load is the sum of the inductor current and the output capacitor current. The voltage VBAT in this fourth phase of operation is again less than VIN/2.

As will be appreciated by those of ordinary skill in the art, over a complete operational cycle (where a complete operational cycle comprises the first to fourth phases of operation) of the power converter circuitry 500 when operating in its second forward mode as forward three-level inductive buck converter circuitry with a duty cycle less than 0.5, the average output voltage VOUT will be less than VIN/2.

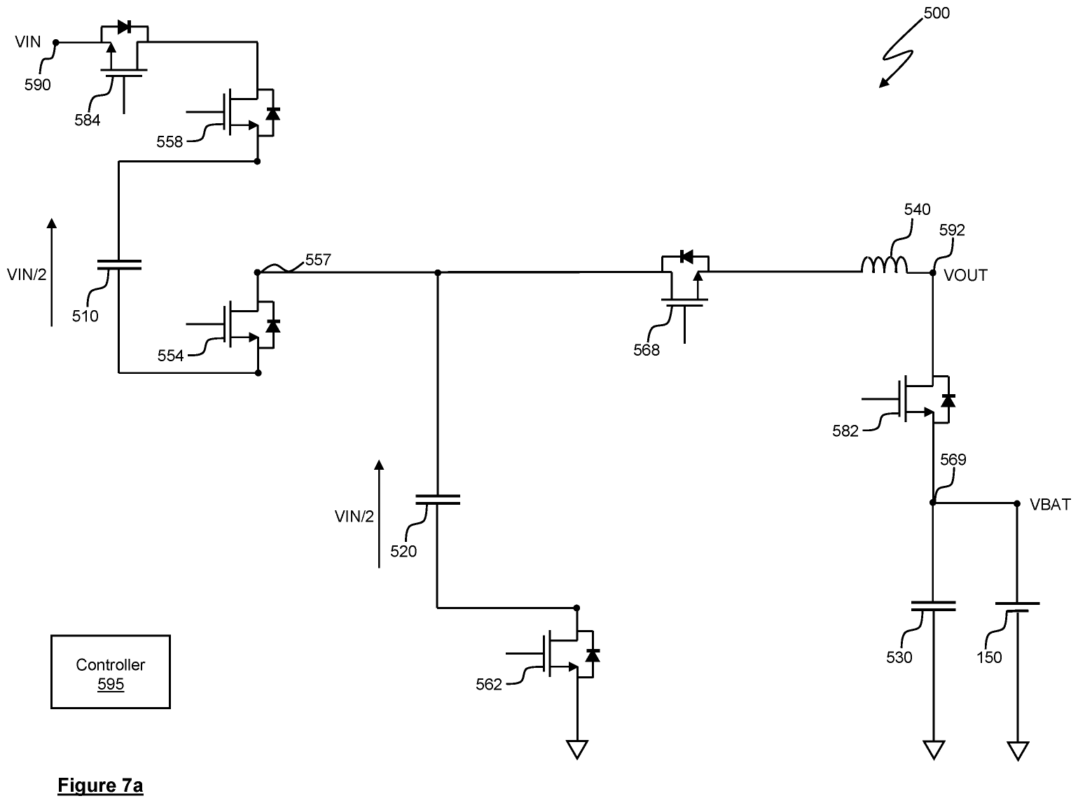

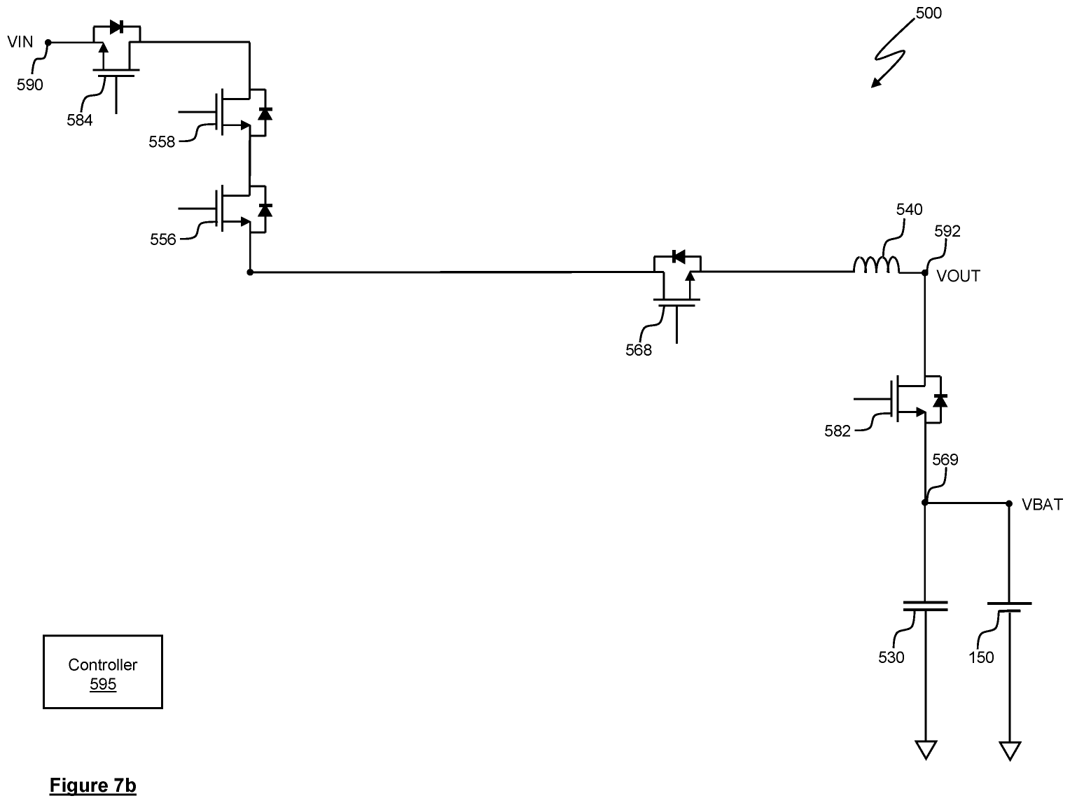

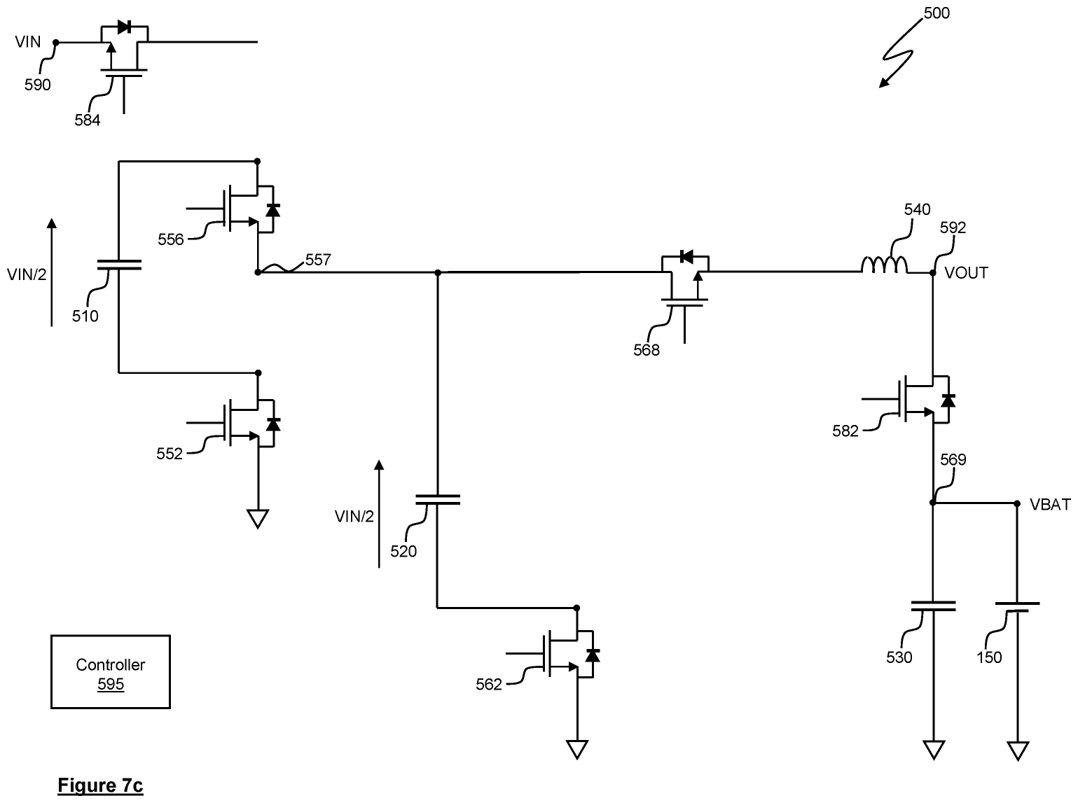

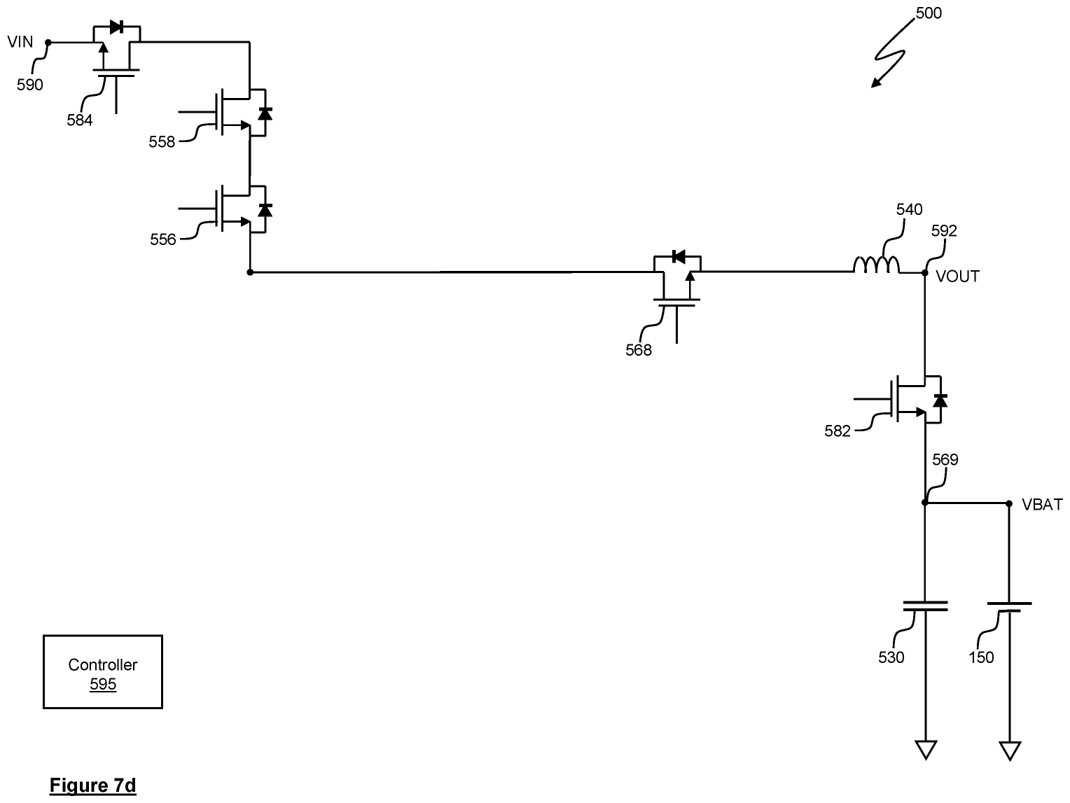

FIGS. 7a-7d are schematic diagrams illustrating operation of the power converter circuitry 500 in the second forward mode, as three-level inductive buck converter circuitry with a duty cycle greater than 0.5, such that the output voltage VOUT is greater than half the input voltage VIN. In this mode the power converter circuitry may apply a non-integer step-down conversion factor to the input voltage VIN to generate the output voltage VOUT. In this second forward mode the third capacitor 530 may again support an output voltage and may thus be referred to as an output capacitor.

If the power converter circuitry 500 is to be operated in the second forward mode as a three-level buck converter with a duty cycle greater than 0.5, the seventh switch 566 should be implemented as two back-to-back connected MOSFET devices, as shown in FIG. 3, to prevent reverse current flow from a load such as a battery that is coupled to the battery coupling node 569, as will be explained in more detail below.

In a first phase of operation, shown in FIG. 7a, the switch network adopts the same configuration as in the first phase of operation when the duty cycle is less than 0.5 (shown in FIG. 6a), with the input switch 584 and the second, fourth, fifth and eighth switches 554, 558, 562, 568 of the switch network and the output switch 582 (if present) closed (i.e. switched on) in response to suitable control signals from the controller circuitry 595, such that the first and second flying capacitors 510, 520 are coupled in series between the input node 590 and the ground (or other reference voltage supply) terminal or coupling node, the third capacitor 530 is coupled between the output node 592 and the ground (or other reference voltage supply) terminal or coupling node, and a series combination of the inductor 540 and the third capacitor 530 is coupled between the third node 557 and the ground (or other reference voltage supply) terminal or coupling node, such that the series combination of the inductor 540 and the third capacitor 530 is coupled in parallel with the second flying capacitor 520.

The first and second flying capacitors 510, 520 thus charge up and a voltage of (or close to) VIN/2 develops across the each of the first flying capacitor 510 and the second flying capacitor 520. Because the duty cycle is greater than 0.5, the output voltage VOUT at the second terminal of the inductor 540 is greater than VIN/2, and so a decreasing current flows through the inductor 540 to a load (e.g. a battery 150) coupled to the battery coupling node 569, and to the third capacitor 530.

Because the output voltage VOUT is greater than the voltage VIN/2 across the second flying capacitor 520 in the first phase of operation, if the seventh switch 566 were implemented as a single MOSFET device with a body diode having an anode coupled to the fifth node 565 and a cathode coupled to the third node 557 (as shown in FIG. 2), then the body diode of the seventh switch 566 would conduct in the first phase of operation, thus providing a path for reverse current from a load coupled to the output node 592 to the second flying capacitor 520.

To prevent this, if the power converter circuitry 500 is to be operated in the second forward mode as a three-level buck converter with a duty cycle greater than 0.5, the seventh switch 566 should be implemented as first and second back-to-back connected MOSFET devices 566a, 566b, as shown in FIG. 3. With the seventh switch 566 implemented in this way, the body diode of the second MOSFET device 556b prevents reverse current flow from the load during the first phase of operation.

Again, it will be noted that no separate flying capacitor is required when the power converter circuitry 500 operates in its second forward mode as three-level inductive buck converter circuitry, because the first and second flying capacitor 510, 520 that are used when the power converter circuitry 500 is operating in its first forward mode as switched capacitor power converter circuitry are also used when the power converter circuitry 500 is operating in its second mode as three-level inductive buck converter circuitry.

In a second phase of operation, shown in FIG. 7b, the input switch 584 and the third, fourth and eighth switches 556, 558, 568 of the switch network, and the output switch 582 (if present) are closed (i.e. switched on) and the other switches 552, 554, 562, 564, 570 opened (i.e. switched off) in response to suitable control signals from the controller circuitry 595, such that the series combination of the inductor 540 and the third capacitor 530 is decoupled from the first and second flying capacitors 510, 520. The inductor 540 and third capacitor 530 are coupled in series between the input node 590 and the ground (or other reference voltage supply) terminal or node and the inductor 540 is coupled in series between the input node 590 and the battery coupling node 569.

With the switch network in this configuration, the input voltage VIN is supplied to the first terminal of the inductor 540, and so an increasing current flows through the inductor 540 to both the third capacitor 530 and to the load that is coupled to the node 569.

In a third phase of operation, shown in FIG. 7c, the switch network adopts the same configuration as in the third phase of operation when the duty cycle is less than 0.5 (shown in FIG. 6c), with the first, third, fifth and eighth switches 552, 556, 562, 568 of the switch network and the output switch 582 (if present) are closed (i.e. switched on) in response to suitable control signals from the controller circuitry 595.

With the switch network in this configuration, the first and second flying capacitors 510, 520 are coupled in parallel between the ground (or other reference voltage) terminal or coupling node and the third node 557. The third capacitor 530 is coupled between the output node 592 and the ground (or other reference voltage) terminal or coupling node. The inductor 540 and the third capacitor 530 are coupled in series between the third node 557 and the ground (or other reference voltage supply) terminal or coupling node, such that this series combination of the inductor 540 and the third capacitor 530 is coupled in parallel with the first and second flying capacitors 510, 520.

Thus, in the third phase of operation, the voltage VIN/2 across the first and second flying capacitors 510, 520 is supplied to the inductor 540. The inductor 540 acts as an additional voltage source in series with the parallel combination of the first and second flying capacitors 510, 520, such that the voltage VBAT, which is supplied to the load that is coupled to the battery coupling node 569, is greater than VIN/2.

In a fourth phase of operation, shown in FIG. 7d, the switch network again adopts the configuration adopted in the second phase, with the third, fourth and eighth switches 556, 558, 568 and the output switch 582 (if present) being closed (i.e. switched on)) and the other switches 552, 554, 558, 566, 570 being opened (i.e. switched off) in response to suitable control signals from the controller circuitry 595, such that the series combination of the inductor 540 and the third capacitor 530 is again decoupled from the first and second flying capacitors 510, 520. The inductor 540 and third capacitor 530 are again coupled in series between the input node 590 and the ground (or other reference voltage supply) terminal or node and the inductor 540 is coupled in series between the input node 590 and the node 569.

With the switch network in this configuration, the input voltage VIN is supplied to the first terminal of the inductor 540, and so an increasing current flows through the inductor 540 to both the third capacitor 530 and to the load that is coupled to the battery coupling node 569.

As will be appreciated by those of ordinary skill in the art, over a complete operational cycle (where a complete operational cycle comprises the first to fourth phases of operation) of the power converter circuitry 500 when operating in its second forward mode as forward three-level inductive buck converter circuitry with a duty cycle greater than 0.5, the average output voltage VOUT will be greater than VIN/2.

Those of ordinary skill in the art will also appreciate that the voltage VBAT is also present at the output node 592 as an output voltage VOUT during operation of the power converter circuitry 500 in the second forward mode as forward three-level inductive buck converter circuitry, whether the power converter circuitry is operating with a duty cycle of less than 0.5 or a duty cycle greater than 0.5. Again, the output voltage VOUT can be used as a supply voltage by a system (not shown in FIGS. 6a-6d or 7a-7d) that may be coupled to the output node 582. Thus, when the power converter circuitry 500 is operating in second forward mode as forward three-level inductive buck converter circuitry, it can simultaneously supply a charging current to a battery 150 and a supply voltage to an external system.

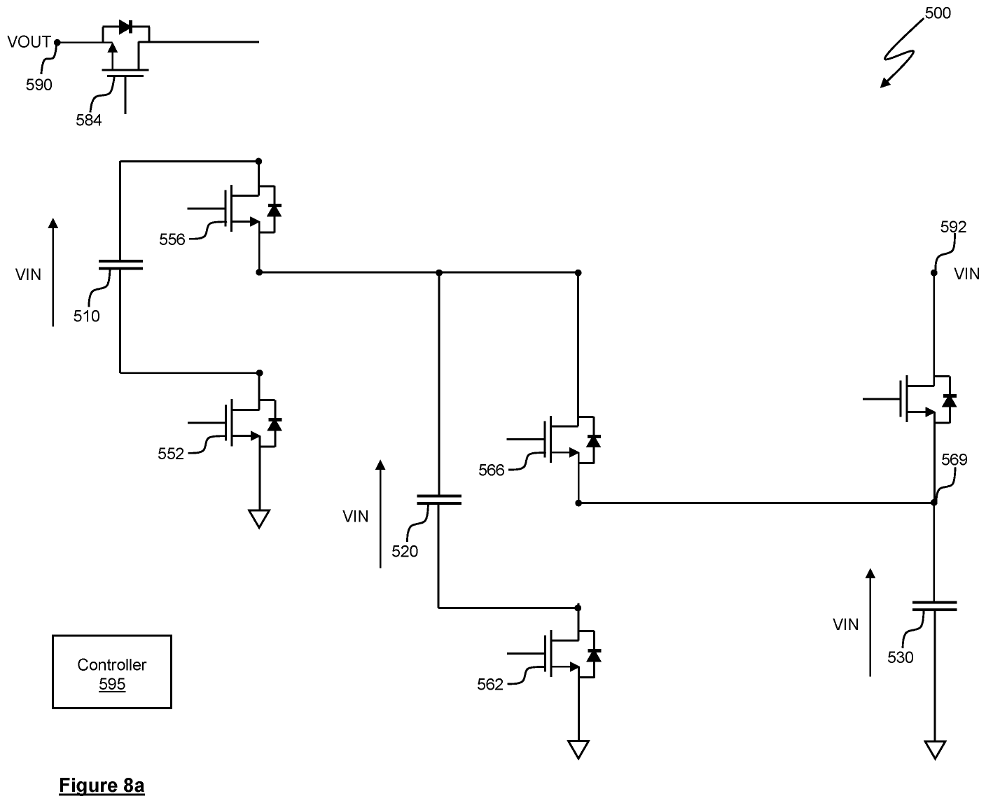

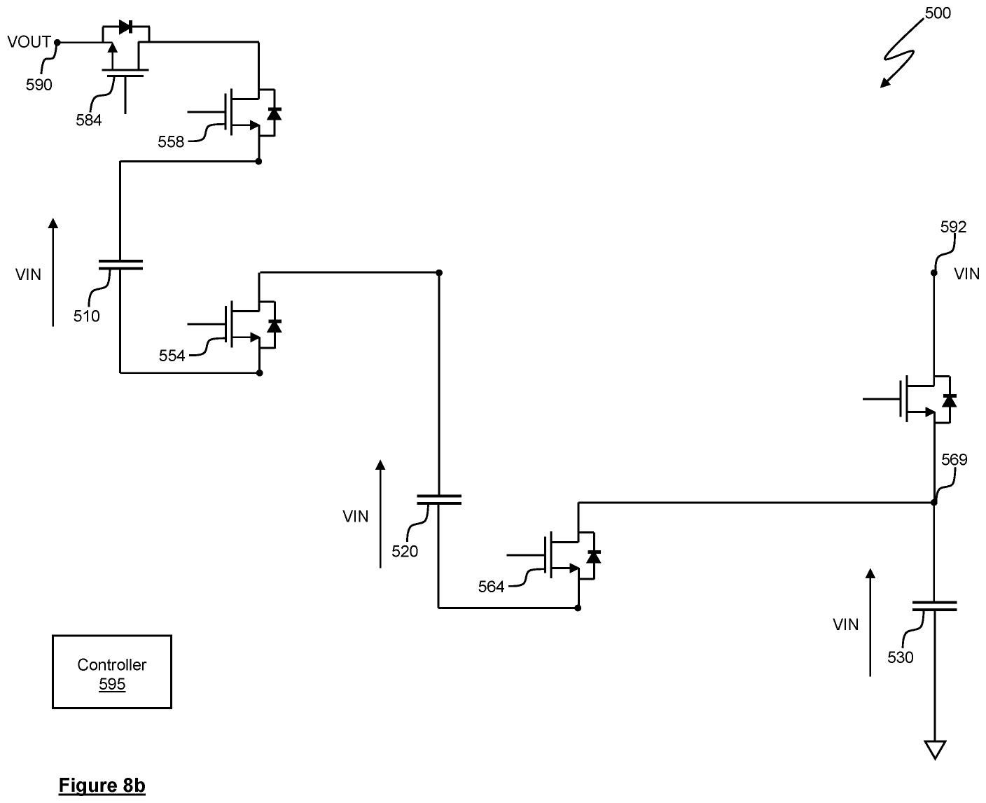

FIGS. 8a and 8b are schematic diagrams illustrating operation of the power converter circuitry 500 in the first reverse mode, as reverse switched capacitor power converter circuitry with a 1:3 input voltage to output voltage ratio (i.e. a step-up conversion factor of 3) to convert an input voltage VIN received at the output node 592 to a higher output voltage VOUT at the input node 590. In this mode, the power converter circuitry 500 operates with a fixed duty cycle of 0.5. In this first reverse mode the third capacitor 530 may receive an input voltage and may thus be referred to as an input capacitor.

In a first phase of operation, shown in FIG. 8a, the first, third, fifth and seventh switches 552, 556, 562, 566 and the output switch 582 (where present) are closed (i.e. switched on) and the other switches 554, 558, 564, 568, 570 are opened (i.e. switched off) in response to suitable control signals from the controller circuitry 595.

With the switch network in this configuration, the third capacitor 530 and the first and second flying capacitors 510, 520 are coupled in parallel with each other, between the battery coupling node 569 (which is in turn coupled to the output node 592 at which an input voltage VIN is received from an external voltage source such as a battery in this first reverse mode) and the ground (or other reference voltage supply) terminal or coupling node. Thus, in the first phase of operation, the third capacitor 530 and the first and second flying capacitor 510, 520 charge up to the input voltage VIN.

In a second phase of operation, shown in FIG. 8b, the second, fourth and sixth switches 554, 558, 564, the output switch 582 (if present) and the input switch 584 are closed (i.e. switched on) and the other switches 552, 556, 562, 568, 570 are opened (i.e. switched off) in response to suitable control signals from the controller circuitry 595.

With the switch network in this configuration, the third capacitor 530 and the first and second flying capacitors 510, 520 are coupled in series with each other, between the ground (or other reference voltage supply) terminal or coupling node and the input node 590 (at which an output voltage VOUT is supplied, in this first reverse mode), with the third capacitor 530 being coupled in parallel with the external voltage source.

Thus, in the second phase of operation the third capacitor 530 and the first and second flying capacitors 510, 520 act as additional voltage sources. The first and second flying capacitors 510, 520 act as additional voltage sources in series with a parallel combination of the external voltage source and the third capacitor 530. The voltage VIN across the parallel combination of the external voltage source and the third capacitor 530 combines with the voltages across the first and second flying capacitors 510, 520 to generate the output voltage VOUT. As the third capacitor 530 and the first and second flying capacitors 510, 520 were each charged to the input voltage VIN during the first phase of operation, the output voltage VOUT at the input node 590 in the second phase of operation is equal to 3VIN.

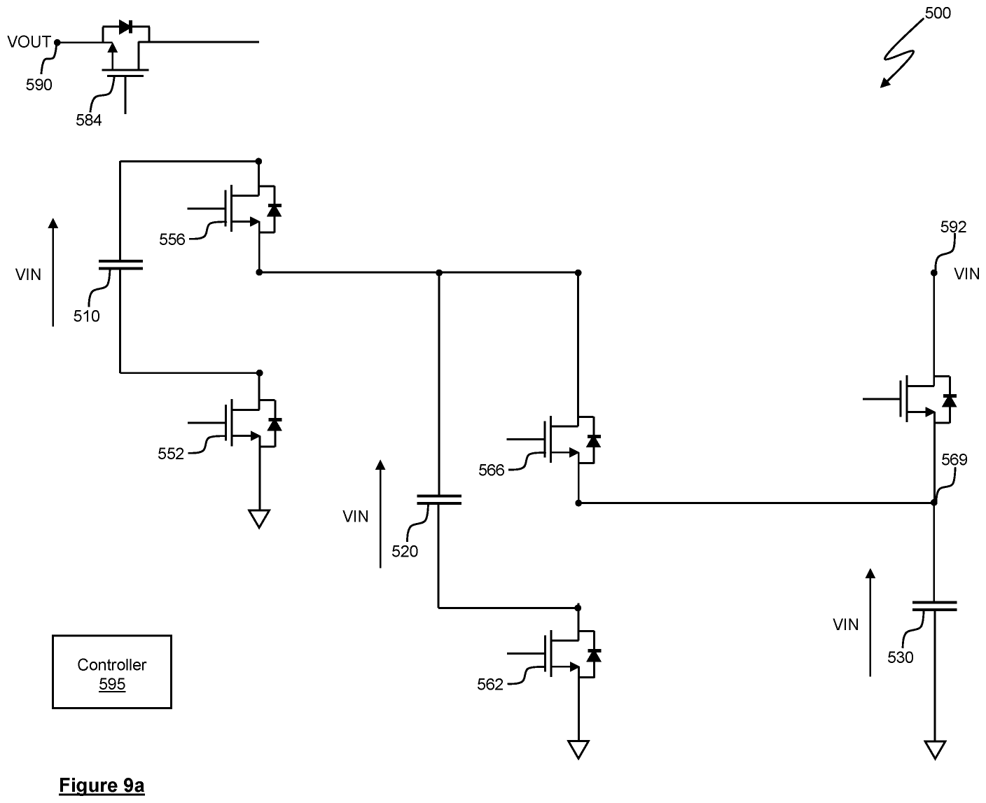

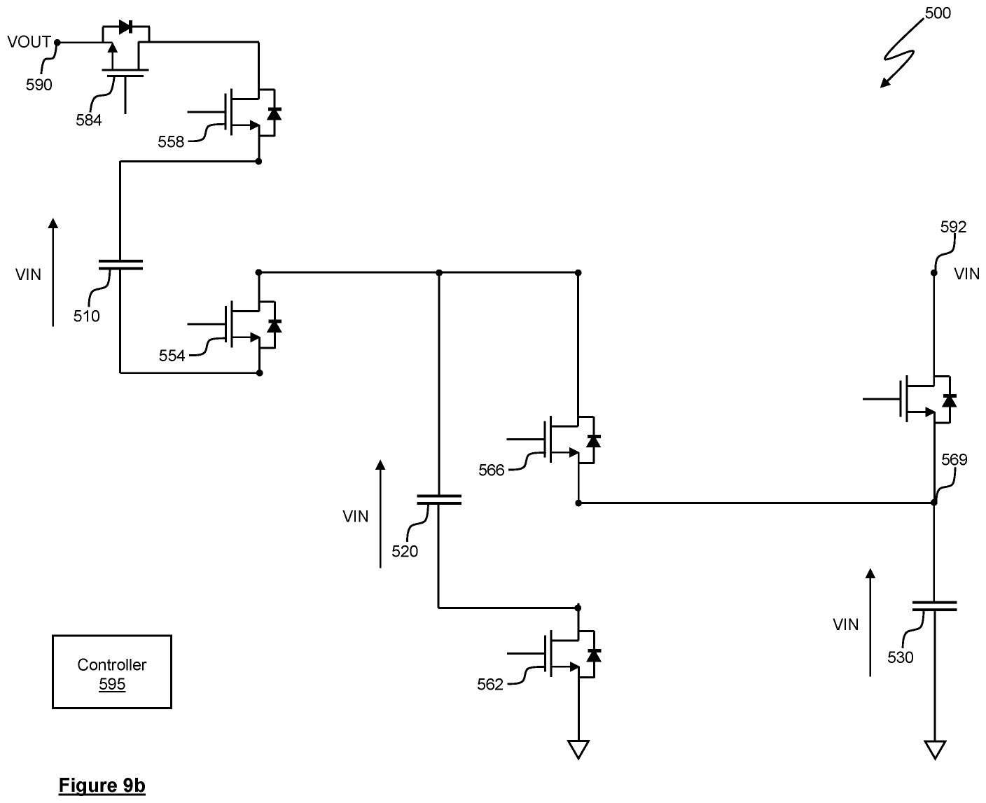

FIGS. 9a and 9b are schematic diagrams illustrating operation of the power converter circuitry 500 in the first reverse mode, as reverse switched capacitor power converter circuitry with a 1:3 input voltage to output voltage ratio (i.e. a step-up conversion factor of 3) to convert an input voltage VIN received at the output node 592 to a higher output voltage VOUT at the input node 590. In this mode, the power converter circuitry 500 operates with a fixed duty cycle of 0.5. In this first reverse mode the third capacitor 530 may receive an input voltage and may thus be referred to as an input capacitor.

In a first phase of operation, shown in FIG. 9a, the first, third, fifth and seventh switches 552, 556, 562, 566 and the output switch 582 (if present) are closed (i.e. switched on) and the other switches 554, 558, 564, 568, 570 are opened (i.e. switched off) in response to suitable control signals from the controller circuitry 595.

With the switch network in this configuration, the third capacitor 530 and the first and second flying capacitors 510, 520 are coupled in parallel with each other, between the battery coupling node 569 (which is in turn coupled to the output node 592 at which an input voltage VIN is received from an external voltage source such as a battery in this first reverse mode) and the ground (or other reference voltage supply) terminal or coupling node. Thus, in the first phase of operation, the third capacitor 530 and the first and second flying capacitor 510, 520 charge up to the input voltage VIN.

In a second phase of operation, shown in FIG. 9b, the second, fourth, fifth and seventh switches 554, 558, 562, 566, the output switch 582 (if present) and the input switch 584 are closed (i.e. switched on) and the other switches 552, 556, 564, 568, 570 are opened (i.e. switched off) in response to suitable control signals from the controller circuitry 595.

With the switch network in this configuration, the third capacitor 530 and the first flying capacitor 510 are coupled in series with each other, between the ground (or other reference voltage supply) terminal or coupling node and the input node 590 (at which an output voltage VOUT is supplied, in this first reverse mode), with the third capacitor 530 being coupled in parallel with the external voltage source. The second flying capacitor 520 is coupled in parallel with the third capacitor 530 between the between the ground (or other reference voltage supply) terminal or coupling node and the battery coupling node 569.

Thus, in the second phase of operation the third capacitor 530 is coupled in parallel with the second flying capacitor 520, between the ground (or other reference voltage supply) terminal or coupling node and the third node 577, and the first flying capacitor 510 is coupled in series with the parallel combination of the third capacitor 530 and the second flying capacitor 520. The first flying capacitor 510 thus acts as an additional voltage source, such that the voltage VIN across the first flying capacitor 510 combines with the voltage VIN across the parallel combination of the external voltage source, the third capacitor 530 and the second flying capacitor 520 to generate the output voltage VOUT. As the third capacitor 530 and the first and second flying capacitors 510, 520 and the third capacitor 530 were each charged to the input voltage VIN during the first phase of operation, the output voltage VOUT at the input node 590 in the second phase of operation is equal to 2VIN.

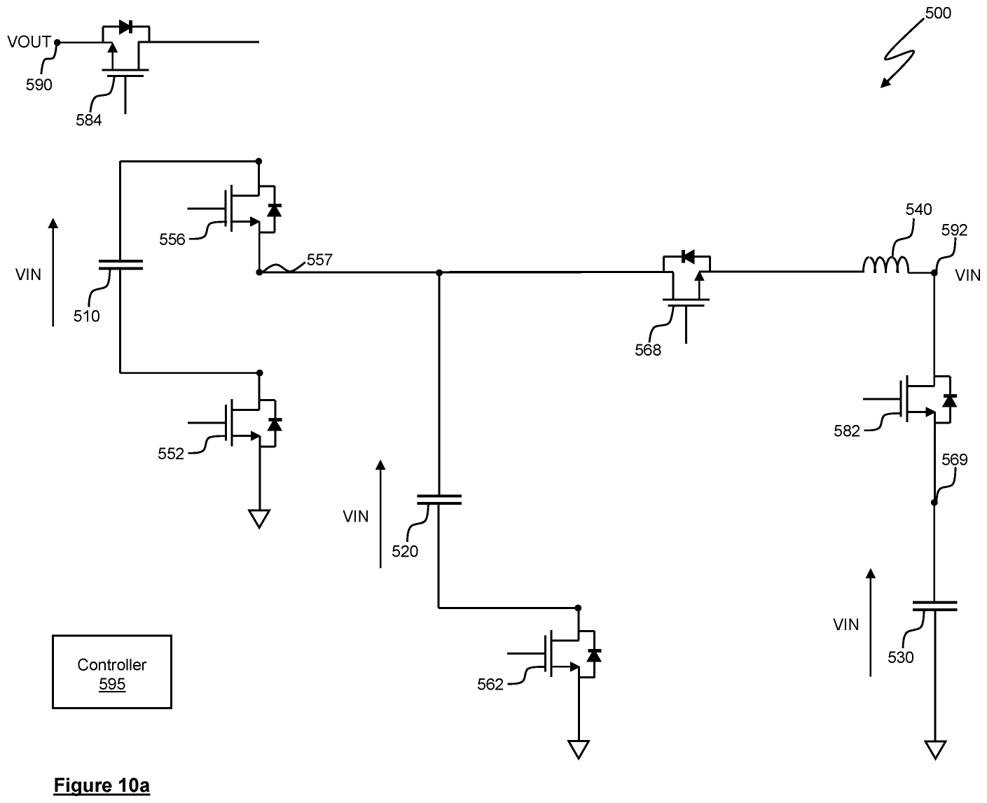

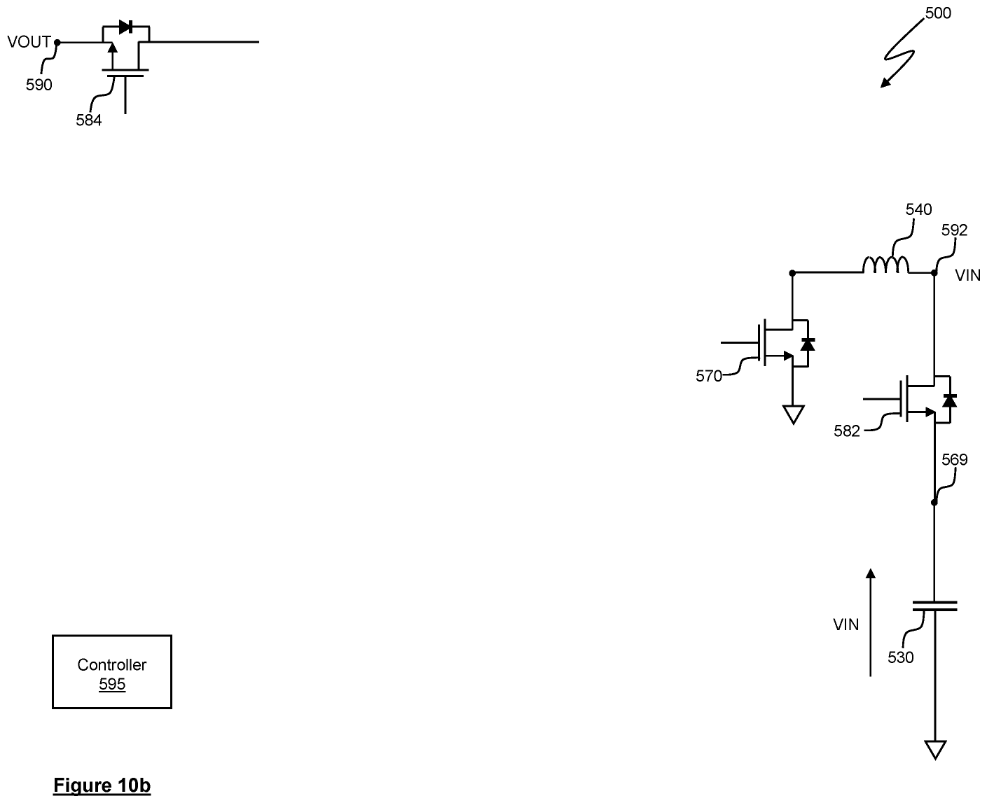

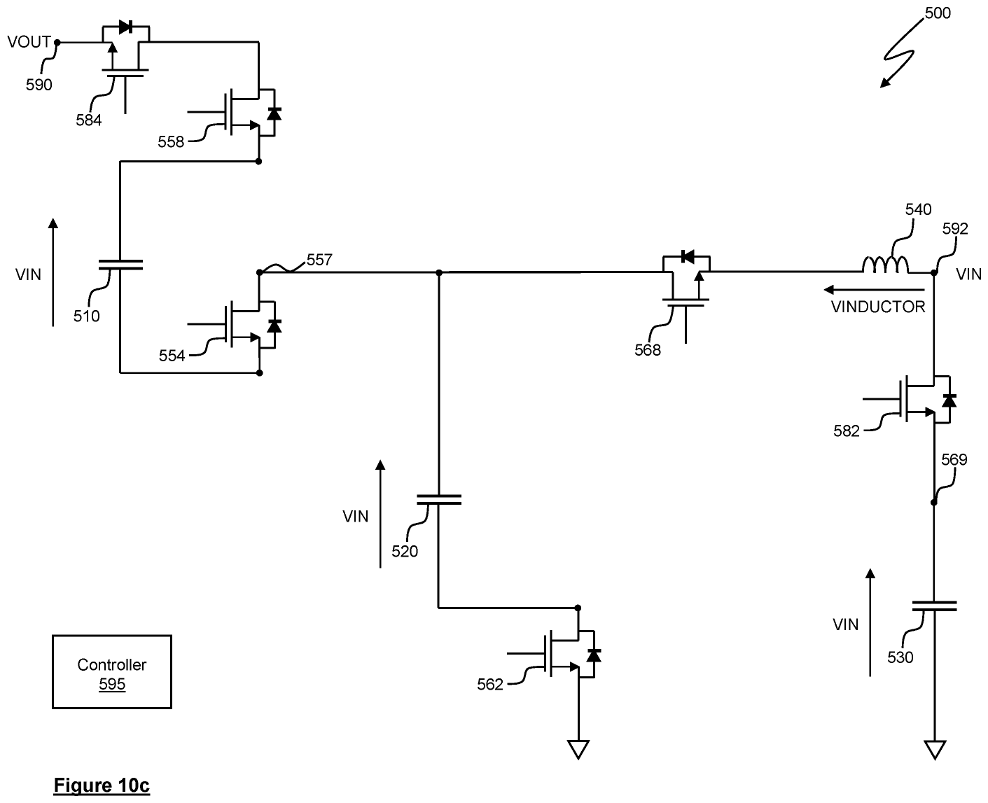

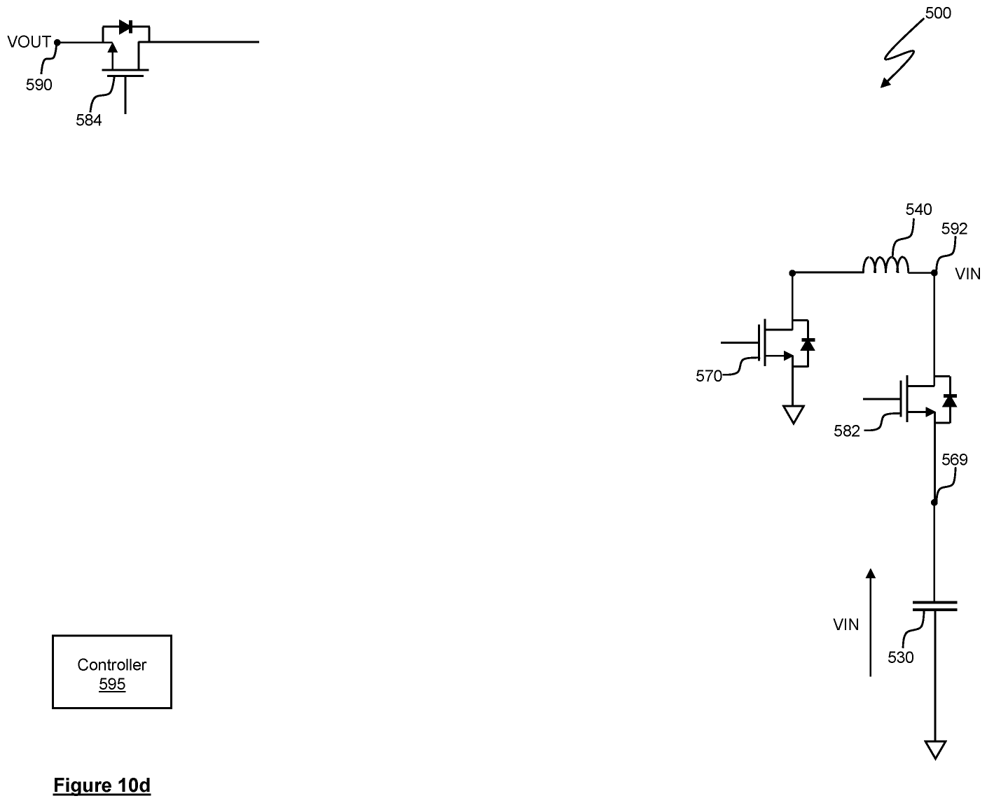

FIGS. 10a-10d are schematic diagrams illustrating operation of the power converter circuitry 500 in the second reverse mode as three-level inductive boost converter circuitry with a duty cycle (defined as a ratio of the input voltage to the output voltage) of less than 0.5, such that the output voltage is greater than twice the input voltage. In this mode the power converter circuitry may apply a non-integer step-up conversion factor to the input voltage VIN to generate the output voltage VOUT. In this second reverse mode the third capacitor 530 may again receive an input voltage and may thus be referred to as an input capacitor.

In a first phase of operation, shown in FIG. 10a, the first, third, fifth and eighth switches 542, 546, 562, 568 and the output switch 582 (if present) are closed (i.e. switched on) and the other switches 554, 558, 564, 568, 570 are opened (i.e. switched off) in response to suitable control signals from the controller circuitry 595.

With the switch network in this configuration, the third capacitor 530 is coupled between the output node 592 (at which an input voltage VIN is received from an external voltage source such as a battery 150 in this second reverse mode of operation) and the ground (or other reference voltage supply) terminal or coupling node. The inductor 540 is coupled between the output node 592 and the third node 557. The first and second flying capacitors 510, 520 are coupled in parallel with each other between the ground (or other reference voltage supply) terminal or coupling node and the third node 557.

Thus, in the first phase of operation the inductor 540 is coupled in series with a parallel combination of the first and second flying capacitors 510, 520 between the output node 592 and the ground (or other reference voltage supply) terminal or coupling node, and a series combination of the third capacitor 530 and the inductor 540 is coupled in parallel with the first and second flying capacitors 510, 520 between the ground (or other reference voltage supply) terminal or coupling node and the third node 557.

The input voltage VIN thus appears across the third capacitor 530, charging the third capacitor 530 to VIN and also causing an increasing current to flow through the inductor 540, which charges up the first and second flying capacitors 510, 520 to VIN.

In a second phase of operation, shown in FIG. 10b, the ninth switch 570 and the output switch 582 (if present) are closed (i.e. switched on) and the other switches 552-568 are opened (i.e. switched off) in response to suitable control signals from the controller circuitry 595.

With the switch network in this configuration, the third capacitor 530 and the inductor 540 are coupled in parallel between the output node 592 and the ground (or other reference voltage supply) terminal or node.

The input voltage VIN thus appears across the third capacitor 530 and the inductor 540, causing the third capacitor 530 to charge up to VIN and an increasing current to flow through the inductor 540.

In a third phase of operation, shown in FIG. 10c, the second, fourth, fifth and eighth switches 554, 558, 562, 568 and the output switch 582 (if present) are closed (i.e. switched on) and the other switches 552, 556, 654, 566, 570 are opened (i.e. switched off) in response to suitable control signals from the controller circuitry 595. The input switch 584 is also closed (i.e. switched on) in response to a suitable control signal from the controller circuitry 595.

With the switch network in this configuration, the inductor 540 and the first flying capacitor 510 are coupled in series between the output node 592 and the input node 590. The third capacitor 530 is coupled between the output node 592 and the ground (or other reference voltage supply) terminal or node. The second flying capacitor 520 is coupled between the ground (or other reference voltage supply) terminal or node and output node 592 (which is coupled to the third node 557). The first and second flying capacitors 510, 520 are coupled in series between the ground (or other reference voltage supply) terminal or coupling node and the input node 590, and the series combination of the inductor 540 and the third capacitor 530 is coupled in parallel with the second flying capacitor 520, between the ground (or other reference voltage supply) terminal or coupling node and the output node 592.

Thus, in the third phase of operation, the third capacitor 530 acts as an additional voltage source in parallel with the external voltage source (e.g. battery 150) that is coupled to the output node 592, and the inductor 540 and first flying capacitor 510 act as additional voltage sources in series with the external voltage source. Thus, an output voltage VOUT, which is a combination of the input voltage VIN (from the parallel combination of the external voltage source and the third capacitor 530), the voltage VIN across the first flying capacitor 510, the voltage VIN across the second flying capacitor 520, and a voltage VINDUCTOR across the inductor 540 (which is dependent upon the duty cycle of the power converter circuitry 500) is supplied at the input node 590. VOUT is therefore equal to 2VIN+VINDUCTOR.

In a fourth phase of operation, shown in FIG. 10c, the switch network again adopts the configuration used in the second phase, with the ninth switch 570 and the output switch 582 (if present) being closed (i.e. switched on) and the other switches 552-568 being opened (i.e. switched off) in response to suitable control signals from the controller circuitry 595.

With the switch network in this configuration, the third capacitor 530 and the inductor 540 are again coupled in parallel between the output node 592 and the ground (or other reference voltage supply) terminal or node.

The input voltage VIN thus appears across the third capacitor 530 and the inductor 540, maintaining the voltage of the third capacitor 530 at VIN and causing an increasing current to flow through the inductor 540.

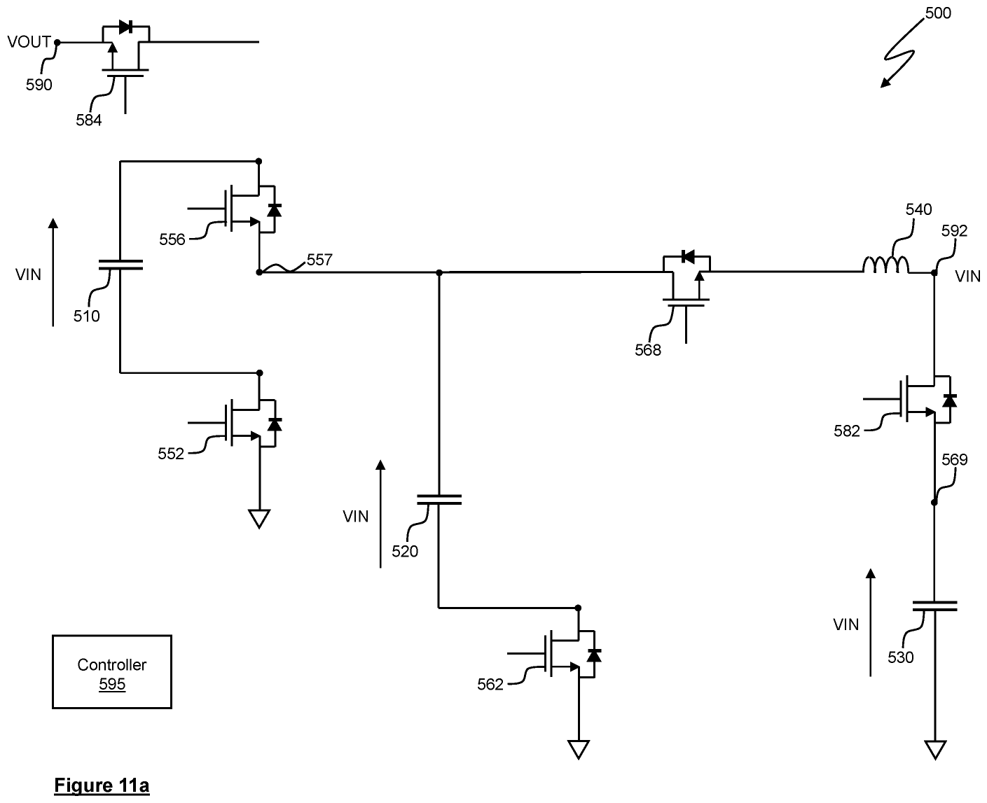

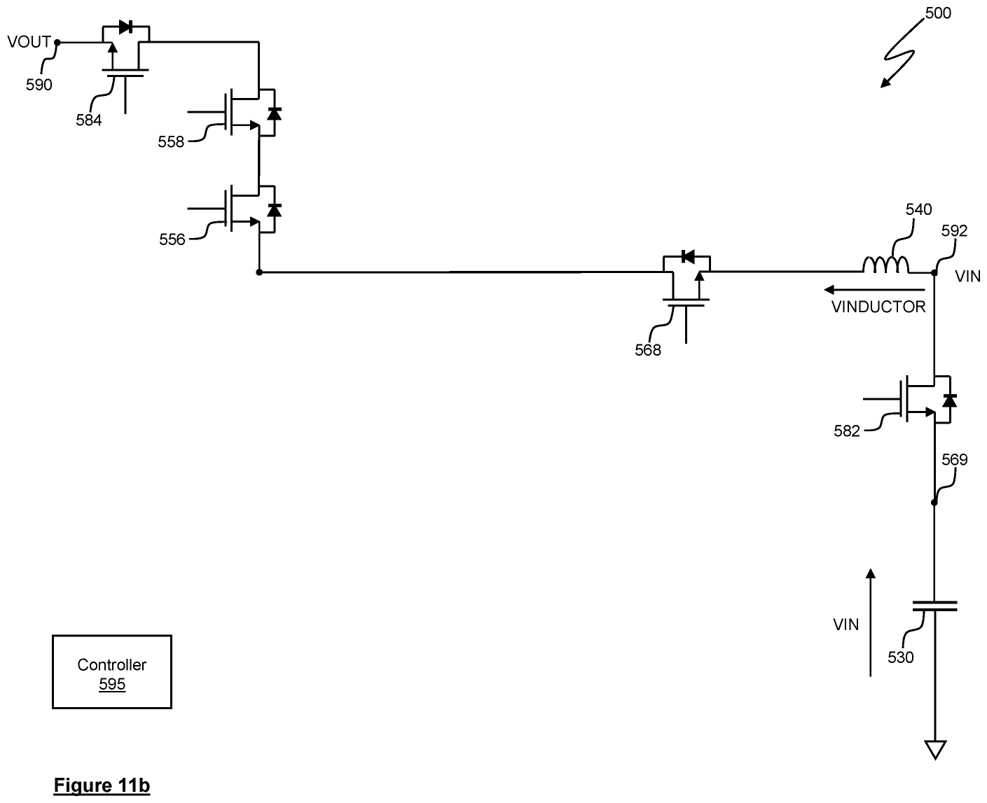

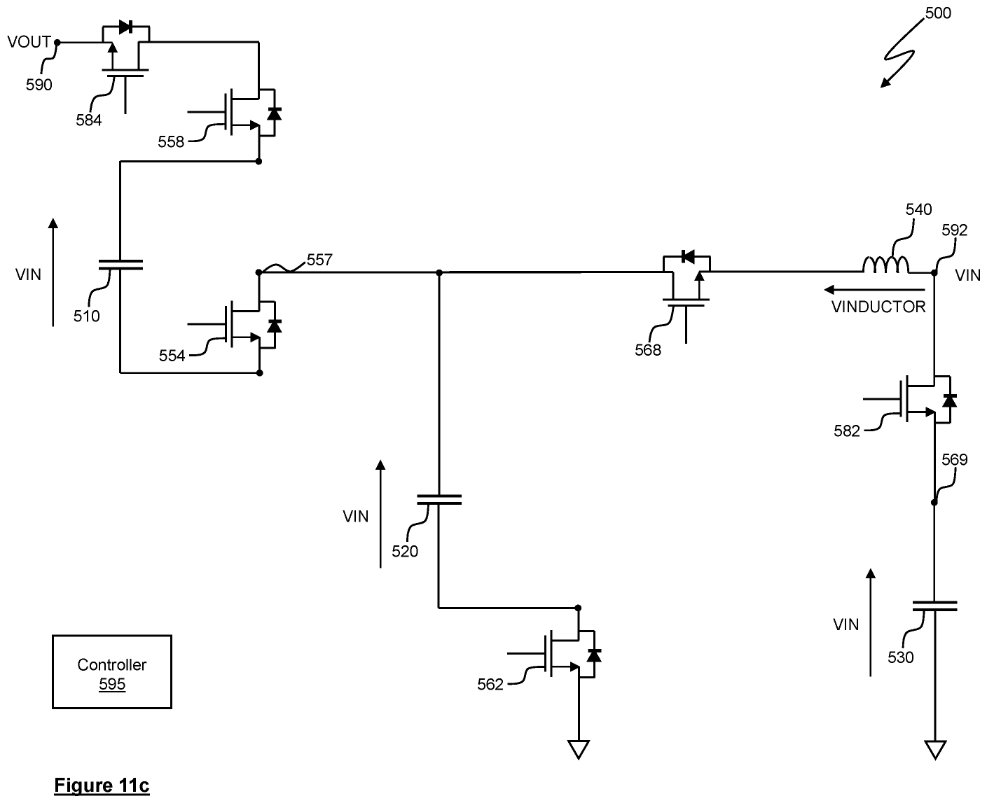

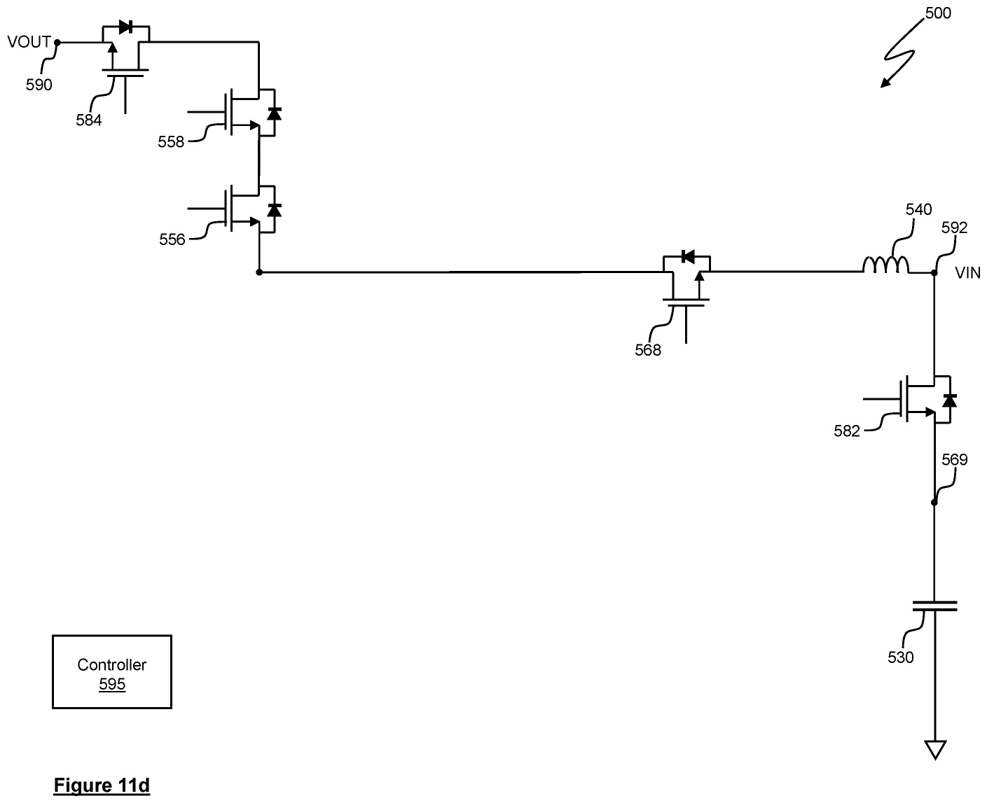

FIGS. 11a-11d are schematic diagrams illustrating operation of the power converter circuitry 500 in the second reverse mode as three-level inductive boost converter circuitry with a duty cycle (defined as a ratio of the input voltage to the output voltage) greater than 0.5, such that the output voltage is less than twice the input voltage. In this mode the power converter circuitry may apply a non-integer step-up conversion factor to the input voltage VIN to generate the output voltage VOUT. In this second reverse mode the third capacitor 530 may again receive an input voltage and may thus be referred to as an input capacitor.

In a first phase of operation, shown in FIG. 11a, the first, third, fifth and eighth switches 552, 556, 562, 568 and the output switch 582 (if present) are closed (i.e. switched on) and the other switches 554, 558, 564, 566 and 570 are opened (i.e. switched off) in response to suitable control signals from the controller circuitry 595.

With the switch network in this configuration, the third capacitor 530 is coupled between the output node 592 (at which an input voltage VIN is received from an external voltage source such as a battery 150 is received, in this second reverse mode of operation) and the ground (or other reference voltage supply) terminal or coupling node. The inductor 540 is coupled between the output node 592 and the third node 557. The first and second flying capacitors 510, 520 are coupled in parallel with each other between the third node 557 and the ground (or other reference voltage supply) terminal or coupling node. A series combination of the third capacitor 530 and the inductor 540 is coupled in parallel with the first and second flying capacitors, between the third node 557 and the ground (or other reference voltage supply) terminal or coupling node.

The input voltage VIN thus appears across the third capacitor 530, causing the third capacitor 530 to charge up to VIN. An increasing current flows through the inductor 540 to the parallel coupled first and second flying capacitors 510, 520, which also charge up to VIN.

In a second phase of operation, shown in FIG. 11b, the input switch 584, the third, fourth and eighth switches 556, 558, 568 and the output switch 582 (if present) are closed (i.e. switched on) and the other switches 552, 554, 562-566, 570 are opened (i.e. switched off) in response to suitable control signals from the controller circuitry 595.

With the switch network in this configuration, the series combination of the inductor 540 and the third capacitor 530 is decoupled from the first and second flying capacitors 510, 520. The inductor 540 and third capacitor 530 are coupled in series between the input node 590 and the ground (or other reference voltage supply) terminal or node. The inductor 540 is coupled in series between the output node 592 and the input node 590, and the third capacitor 530 is coupled between the output node 592 and the ground (or other reference voltage supply) terminal or coupling node.

The voltage across the third capacitor 530 is thus maintained at VIN. The inductor 540 acts as an additional voltage source in series with the external voltage source, such that an output voltage VOUT equal to VIN+VINDUCTOR (where VINDUCTOR is a duty cycle dependent voltage across the inductor 540 in the second phase of operation) is supplied to the input node 590.

In a third phase of operation, shown in FIG. 11c, the input switch 584, the second, fourth, fifth and eighth switches 554, 558, 562, 568, and the output switch 582 (if present) are closed (i.e. switched on) and the other switches 552, 556, 564, 566, 570 are opened (i.e. switched off) in response to suitable control signals from the controller circuitry 595.

With the switch network in this configuration, the inductor 540 and the first flying capacitor 510 are coupled in series between the output node 592 and the input node 590. The third capacitor 530 is coupled between the output node 592 and the ground (or other reference voltage supply) terminal or node. The second flying capacitor 520 is coupled between the ground (or other reference voltage supply) terminal or node and the third node 557. A series combination of the third capacitor 530 and the inductor 540 is coupled in parallel with the second flying capacitor 520, between the third node 557 and the ground (or other reference voltage supply) terminal or coupling node.

Thus, in the third phase of operation, the third capacitor 530 acts as an additional voltage source in parallel with the external voltage source (e.g. battery 150) that is coupled to the output node 592, and the inductor 540 and first flying capacitor 510 act as additional voltage sources in series with the external voltage source. Thus, an output voltage VOUT, which is a combination of the input voltage VIN (from the parallel combination of the external voltage source and the third capacitor 530), the voltage VIN across the first flying capacitor 510, the voltage VIN across the second flying capacitor 520, and a voltage VINDUCTOR across the inductor 540 (which is dependent upon the duty cycle of the power converter circuitry 500) is supplied at the input node 590. VOUT is therefore equal to 2VIN+VINDUCTOR.

In a fourth phase of operation, shown in FIG. 11d, the switch network 440 adopts the same configuration as in the second phase, with the input switch 584, the third, fourth and eighth switches 556, 558, 568 and the output switch 582 (if present) being closed (i.e. switched on) and the other switches 552, 554, 562-566, 570 being opened (i.e. switched off) in response to suitable control signals from the controller circuitry 595.

With the switch network in this configuration, the series combination of the inductor 540 and the third capacitor 530 is again decoupled from the first and second flying capacitors 510, 520. The inductor 540 and third capacitor 530 are coupled in series between the input node 590 and the ground (or other reference voltage supply) terminal or node. The inductor 540 is again coupled in series between the output node 592 and the input node 590, and the third capacitor 530 is coupled between the output node 592 and the ground (or other reference voltage supply) terminal or coupling node.

The voltage across the third capacitor 530 is thus maintained at VIN. The inductor 540 acts as an additional voltage source in series with the external voltage source, such that an output voltage VOUT equal to VIN+VINDUCTOR (where VINDICTOR is a duty cycle dependent voltage across the inductor 540 in the second phase of operation) is supplied to the input node 590.

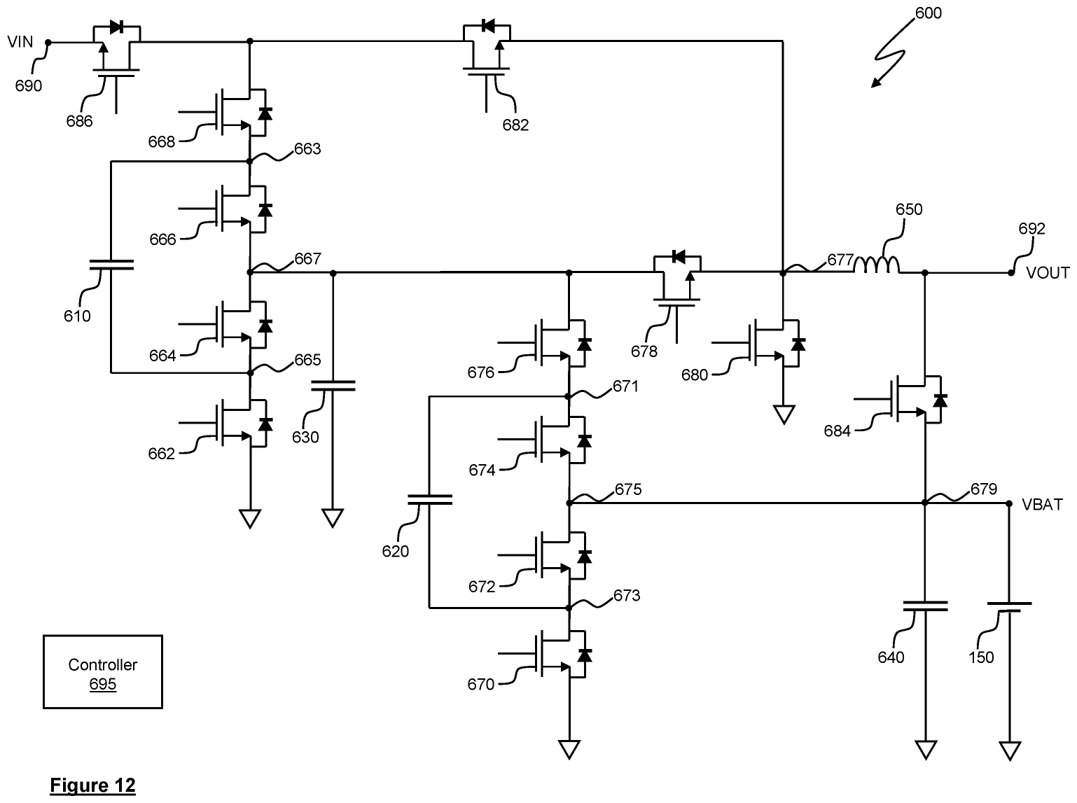

FIG. 12 is a schematic representation of alternative example power converter circuitry according to the present disclosure, which combines inductive buck converter circuitry and switched capacitor power converter circuitry into a single circuit. The power converter circuitry of the present disclosure may thus be referred to as a combined power converter circuit (or combined power converter circuitry).

The power converter circuitry, shown generally at 600 in FIG. 12, is operable in a first forward mode as switched capacitor converter circuitry and in a second forward mode as inductive buck converter circuitry. In the first and second forward modes, the power converter circuitry 600 is operative to step down an input voltage to generate an output voltage.

The power converter circuitry 600 is also operable in a first reverse mode as switched capacitor power converter circuitry, and in a second reverse mode as inductive boost converter circuitry. In the first and second reverse modes, the power converter circuitry 600 is operative to step up an input voltage to generate an output voltage.

The power converter circuitry 600 in the illustrated example includes a first capacitor 610 (which is also referred to herein as a first flying capacitor 610), a second flying capacitor 620 (also referred to herein as a second flying capacitor 620), a third capacitor 630 (which may also be referred to as a first output capacitor 630 when the power converter circuitry is operating in its forward modes and as a first input capacitor 630 when the power converter circuitry is operating in its reverse modes), a fourth capacitor 640 (which may also be referred to as a second output capacitor 640 when the power converter circuitry is operating in its forward modes and as a second input capacitor 640 when the power converter circuitry is operating in its reverse modes) and an inductor 650. The first, second, third and fourth capacitors 610, 620, 630, 640 may be of equal capacitance.

The power converter circuitry 600 further includes a switch network comprising, in this example, first to eleventh switches 662-682. The switch network is configured to be coupled to the first and second flying capacitors 610, 620, the first and second output capacitors 630, 640 and the inductor 650.

In the example shown in FIG. 12, an output switch 684, which in this example is a MOSFET device, is coupled between the inductor 650 and a battery coupling node 679 to which a first terminal of the fourth capacitor 640 and, in sue of the power converter circuitry 600 in a battery charging application, a battery 150, are coupled. In other examples, the output switch 684 may be omitted, and the inductor 650 may instead be coupled to the node 684 and thus to the first terminal of the fourth capacitor 640. The output switch 684 (where provided) fulfils the function of the battery controller transistor 136 of FIG. 1a, and is thus operable to selectively couple the battery 150 to the inductor 650 when the power converter circuitry 600 is operating as inductive buck converter or inductive boost converter circuitry, as will be explained in more detail below.

An input switch 686, which in this example is a MOSFET device, is coupled between the fourth switch 668 of the switch network and an input node 690 at which an input voltage VIN is received. The input switch 686 is operable to activate and deactivate the power converter circuitry 600 by selectively coupling the switch network to, and decoupling the switch network from, the input node 690.

The power converter circuitry 600 further includes controller circuitry 695, which is configured to control operation of the switch network to cause the power converter circuitry 600 to operate in a desired mode, as described in more detail below. The controller circuitry 695 may be implemented in discrete circuitry or integrated circuitry, or may be implemented by a microprocessor, microcontroller, sate machine or the like, executing suitable instructions.

The power converter circuitry 600 may be said to comprise switched capacitor power converter circuitry and inductive buck or boost converter circuitry, with the switch network, the first and second flying capacitor 610, 620 and the first and second output capacitors 630, 640 being common to or shared by the switched capacitor power converter circuitry and the inductive buck or boost converter circuitry.

In some examples, the power converter circuitry 600 is implemented in a single integrated circuit. In such examples, the first and second flying capacitors 610, 620, the first and second output capacitors 630, 640, the inductor 650, the switch network, the output switch 684, the input switch 686 and the controller circuitry 695 are provided as part of the integrated circuit, i.e. are provided on-chip.

In other examples, the first and second flying capacitors 610, 620, first and second output capacitor 630, 640 and inductor 650 may be provided externally of the integrated circuit (i.e. off-chip), and the switch network, the output switch 684, the input switch 686 and the controller circuitry 695 may be implemented in a single integrated circuit. In such examples, the integrated circuit may comprise a first set of one or more terminals (pins, pads, balls or the like) by means of which an external (i.e. off-chip) first flying capacitor 610 can be coupled to a first set of one or more coupling nodes of the switch network. Similarly, the integrated circuit may comprise a second set of one or more terminals (pins, pads, balls or the like) by means of which an external (i.e. off-chip) second flying capacitor 620 can be coupled to a second set of one or more coupling nodes of the switch network, a third set of one or more terminals (pins, pads, balls or the like) by means of which an external (i.e. off-chip) third capacitor 630 can be coupled to a third set of one or more coupling nodes of the switch network, a fourth set of one or more terminals (pins, pads, balls or the like) by means of which an external (i.e. off-chip) fourth capacitor 640 can be coupled to a third set of one or more coupling nodes of the switch network, and a fifth set of one or more terminals (pins, pads, balls or the like) by means of which an external (i.e. off-chip) inductor 650 can be coupled to a fifth set of one or more coupling nodes of the switch network. The coupling nodes of the switch network are described in more detail below.

As shown in FIG. 12, the first to fourth switches 662-668 of the switch network are coupled in series between the ground (or other reference voltage supply) terminal or coupling node and the input switch 686. The fifth to eighth switches 670-676 are coupled in series between the ground (or other reference voltage supply) terminal or coupling node and a node (referred to as the sixth node 667) between the second and third switches 664, 666.

In use of the power converter circuitry 600, a first terminal of the first flying capacitor 610 is coupled to a first node 663 of the switch network, between the third switch 666 and the fourth switch 668. A second terminal of the first flying capacitor 610 is coupled to a second node 665 of the switch network, between the first switch 662 and the second switch 664. Thus, the first node 663 and the second node 665 of the switch network constitute a set of coupling nodes for the first flying capacitor 610.

A first terminal of the second flying capacitor 620 is coupled to a third node 671 of the switch network, between the seventh switch 674 and the eighth switch 676. A second terminal of the second flying capacitor 620 is coupled to a fourth node 673 of the switch network, between the fifth switch 670 and the sixth switch 672. Thus, the third node 671 and the fourth node 673 of the switch network constitute a set of coupling nodes for the second flying capacitor 620.

The battery coupling node 679 is coupled to a fifth node 675 of the switch network, between the sixth switch 672 and the seventh switch 674.

The switch network further includes a ninth switch 678 (which is a MOSFET device, in the illustrated example) coupled between a sixth node 667 between the second and third switches 664, 666 and a seventh node 677. In use of the power converter circuitry 600, the seventh node 677 is coupled to a first terminal of the inductor 650. The seventh node 677 thus constitutes a first coupling node for the inductor 650.

The switch network further includes a tenth switch 680 (which is also a MOSFET device, in the illustrated example) coupled between the seventh node 677 and a ground (or other reference voltage) supply terminal or node.

The switch network further includes an eleventh switch 682 (which is also a MOSFET device, in the illustrated example) coupled between the input switch 686 and the seventh node 677.

In use of the power converter circuitry 600, a first terminal of the third capacitor 630 is coupled to the sixth node 667. A second terminal of the third capacitor 630 is coupled to the ground (or other reference voltage) terminal or coupling node. The sixth node 667 thus constitutes a first coupling node for the third capacitor 630.

In use of the power converter circuitry 600, a first terminal of the fourth capacitor 640 is coupled battery coupling node 679, which is in turn coupled to the fifth node 675. A second terminal of the fourth capacitor 640 is coupled to the ground (or other reference voltage) terminal or coupling node. The battery coupling node 679 thus constitutes a first coupling node for the fourth capacitor 640.

In examples in which the output switch 684 is provided, the output switch 684 is coupled between the battery coupling node 679 and the output node 682. battery coupling node 679 In examples in which the output switch is 684 not provided, the second terminal of the inductor 650 is coupled to the fifth node 675. In both examples, the second terminal of the inductor 650 is coupled to the output node 692, such that the output node 692 constitutes a second coupling node for the inductor 650.

Thus, as will be appreciated, the combination of the first to eighth switches 662-676, the first and second flying capacitors 610, 620 and the first and second output capacitors 630, 640 of the power converter circuitry 600 constitutes switched capacitor power converter circuitry, and the combination of the switch network, the first and second flying capacitors 610, 620, the first and second output capacitors 630, 640 and the inductor 650 constitutes inductive buck or boost converter circuitry. Thus, the power converter circuitry 600 may be said to comprise switched capacitor power converter circuitry and inductive buck or boost converter circuitry, with the switch network, the first and second flying capacitors 610, 620 and the first and second output capacitors 630, 640 being common to or shared by the switched capacitor power converter circuitry and the inductive buck or boost converter circuitry.

As will be apparent from FIG. 12, the power converter circuitry 600 in the example illustrated in FIG. 12 includes a total of twelve switches, four capacitors and one inductor. In some examples, however, there may only be ten switches, as the input switch 686 may be omitted, e.g. if a back to back switch is used, externally of the power converter circuitry 600, in an input signal path to the input node 690, and the output switch 684 may also be omitted.

In contrast, in the charging system of the kind shown in FIG. 1a in which the switched capacitor power converter circuitry 140 and the inductive buck converter circuitry implemented by the PMIC are provided as separate circuits of the kind shown in FIGS. 1d and 1c respectively, a total of eighteen switches (or sixteen, if the input switch 280 and the battery controller transistor 136 are omitted) and seven capacitors are required to implement the inductive buck converter circuitry and the switched capacitor power converter circuitry 140. Thus, the power converter circuitry 600 of FIG. 12 requires six fewer switches and three fewer capacitors than a charging system of the kind shown in FIG. 1a in which the switched capacitor power converter circuitry 140 and the inductive buck converter circuitry implemented by the PMIC and are provided as separate circuits of the kind shown in FIGS. 1d and 1c respectively.

In the example shown in FIG. 12, the switches 662-682 of the switch network are shown as being implemented by single MOSFET devices. However, in some implementations, the seventh switch 674, and/or the eighth switch 676 and/or the ninth switch 678 may be implemented as two back to back connected MOSFET devices, as shown in FIG. 3.

As noted above, the power converter circuitry 600 is operable in a first forward mode as switched capacitor power converter circuitry and in a second forward mode as inductive buck converter circuitry. The power converter circuitry 600 is also operable in a first reverse mode as switched capacitor power converter circuitry, and in a second reverse mode as or inductive boost converter circuitry.

When operating in the first forward mode as switched capacitor power converter circuitry, the power converter circuitry 600 can operate as a forward switched capacitor power converter with either a 4:1 a 2:1 input voltage to output voltage ratio to supply power to a component coupled to its output node 692, e.g. to supply power to charge a battery 150. Thus, when operating in the first forward mode (i.e. in a forward switched capacitor converter mode), the power converter circuitry 600 is operative to generate the output voltage VOUT by applying a substantially integer step-down conversion factor (i.e. the input voltage VIN is an integer multiple of the output voltage VOUT) to the input voltage VIN.

When operating in the second forward mode as inductive buck converter circuitry, the power converter circuitry 600 operates as a forward 3-level inductive buck converter to supply power to a component coupled to its output node 692, e.g. to supply power to charge a battery 150. Thus, when operating in the second forward mode (i.e. in an inductive buck converter mode), the power converter circuitry 600 is operative to generate the output voltage VOUT by applying a substantially non-integer step-down conversion factor (i.e. the input voltage VIN is a non-integer multiple of the output voltage VOUT) to the input voltage VIN.

When operating in the first reverse mode as switched capacitor power converter circuitry, the power converter circuitry 600 can operate as a reverse switched capacitor power converter with a 1:4 or 1:2 input voltage to output voltage ratio to supply power from a component such as a battery 150 coupled to its output node 692 to a component or subsystem (e.g. a wireless charging subsystem) coupled to its input node 690. Thus, when operating in the first reverse mode (i.e. in a reverse switched capacitor converter mode), the power converter circuitry 600 is operative to generate the output voltage VOUT by applying a substantially integer step-up conversion factor (i.e. the output voltage VOUT is an integer multiple of the input voltage VIN) to the input voltage VIN.

When operating in the second reverse mode as inductive boost converter circuitry, the power converter circuitry 600 operates as reverse 3-level inductive boost converter to supply power from a component such as a battery 150 coupled to its output node 692 to a component or subsystem (e.g. a wireless charging subsystem) coupled to its input node 690. Thus, when operating in the second reverse mode (i.e. in an inductive boost converter mode), the power converter circuitry 600 is operative to generate the output voltage VOUT by applying a non-integer step-up conversion factor (i.e. the output voltage VOUT is a non-integer multiple of the input voltage VIN) to the input voltage VIN.

The ability of the power converter circuitry 600 to apply a substantially integer step-down or step-up conversion factor to the input voltage VIN (when operating in the first forward mode and the first reverse mode, respectively) and to apply a non-integer step-down or step up conversion factor to the input voltage VIN (when operating in the second forward mode or the second reverse mode, respectively) allows selection between coarse control of the output voltage VOUT (in the first mode) and finer control of the output voltage VOUT (in the second mode) as required by the application in which the power converter circuitry 600 is used. For example, in a battery charger application, coarse control of the output voltage VOUT (as provided by the power converter circuitry 600 in its first mode) may be sufficient for the first, fast charging stage, whereas in the second, CC-CV stage, finer control of the output voltage VOUT (as provided by the power converter circuitry 500 in its second mode) may be required.

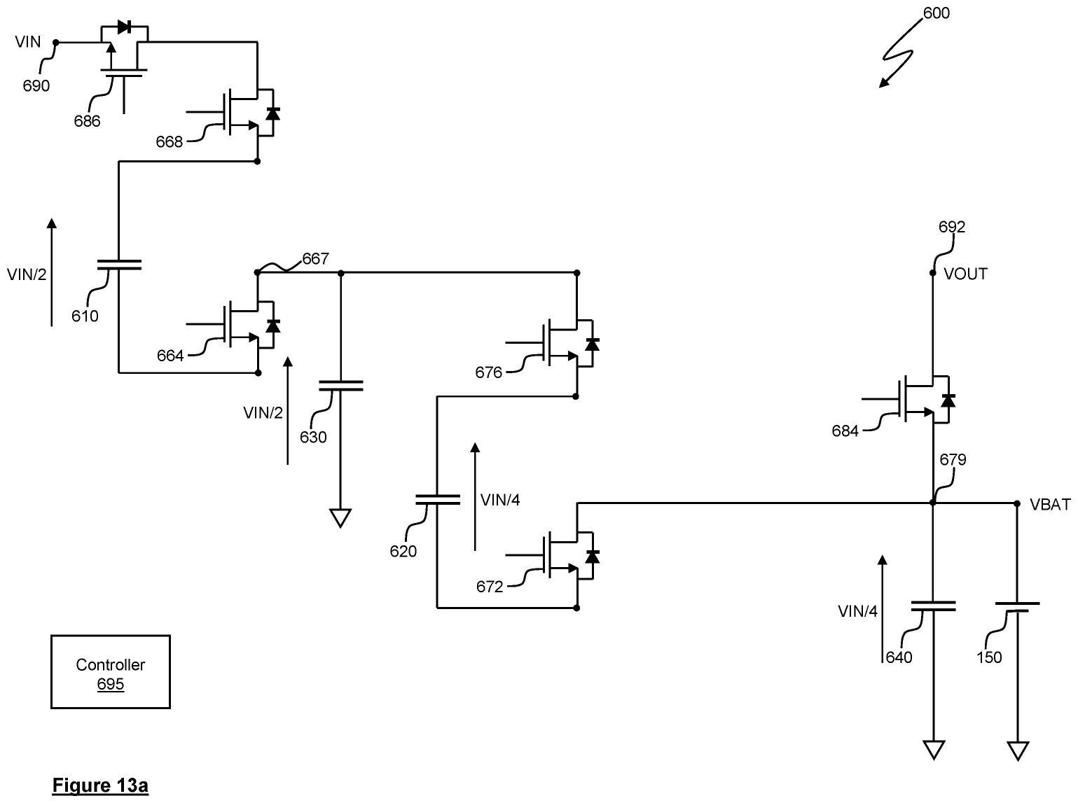

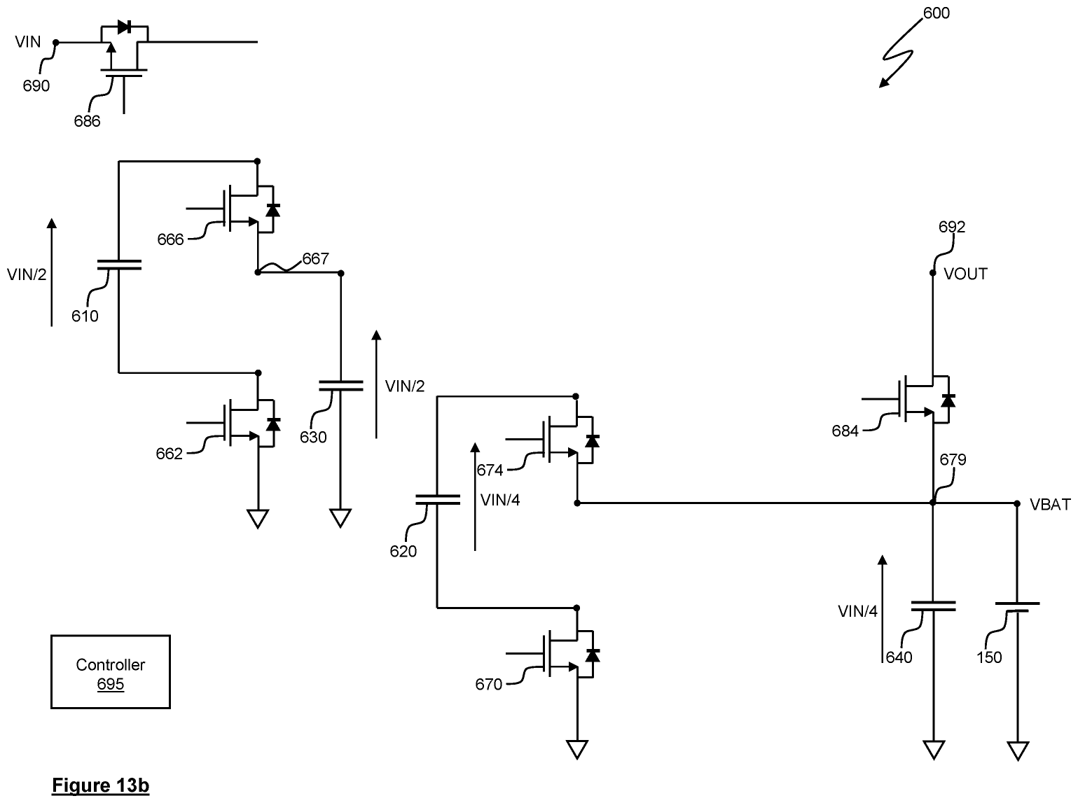

FIGS. 13a and 13b are schematic diagrams illustrating operation of the power converter circuitry 600 in the first forward mode, as switched capacitor power converter circuitry with a 4:1 input voltage to output voltage ratio, i.e. a step-down conversion factor of 4.

In a first phase of operation, shown in FIG. 13a, the input switch 686 and the second, fourth, sixth and eighth switches 664, 668, 672, 676 of the switch network and the output switch 684 (if present) are closed (i.e. switched on) in response to suitable control signals from the controller circuitry 695. The other switches 662, 666, 674, 678, 680, 682 are opened (i.e. switched off) in response to suitable control signals from the controller circuitry 695 (and are thus not shown in FIG. 13a). In this first forward mode the third and fourth capacitors 630, 640 may support an output voltage, and may thus be referred to as first and second output capacitors 630, 640 respectively.

With the switch network in this configuration, the first flying capacitor 610 and the third capacitor 630 are coupled in series between the input node 690 and the ground (or other reference voltage) supply terminal or coupling node. The second flying capacitor 620 is coupled between the sixth node 667 and the battery coupling node 679, which is in turn coupled to the output node 692. The fourth capacitor 640 is coupled between the battery coupling node 679 and the ground (or other reference voltage supply) terminal or coupling node. Thus, the first and second flying capacitors 610, 620 are coupled in series between the input node 690 and the output node 692, and the first and second flying capacitors 610, 620 and the fourth capacitor 640 are coupled in series between the input node 690 and the ground (or other reference voltage supply) terminal or coupling node.

Thus, if the first flying capacitor 610 and the third capacitor 630 are of equal capacitance, a voltage of VIN/2 develops across each of the first flying capacitor 610 and the third capacitor 630. The first flying capacitor 610 and the third capacitor 630 thus charge up to VIN/2, and a voltage VIN/2 is present at the sixth node 667. Thus, if the second flying capacitor 620 and the fourth capacitor 640 are of equal capacitance, a voltage of VIN/4 develops across each of the second flying capacitor 620 and the fourth capacitor 640. The second flying capacitor 620 and the fourth capacitor 640 thus charge up to VIN/4, and the output voltage VOUT is equal to VIN/4.

In a second phase of operation, shown in FIG. 13b, the first, third, fifth and seventh switches 662, 666, 670, 674 and the output switch 684 (if present) are closed (i.e. switched on) in response to suitable control signals from the controller circuitry 695. The other switches 664, 668, 672, 676-682 are opened (i.e. switched off) in response to suitable control signals from the controller circuitry 695 (and are thus not shown in FIG. 13b).

With the switch network in this configuration, the first flying capacitor 610 and the third capacitor 630 are coupled in parallel between the sixth node 667 and the ground (or other reference voltage supply) terminal or coupling node, such that charge on the first flying capacitor 610 and the third capacitor 630 balances and the voltage across each of the first flying capacitor 610 and the third capacitor 630 is maintained at VIN/2.

The second flying capacitor 620 and the fourth capacitor 640 are coupled in parallel between the output node 692 and the ground (or other reference voltage supply) terminal or coupling node. Thus, in the second phase of operation, the peak output voltage VOUT is equal to the voltage that developed across the second flying capacitor 620 and the fourth capacitor 640 during the first phase, and so the peak output voltage VOUT in the second phase of operation is VIN/4.

In operation of the power converter circuitry 600 in the first forward mode as switched capacitor power converter circuitry with a 4:1 input voltage to output voltage ratio, a duty cycle of the power converter circuitry is fixed at 0.5, such that the duration of the first phase is equal to half of a total duration of the first and second phases. As a result of this fixed duty cycle, the voltage across the first and second flying capacitors 610, 620 is maintained at VIN/2 and VIN/4 respectively, so there is no need for additional circuitry for balancing the voltage of the first and second flying capacitors 610, 620.

As will be appreciated by those of ordinary skill in the art, if the output switch 684 is switched on or is not present, a voltage equal to VIN/2 is also present at the output node 692 as an output voltage VOUT during operation of the power converter circuitry 600 in the first forward mode as switched capacitor power converter circuitry with a 4:1 input voltage to output voltage ratio. The output voltage VOUT can be used as a supply voltage by a system (not shown in FIGS. 13a and 13b) that may be coupled to the output node 692. Thus, when the power converter circuitry 600 is operating in its first forward mode as switched capacitor power converter circuitry with a 4:1 input voltage to output voltage ratio it can simultaneously supply a charging current to a battery 150 and a supply voltage to an external system.

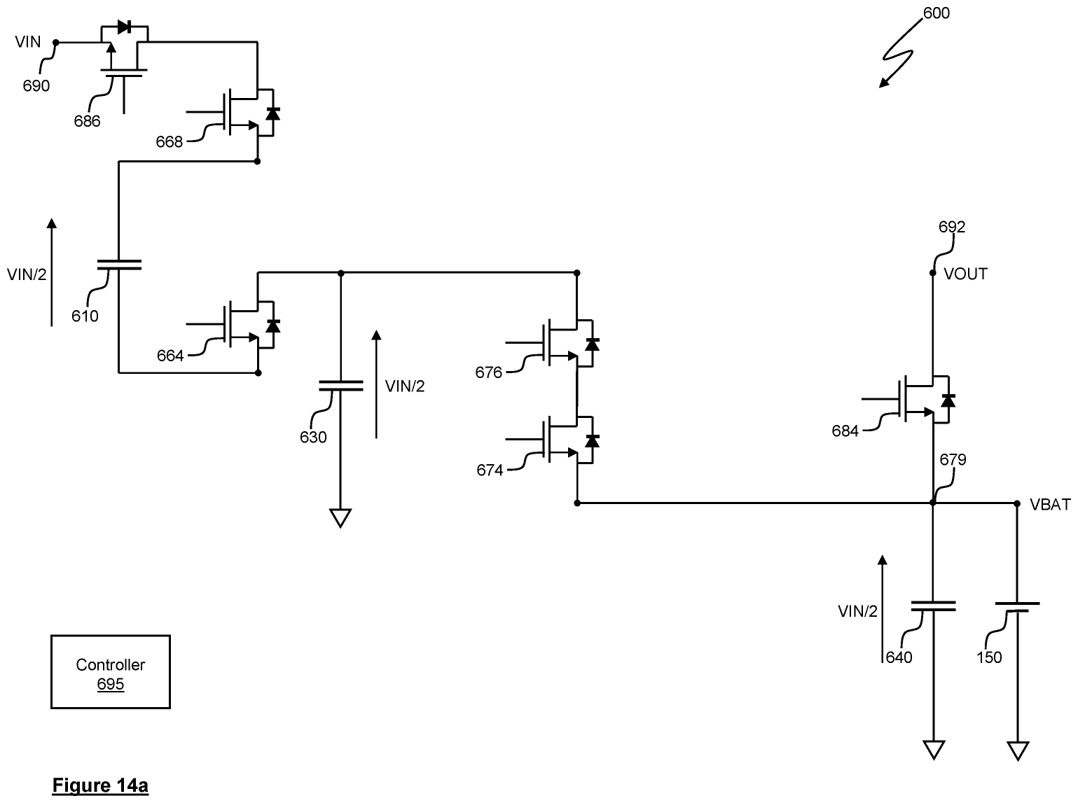

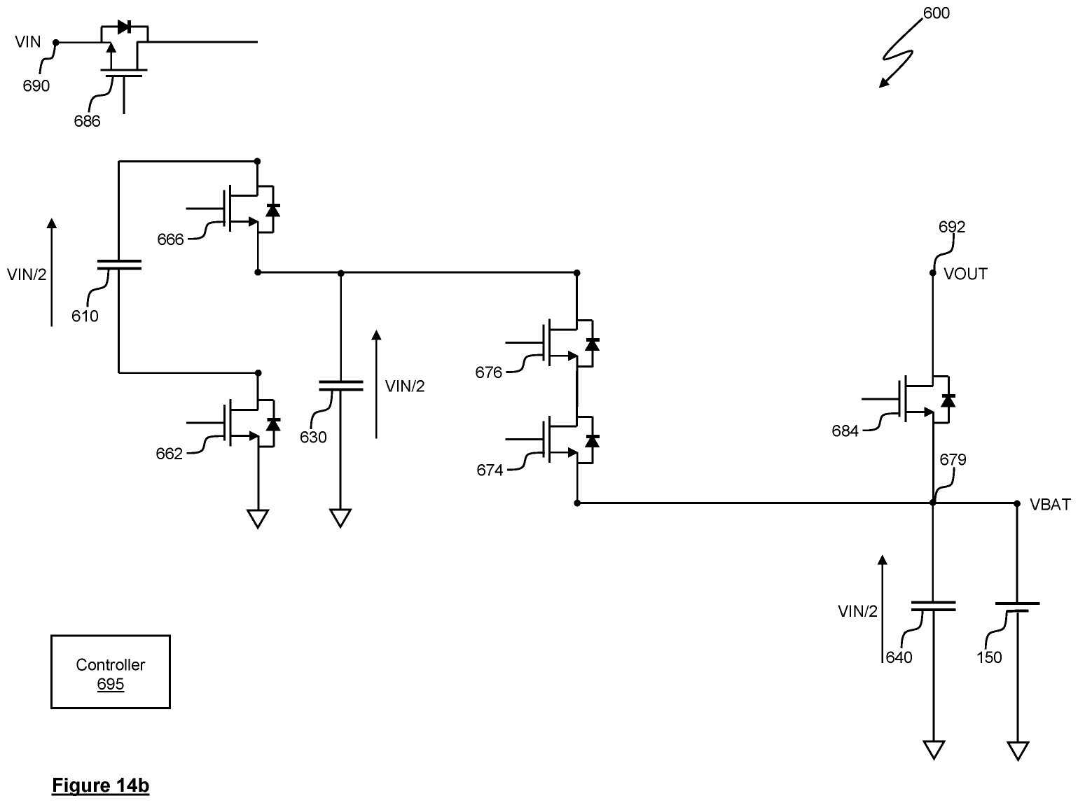

FIGS. 14a and 14b are schematic diagrams illustrating operation of the power converter circuitry 600 in the first forward mode, as switched capacitor power converter circuitry with a 2:1 input voltage to output voltage ratio, i.e. a step-down conversion factor of 2. In this first forward mode the third and fourth capacitors 630, 640 may again support an output voltage, and may thus be referred to as first and second output capacitors 630, 640 respectively.

In a first phase of operation, shown in FIG. 14a, the input switch 686, the second, fourth, seventh and eighth switches 664, 668, 674, 676 of the switch network and the output switch 684 (if present) are closed (i.e. switched on) in response to suitable control signals from the controller circuitry 695. The other switches 662, 666, 672, 678, 680, 682 are opened (i.e. switched off) in response to suitable control signals from the controller circuitry 695 (and are thus not shown in FIG. 14a).

With the switch network in this configuration, the first flying capacitor 610 and the third capacitor 630 are coupled in series between the input node 690 and the ground (or other reference voltage) supply terminal or coupling node. The fourth capacitor 640 is coupled between the output node 692 and the ground (or other reference voltage supply) terminal or coupling node. The first flying capacitor 610 and the fourth capacitor 640 are thus coupled in series between the input node 690 and the ground (or other reference voltage supply) terminal or coupling node, and the first flying capacitor 610 is coupled in series with a parallel combination of the third capacitor 630 and the fourth capacitor 640, between the input node 690 and the ground (or other reference voltage supply) terminal or coupling node.

Thus, if the first flying capacitor 610 and the third capacitor 630 are of equal capacitance, a voltage of VIN/2 develops across each of the first flying capacitor 610 and the third capacitor 630. The first flying capacitor 610 and the third capacitor 630 thus charge up to VIN/2, and a voltage VIN/2 is present at the sixth node 667. A voltage of VIN/2 therefore develops across the fourth capacitor 640. The fourth capacitor 640 thus charges up to VIN/2, and the output voltage VOUT is equal to VIN/2.

In a second phase of operation, shown in FIG. 14b, the first, third, seventh and eighth switches 662, 666, 674, 676 and the output switch 684 (if present) are closed (i.e. switched on) in response to suitable control signals from the controller circuitry 695. The other switches 664, 668, 672, 678-682 are opened (i.e. switched off) in response to suitable control signals from the controller circuitry 695 (and are thus not shown in FIG. 14b).

With the switch network in this configuration, the first flying capacitor 610, the third capacitor 630 and the fourth capacitor 640 are coupled in parallel between the battery coupling node 679 (which is in turn coupled to the output node 692) and the ground (or other reference voltage supply) terminal or coupling node. Thus, in the second phase of operation, the peak output voltage VOUT is equal to the voltage that developed across the first flying capacitor 610, the third capacitor 630 and the fourth capacitor 640 during the first phase, and so the peak output voltage VOUT in the second phase of operation is VIN/2.

In operation of the power converter circuitry 600 in the first forward mode as switched capacitor power converter circuitry with a 2:1 input voltage to output voltage ratio, a duty cycle of the power converter circuitry is fixed at 0.5, such that the duration of the first phase is equal to half of a total duration of the first and second phases. As a result of this fixed duty cycle, the voltage across the first and second flying capacitors 610, 620 is maintained at VIN/2 respectively, so there is no need for additional circuitry for balancing the voltage of the first and second flying capacitors 610, 620.

As will be appreciated by those of ordinary skill in the art, if the output switch 684 is switched on or is not present, a voltage equal to VIN/2 is also present at the output node 692 as an output voltage VOUT during operation of the power converter circuitry 600 in the first forward mode as switched capacitor power converter circuitry with a 2:1 input voltage to output voltage ratio. The output voltage VOUT can be used as a supply voltage by a system (not shown in FIGS. 14a and 14b) that may be coupled to the output node 692. Thus, when the power converter circuitry 600 is operating in its first forward mode as switched capacitor power converter circuitry with a 2:1 input voltage to output voltage ratio it can simultaneously supply a charging current to a battery 150 and a supply voltage to an external system.

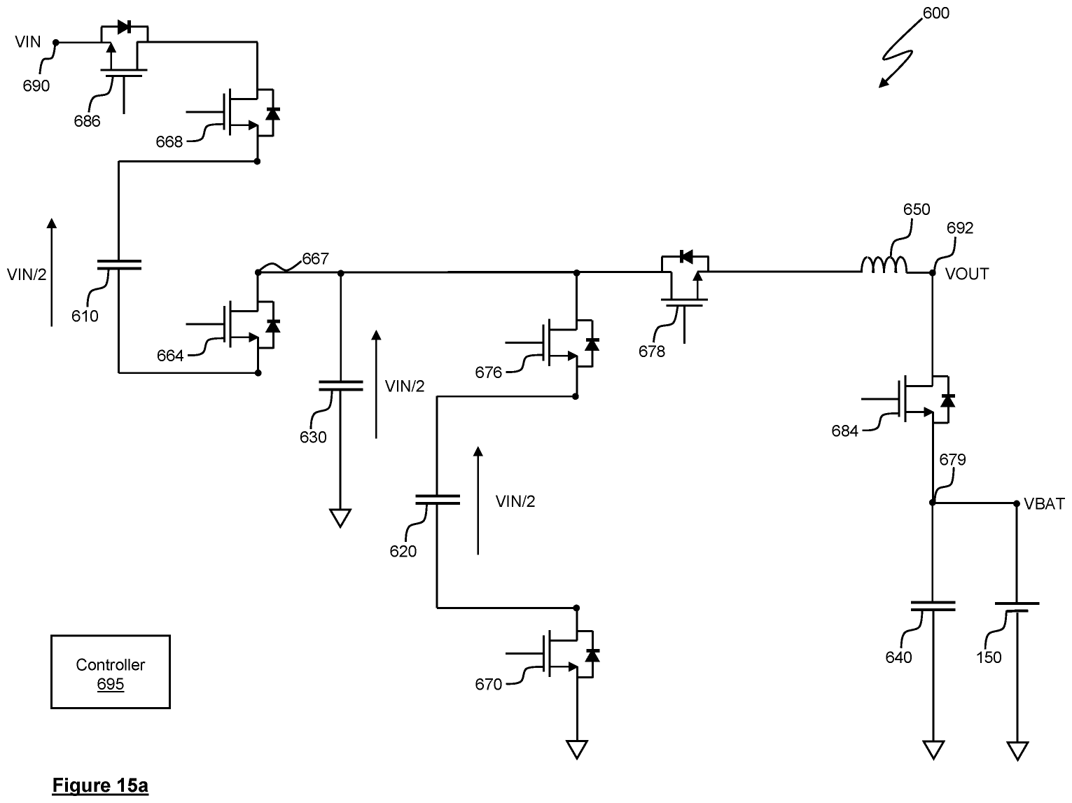

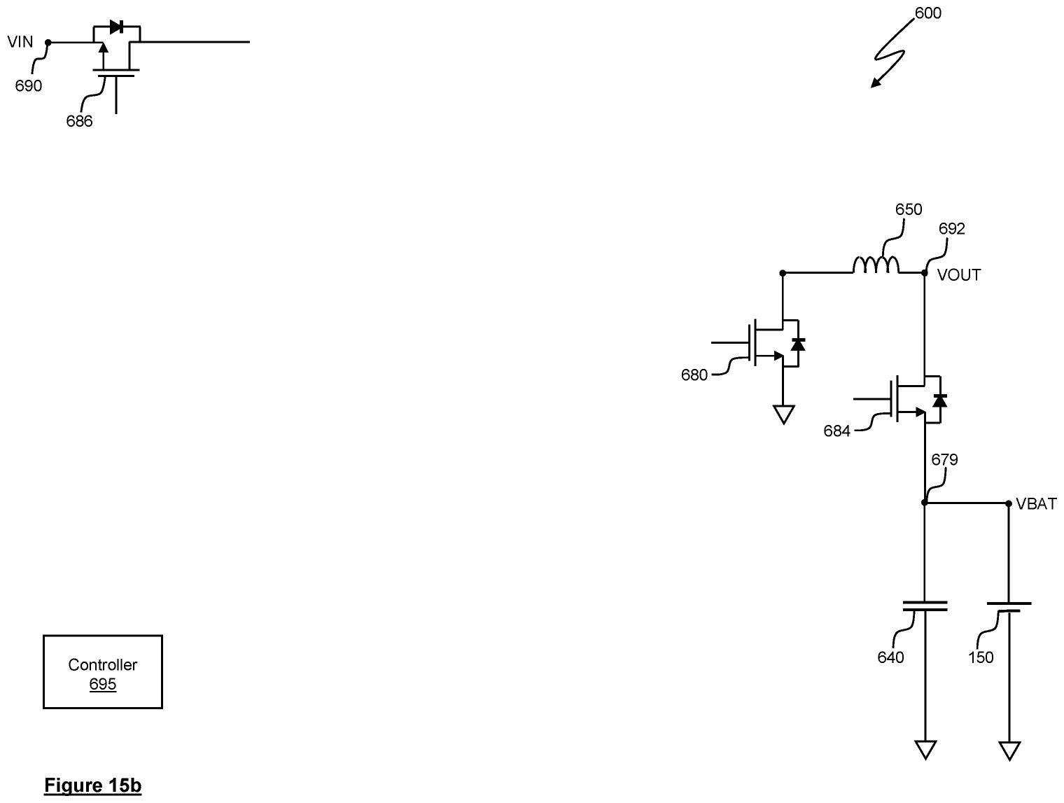

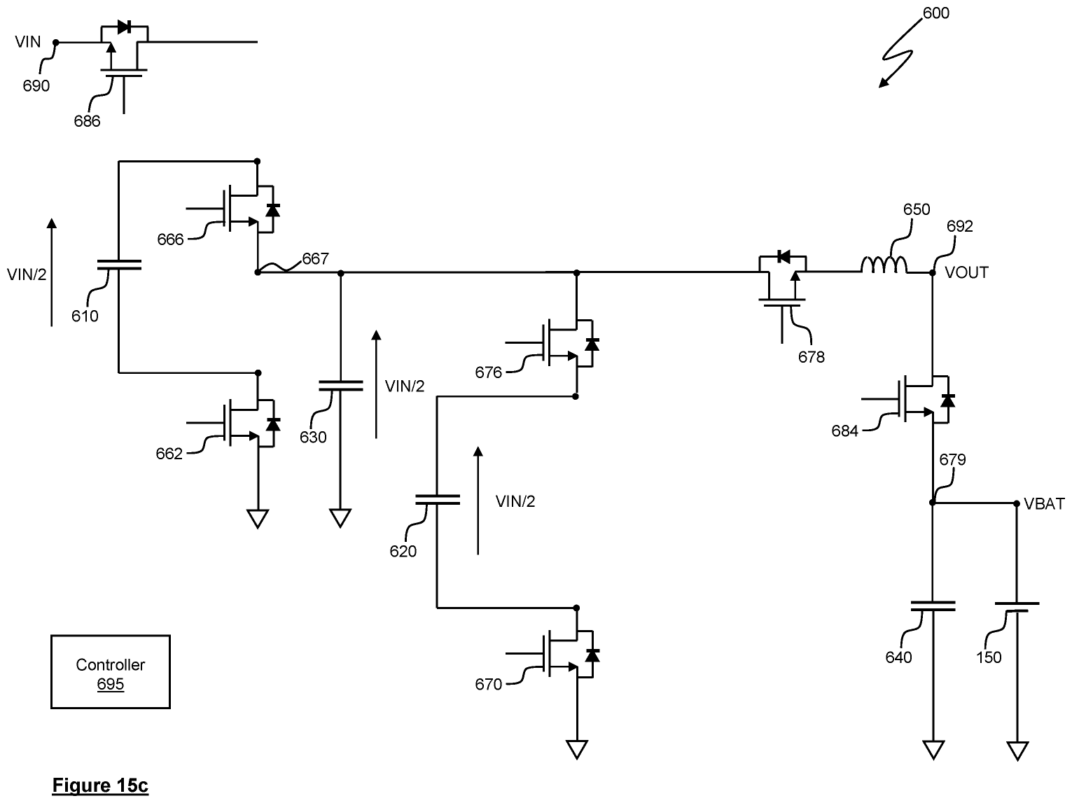

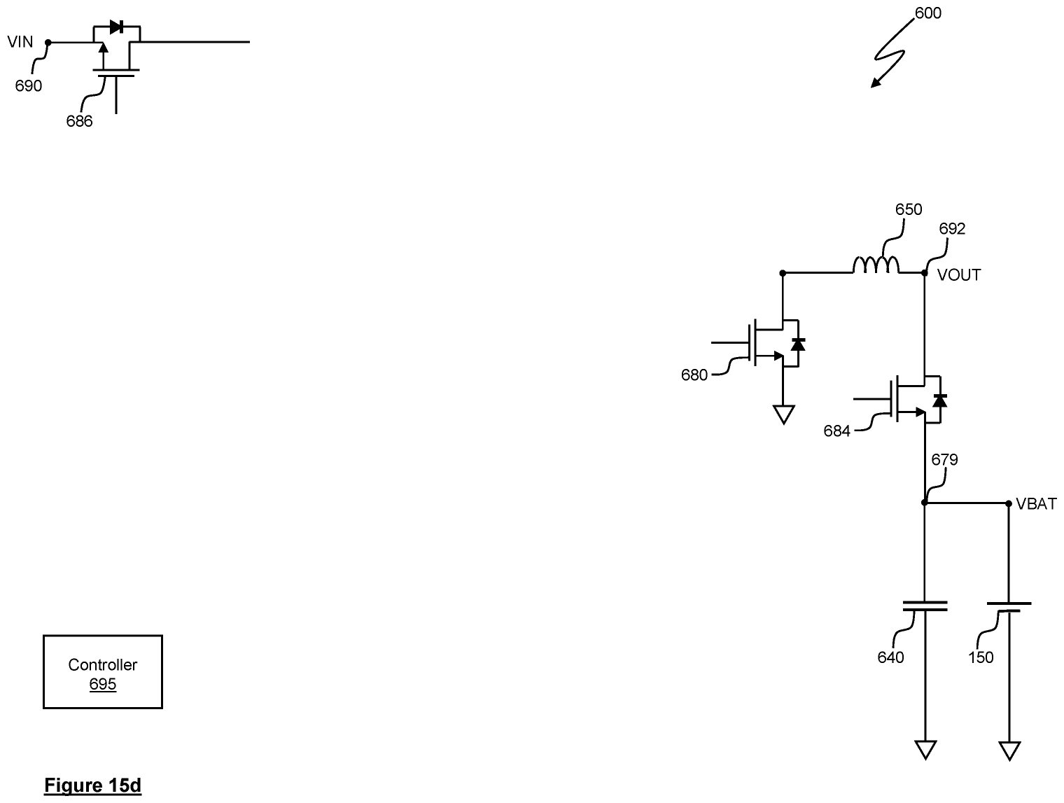

FIGS. 15a-15d are schematic diagrams illustrating operation of the power converter circuitry 600 in the second forward mode, as three-level inductive buck converter circuitry with a duty cycle D of less than 0.5. In this mode the power converter circuitry may apply a non-integer step-down conversion factor to the input voltage VIN to generate the output voltage VOUT. In this second forward mode the third and fourth capacitors 630, 640 may support an output voltage, and may thus be referred to as first and second output capacitors 630, 640 respectively.

In a first phase of operation, shown in FIG. 15a, the input switch 686 and the second, fourth, fifth, eighth and ninth switches 664, 668, 670, 676, 678 of the switch network are closed (i.e. switched on) in response to suitable control signals from the controller circuitry 695. The other switches 662, 666, 672, 674, 680, 682 are opened (i.e. switched off) in response to suitable control signals from the controller circuitry 695 (and are thus not shown in FIG. 15a). The output switch 684 (if present) is also closed (i.e. switched on) in response to a suitable control signal from the controller circuitry 995.

With the switch network in this configuration, the first flying capacitor 610 and the third capacitor 630 are coupled in series between the input node 690 and the ground (or other reference voltage supply) terminal or coupling node. The second flying capacitor 620 is coupled in parallel with the third capacitor 630 between the sixth node 667 and the ground (or other reference voltage supply) terminal or node. The inductor 650 and the second output capacitor are coupled in series between the sixth node 667 and the ground (or other reference voltage supply) terminal or coupling node, such that the series combination of the inductor 650 and the fourth capacitor 640 is in parallel with the third capacitor 630 and the second flying capacitor 620.

In the first phase of operation the first flying capacitor 610, the third capacitor 630 and the second flying capacitor 620 charge up and a voltage of (or close to) VIN/2 develops across each of the first flying capacitor 610, the third capacitor 630 and the second flying capacitor 620. As the first terminal of the inductor 650 is coupled to the parallel combination of the third capacitor 630 and the second flying capacitor 620, and as the output voltage VOUT is less than VIN/2 (because the duty cycle is less than 0.5), the voltage (VIN/2) at the first terminal of the inductor 650 is greater than the voltage at the second terminal of the inductor 650. Current through the inductor 650 thus increases and flows to a load (e.g. a battery 150) coupled to the battery coupling node 679, and to the fourth capacitor 640. A voltage VBAT, which is less than VIN/2 (because the voltage across the fourth capacitor 640 cannot increase instantaneously and because the inductor 650 limits the charging current that is supplied to the fourth capacitor 640), develops at the battery coupling node 679.

It will be noted that no separate flying capacitor is required when the power converter circuitry 600 operates in its second forward mode as three-level inductive buck converter circuitry, because the first and second flying capacitors 610, 620 that are used when the power converter circuitry 600 is operating in its first forward mode as switched capacitor power converter circuitry are also used when the power converter circuitry 600 is operating in its second mode as three-level inductive buck converter circuitry.

In a second phase of operation, shown in FIG. 15b, only the tenth switch 680 of the switch network is closed (i.e. switched on) in response to suitable control signals from the controller circuitry 695. The output switch 684 (if present) is also closed (i.e. switched on) in response to a suitable control signal from the controller circuitry 595. The other switches 662-678, 682 are opened (i.e. switched off) in response to suitable control signals from the controller circuitry 695 (and are thus not shown in FIG. 15b).

With the switch network in this configuration, the inductor 650 and the fourth capacitor 640 are coupled in parallel between the ground (or other reference voltage supply) terminal or coupling node and the output node 692. Thus, in the second phase of operation the inductor 650 receives no input voltage. The current through the inductor 650 thus decreases, flowing to the load that is coupled to the battery coupling node 679. The fourth capacitor 640 also discharges into the load during this phase, such that the total current supplied to the load is the sum of the inductor current and the output capacitor current. The voltage VBAT in this second phase of operation is again less than VIN/2.

In a third phase of operation, shown in FIG. 15c, the first, third, fifth, eighth and ninth switches 662, 666, 670, 676, 678 of the switch network, and the output switch 684 (if present) are closed (i.e. switched on) in response to suitable control signals from the controller circuitry 695. The other switches 664, 668, 672, 674, 680, 682 are opened (i.e. switched off) in response to suitable control signals from the controller circuitry 695 (and are thus not shown in FIG. 15c).

With the switch network in this configuration, the first flying capacitor 610, the third capacitor 630 and the second flying capacitor 620 are coupled in parallel between the ground (or other reference voltage) terminal or coupling node and the sixth node 667. The inductor 650 and the fourth capacitor 640 are coupled in series between the sixth node 667 and the ground (or other reference voltage supply) terminal or coupling node, such that this series combination of the inductor 650 and the fourth capacitor 640 is coupled in parallel with the first and second flying capacitors 610, 620 and the third capacitor 630.

Thus, in the third phase of operation, the voltage VIN/2 across the first and second flying capacitors 610, 620 and the third capacitor 630 is supplied to the inductor 650, causing current through the inductor 650 to increase again, charging the fourth capacitor 640 and supplying the load that is coupled to the battery coupling node 679 with a voltage VBAT, which is smaller than VIN/2.

In a fourth phase of operation, shown in FIG. 15d, the switch network again adopts the configuration adopted in the second phase, with only the tenth switch 680 and the output switch 684 (if present) closed (i.e. switched on) in response to suitable control signals from the controller circuitry 695. The other switches 662-678, 682 are opened (i.e. switched off) in response to suitable control signals from the controller circuitry 695 (and are thus not shown in FIG. 15d).

With the switch network in this configuration, the inductor 650 and the fourth capacitor 640 are again coupled in parallel between the ground (or other reference voltage) terminal or coupling node and the output node 692, such that the current through the inductor 650 again decreases, flowing to the load that is coupled to the battery coupling node 679. The fourth capacitor 640 also discharges into the load during this phase, such that the total current supplied to the load is the sum of the inductor current and the output capacitor current. The voltage VBAT in this fourth phase of operation is again less than VIN/2.

As will be appreciated by those of ordinary skill in the art, over a complete operational cycle (where a complete operational cycle comprises the first to fourth phases of operation) of the power converter circuitry 600 when operating in its second forward mode as forward three-level inductive buck converter circuitry with a duty cycle less than 0.5, the average voltage VBAT will be less than VIN/2.

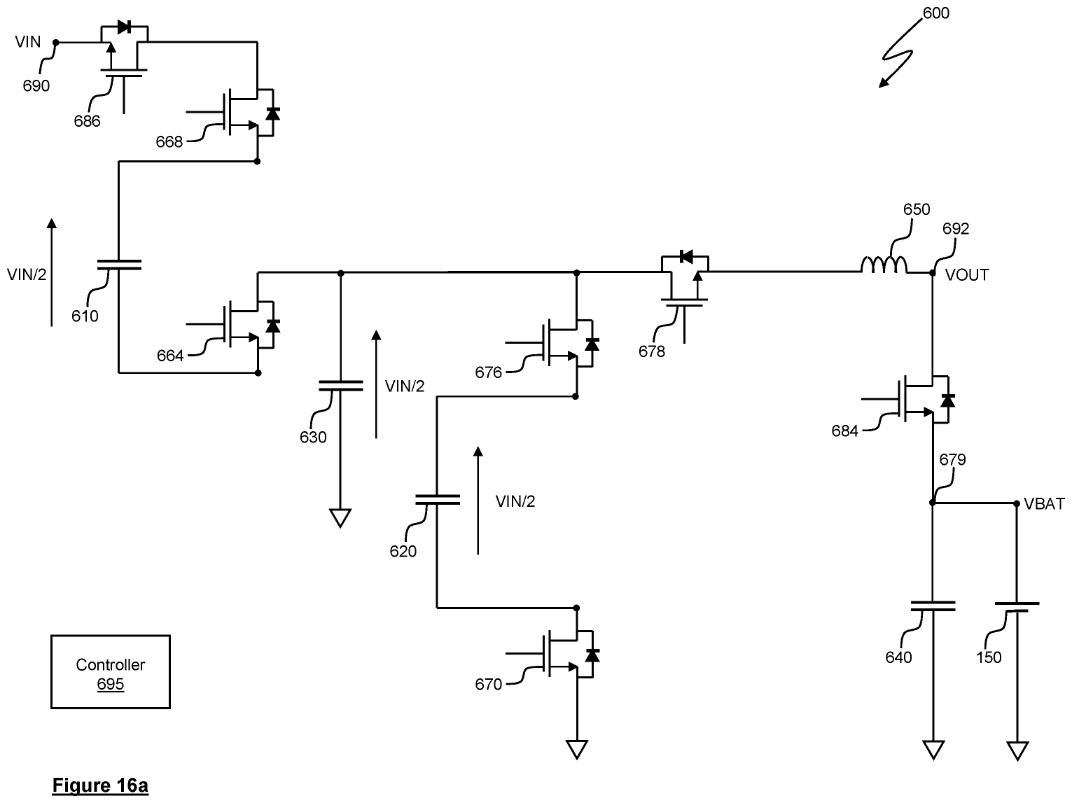

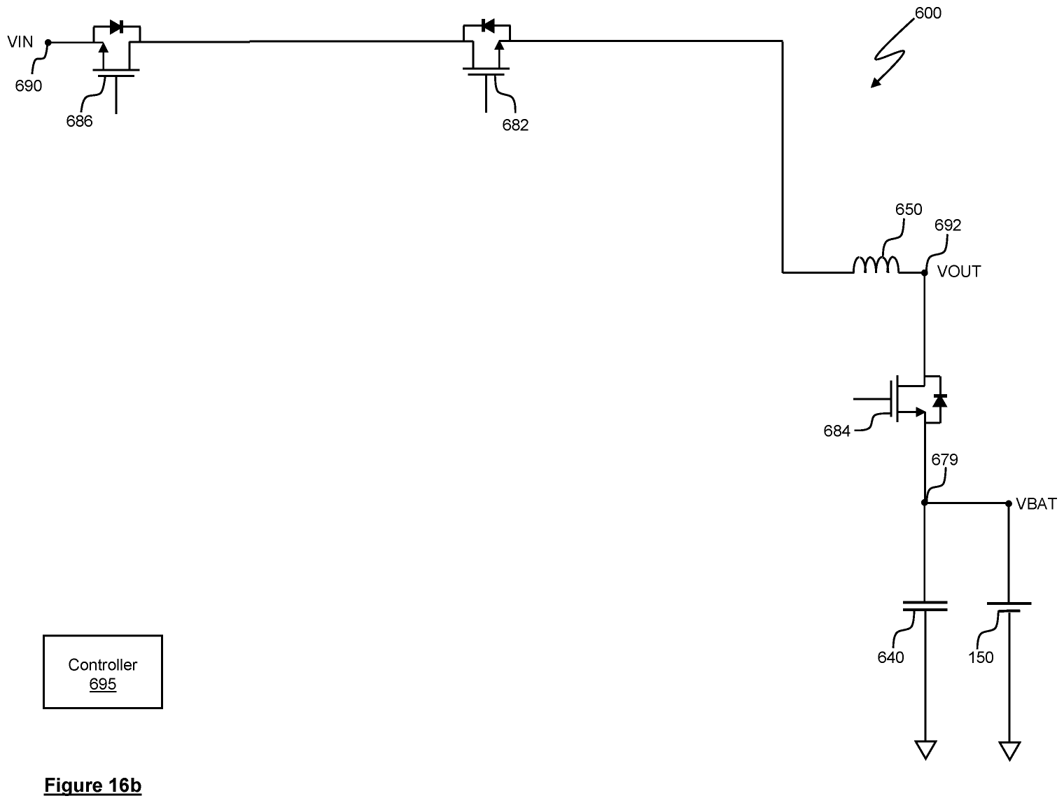

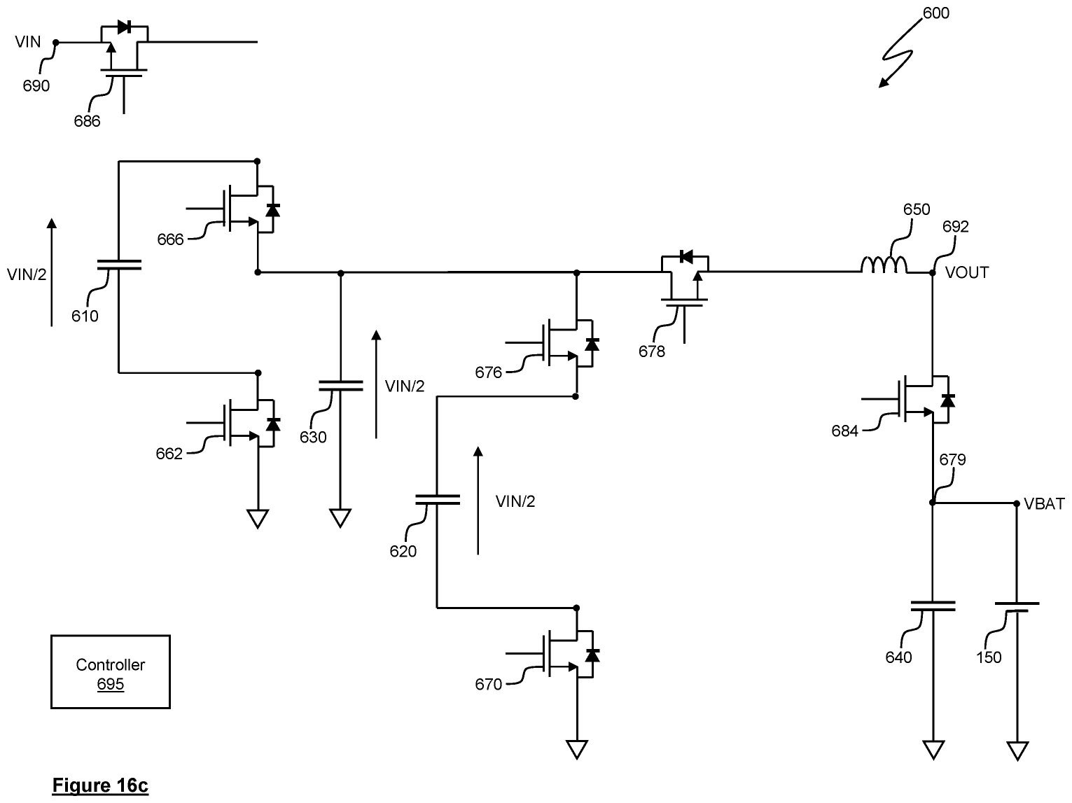

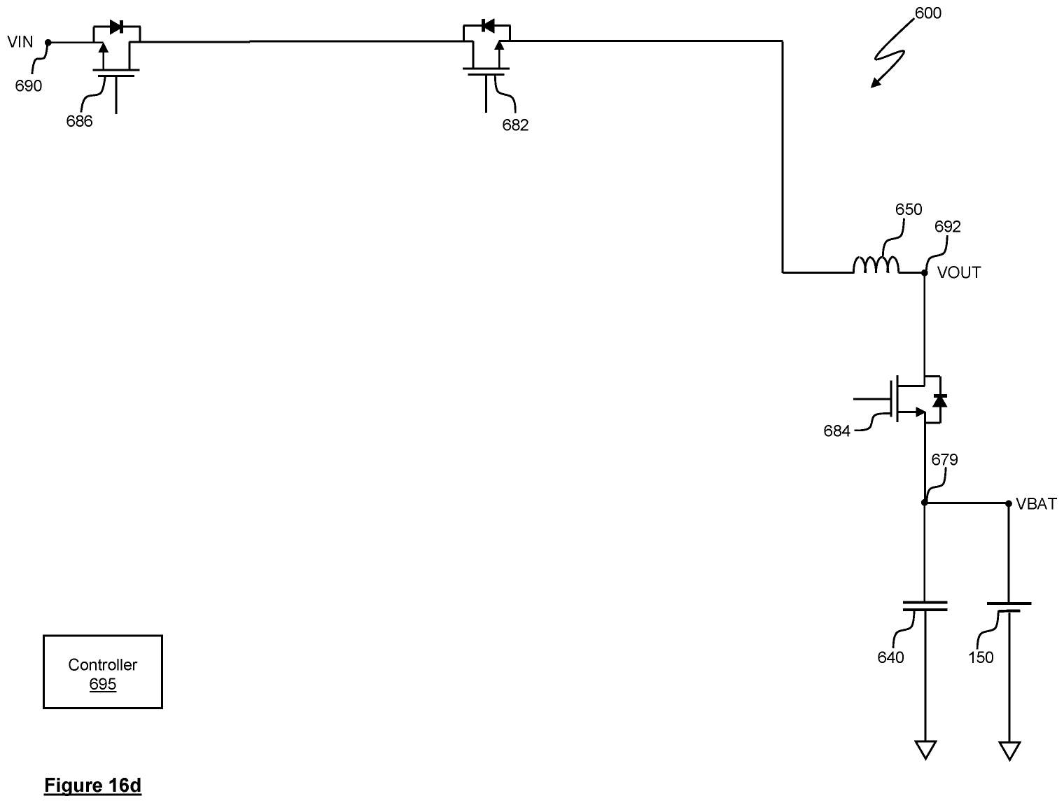

FIGS. 16a-16d are schematic diagrams illustrating operation of the power converter circuitry 600 in the second forward mode, as three-level inductive buck converter circuitry with a duty cycle greater than 0.5, such that the output voltage VOUT is greater than half the input voltage VIN. In this mode the power converter circuitry may apply a non-integer step-down conversion factor to the input voltage VIN to generate the output voltage VOUT. In this second forward mode the third and fourth capacitors 630, 640 may support an output voltage, and may thus be referred to as first and second output capacitors 630, 640 respectively.

If the power converter circuitry 600 is to be operated in the second forward mode as a three-level buck converter with a duty cycle greater than 0.5, the eighth and ninth switches 676, 678 should each be implemented as two back-to-back connected MOSFET devices, as shown in FIG. 3, to prevent reverse current flow from a load such as a battery that is coupled to the output node 692, as will be explained in more detail below.

In a first phase of operation, shown in FIG. 16a, the switch network adopts the same configuration as in the first phase of operation when the duty cycle is less than 0.5 (shown in FIG. 15a), with the input switch 686 and the second, fourth, fifth, eighth and ninth switches 664, 668, 670, 676, 678 of the switch network being closed (i.e. switched on) in response to suitable control signals from the controller circuitry 695. The other switches 662, 666, 672, 674, 680, 682 are opened (i.e. switched off) in response to suitable control signals from the controller circuitry 695 (and are thus not shown in FIG. 15a). The output switch 684 (if present) is also closed (i.e. switched on) in response to a suitable control signal from the controller circuitry 695.

With the switch network in this configuration, the first flying capacitor 610 and the third capacitor 630 are coupled in series between the input node 690 and the ground (or other reference voltage supply) terminal or coupling node. The second flying capacitor 620 is coupled in parallel with the third capacitor 630, between the sixth node 667 and the ground (or other reference voltage supply) terminal or node. The inductor 650 and the fourth capacitor 640 are coupled in series between the sixth node 667 and the ground (or other reference voltage supply) terminal or coupling node, such that the series combination of the inductor 650 and the fourth capacitor 640 is coupled in parallel with the third capacitor 630 and the second flying capacitor 620.

In the first phase of operation, the first flying capacitor 610, the third capacitor 630 and the second flying capacitor 620 charge up and a voltage of (or close to) VIN/2 develops across each of the first flying capacitor 610, the third capacitor 630 and the second flying capacitor 620. As the output voltage VOUT is greater than VIN/2 (because the duty cycle is greater than 0.5), the voltage (VIN/2) at the first terminal of the inductor 650 is less than the voltage at the second terminal of the inductor 650, and so a decreasing current flows through the inductor 650 to a load (e.g. a battery 150) coupled to the battery coupling node 679, and to the fourth capacitor 640. A voltage VBAT, which is less than VIN/2 (because the voltage across the output capacitor 640 cannot increase instantaneously and because the inductor 650 limits the charging current that is supplied to the output capacitor 640), develops at the battery coupling node 679.

Because the output voltage VOUT is greater than the voltage VIN/2 across the parallel combination of the third capacitor 630 and the second flying capacitor 620 in the first phase of operation, if the ninth switch 678 were implemented as a single MOSFET device with a body diode having an anode coupled to the seventh node 677 and a cathode coupled to the sixth node 667 (as shown in FIG. 12), and if the eighth switch were implemented as a single MOSFET device with a body diode having an anode coupled to the third node 671 and a cathode coupled to the sixth node 667 (as shown in FIG. 12), then the body diodes of the ninth switch 678 and the eighth switch 676 would conduct in the first phase of operation, thus providing a path for reverse current from a load coupled to the battery coupling node 679 to the second flying capacitor 620.

To prevent this, if the power converter circuitry 600 is to be operated in the second forward mode as a three-level buck converter with a duty cycle greater than 0.5, the eighth switch 676 and the ninth switch 678 should each be implemented as first and second back-to-back connected MOSFET devices 676a, 676b, 678a, 678b, as shown in FIG. 3. With the eighth switch 676 and the ninth switch 678 implemented in this way, the body diodes of the second MOSFET devices 676b 678b prevent reverse current flow from the load during the first phase of operation.

Again, it will be noted that no separate flying capacitor is required when the power converter circuitry 600 operates in its second forward mode as three-level inductive buck converter circuitry, because the first and second flying capacitors 610, 620 that are used when the power converter circuitry 600 is operating in its first forward mode as switched capacitor power converter circuitry are also used when the power converter circuitry 600 is operating in its second mode as three-level inductive buck converter circuitry.

In a second phase of operation, shown in FIG. 16b, the input switch 686, the eleventh switch 682 of the switch network, and the output switch 684 (if present) are closed (i.e. switched on) and the other switches 662-680 are opened (i.e. switched off) in response to suitable control signals from the controller circuitry 695, such that the series combination of the inductor 650 and the fourth capacitor 640 is decoupled from the first and second flying capacitors 610, 620. The inductor 650 and the fourth capacitor 640 are coupled in series between the input node 690 and the ground (or other reference voltage supply) terminal or node and the inductor 650 is coupled in series between the input node 690 and the battery coupling node 679.

With the switch network in this configuration, the input voltage VIN is supplied to the first terminal of the inductor 650, and so an increasing current flows through the inductor 650 to both the fourth capacitor 640 and to the load that is coupled to the battery coupling node 679.

In a third phase of operation, shown in FIG. 16c, the switch network adopts the same configuration as in the third phase of operation when the duty cycle is less than 0.5 (shown in FIG. 15c), with the first, third, fifth, eighth and ninth switches 662, 666, 670, 676, 678 of the switch network, and the output switch 684 (if present) being closed (i.e. switched on) in response to suitable control signals from the controller circuitry 695 and the other switches 664, 668, 672, 674, 680, 682 being opened (i.e. switched off) in response to suitable control signals from the controller circuitry 695.

With the switch network in this configuration, the first flying capacitor 610, the third capacitor 630 and the second flying capacitor 620 are coupled in parallel between the ground (or other reference voltage) terminal or coupling node and the sixth node 667. The inductor 650 and the fourth capacitor 640 are coupled in series between the sixth node 667 and the ground (or other reference voltage supply) terminal or coupling node, such that this series combination of the inductor 650 and the fourth capacitor 640 is coupled in parallel with the first and second flying capacitors 610, 620 and the third capacitor 630.

Thus, in the third phase of operation, the voltage VIN/2 across the first and second flying capacitors 610, 620 and the third capacitor 630 is supplied to the inductor 650. As the voltage at the first terminal of the inductor 650 is less than the voltage at the second terminal of the inductor 650, a decreasing current flows through the inductor 650, such that the inductor 650 acts as an additional voltage source in series with the parallel combination of the first and second flying capacitors 610, 620 and the third capacitor 630, such that the fourth capacitor 640 and the load that is coupled to the battery coupling node 679 are supplied with a voltage VBAT that is greater than VIN/2.

In a fourth phase of operation, shown in FIG. 16d, the switch network again adopts the configuration adopted in the second phase, with the input switch 686, the eleventh switch 682 of the switch network, and the output switch 684 (if present) being closed (i.e. switched on) and the other switches 662-680 being opened (i.e. switched off) in response to suitable control signals from the controller circuitry 695, such that the series combination of the inductor 650 and the fourth capacitor 640 is again decoupled from the first and second flying capacitors 610, 620. The inductor 650 and the fourth capacitor 640 are again coupled in series between the input node 690 and the ground (or other reference voltage supply) terminal or node and the inductor 650 is coupled in series between the input node 690 and the battery coupling node 679.

With the switch network in this configuration, the input voltage VIN is supplied to the first terminal of the inductor 650, and so an increasing current flows through the inductor 650 to both the fourth capacitor 640 and to the load that is coupled to the battery coupling node 679.

Repeated operation of the power converter circuitry 600 in the first and third modes maintains the voltage across the first and second flying capacitors 610, 620 at VIN/2, and thus there is no need for additional circuitry for balancing the voltage of the first and second flying capacitors 610, 620.

Those of ordinary skill in the art will also appreciate that the voltage VBAT is also present at the output node 692 as an output voltage VOUT during operation of the power converter circuitry 600 in the second forward mode as forward three-level inductive buck converter circuitry, whether the duty cycle is less than 0.5 or greater than 0.5. Again, the output voltage VOUT can be used as a supply voltage by a system (not shown in FIGS. 15a-15d or 16a-16d) that may be coupled to the output node 692. Thus, when the power converter circuitry 600 is operating in second forward mode as forward three-level inductive buck converter circuitry, it can simultaneously supply a charging current to a battery 150 and a supply voltage to an external system.

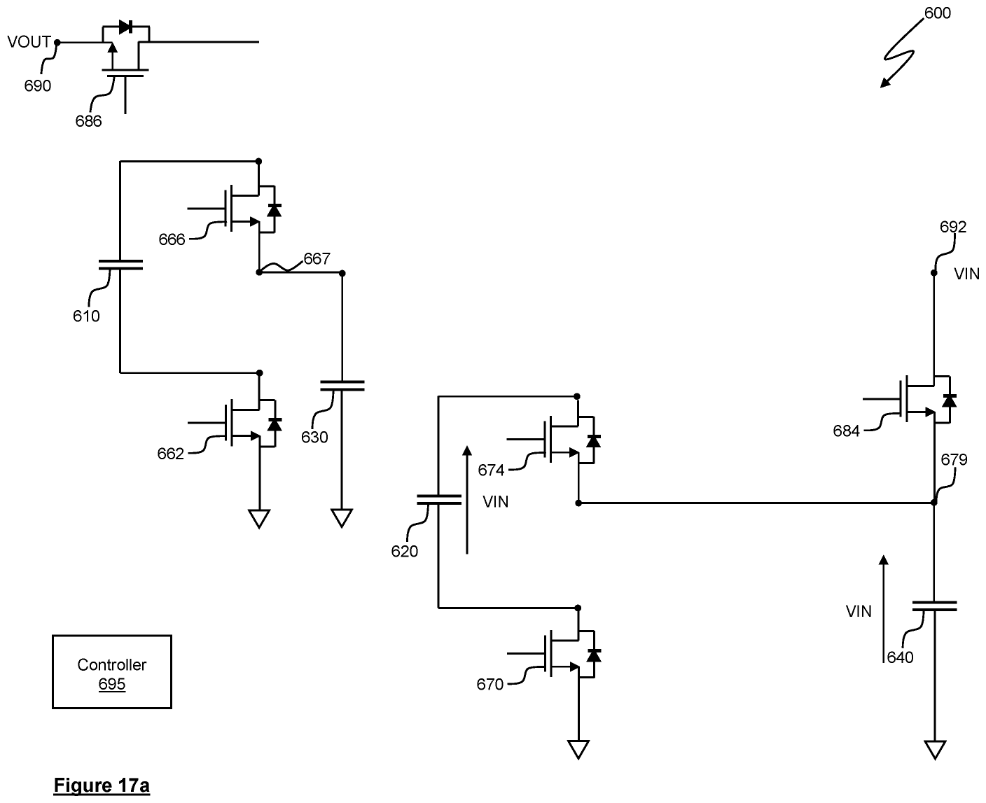

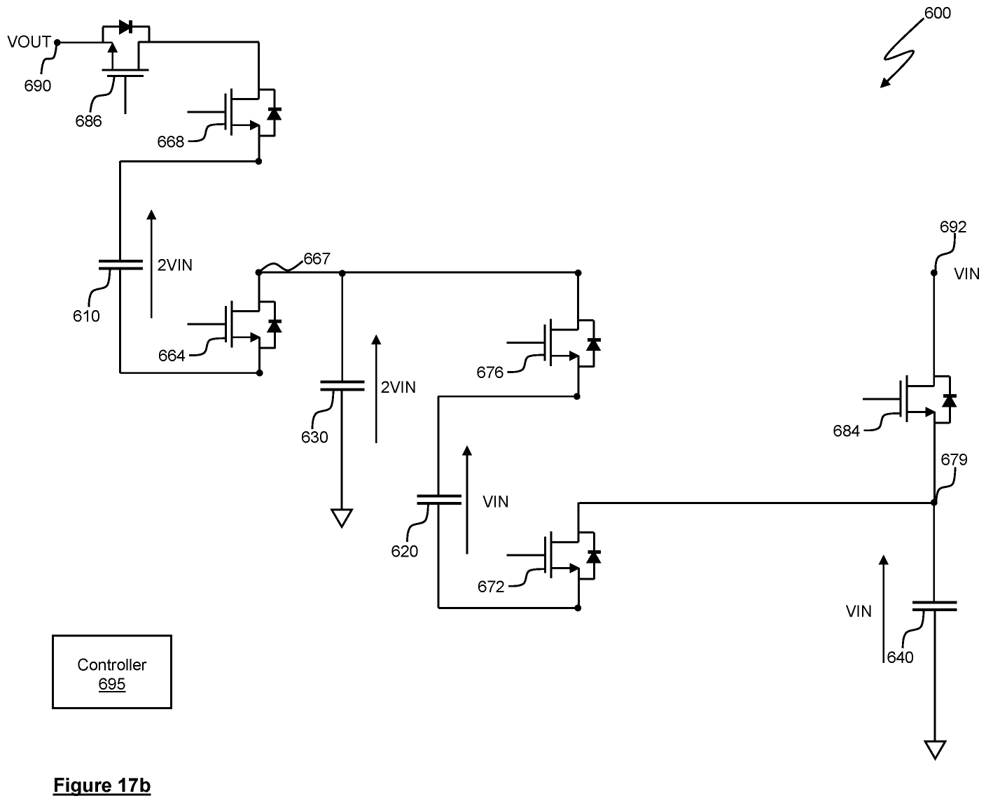

FIGS. 17a and 17b are schematic diagrams illustrating operation of the power converter circuitry 600 in the first reverse mode, as reverse switched capacitor power converter circuitry with a 1:4 input voltage to output voltage ratio (i.e. a step-up conversion factor of 4) to convert an input voltage VIN received at the output node 692 to a higher output voltage VOUT at the input node 690. In this mode, the power converter circuitry 500 operates with a fixed duty cycle of 0.5. In this first reverse mode the third and fourth capacitors 630, 640 may receive an input voltage, and may thus be referred to as first and second input capacitors 630, 640 respectively.

In a first phase of operation, shown in FIG. 17a, the first, third, fifth and seventh switches 662, 666, 670, 674 and the output switch 684 (if present) are closed (i.e. switched on) and the other switches 664, 668, 672, 676-862 are opened (i.e. switched off) in response to suitable control signals from the controller circuitry 695.

With the switch network in this configuration, the fourth capacitor 640 and the second flying capacitor 620 are coupled in parallel with each other, between the battery coupling node 679 (which is coupled to the output node 692, at which an input voltage VIN is received from an external voltage source such as a battery 150 in this first reverse mode) and the ground (or other reference voltage supply) terminal or coupling node. Thus, in the first phase of operation, the output capacitor 640 and the second flying capacitor 620 charge up to the input voltage VIN. The first flying capacitor 610 and the third capacitor 630 are coupled in parallel with each other between the sixth node 667 and the ground (or other reference voltage supply) terminal or coupling node, such that charge is shared between the first flying capacitor 610 and the third capacitor 630 and an equal voltage develops across each of the first flying capacitor 610 and the third capacitor 630.

In a second phase of operation, shown in FIG. 17b, the second, fourth, sixth and eighth switches 664, 668, 672, 676 and the output switch 684 (if provided) are closed (i.e. switched on) and the other switches 662, 666, 670, 674, 678-682 are opened (i.e. switched off) in response to suitable control signals from the controller circuitry 695.

With the switch network in this configuration, the fourth capacitor 640 and the second flying capacitor 620 are coupled in series with each other, between the ground (or other reference voltage supply) terminal or coupling node and the sixth node 667. Thus, a voltage of 2VIN develops at the sixth node 667. The first flying capacitor 610 is coupled in series with the fourth capacitor 640 and the second flying capacitor 620, between the ground (or other reference voltage supply) terminal or coupling node and the input node 690, and thus acts as an additional voltage source in series with the fourth capacitor 640 and the second flying capacitor 620.

During an initial start-up period comprising a plurality of cycles of operation in the first phase followed by operation in the second phase, the third capacitor 630 and the first flying capacitor 610 each charge up to a voltage of 2VIN, by the repeated charging of the third capacitor 630 to 2VIN from the series combination of the fourth capacitor 640 and the second flying capacitor 620 in the second phase and charge sharing between the third capacitor 630 and the first flying capacitor 610 in the first phase.

Thus, in steady state operation (i.e. after the initial start-up period), the first flying capacitor 610 and the third capacitor 630 are both charged to a voltage of 2VIN at the beginning of the second phase. In operation of the power converter circuitry 600|the second phase, voltage 2VIN across the first flying capacitor 610 combines with the voltage 2VIN at the sixth node 667, such that a voltage 4VIN develops at the input node 290 in the second phase of operation.

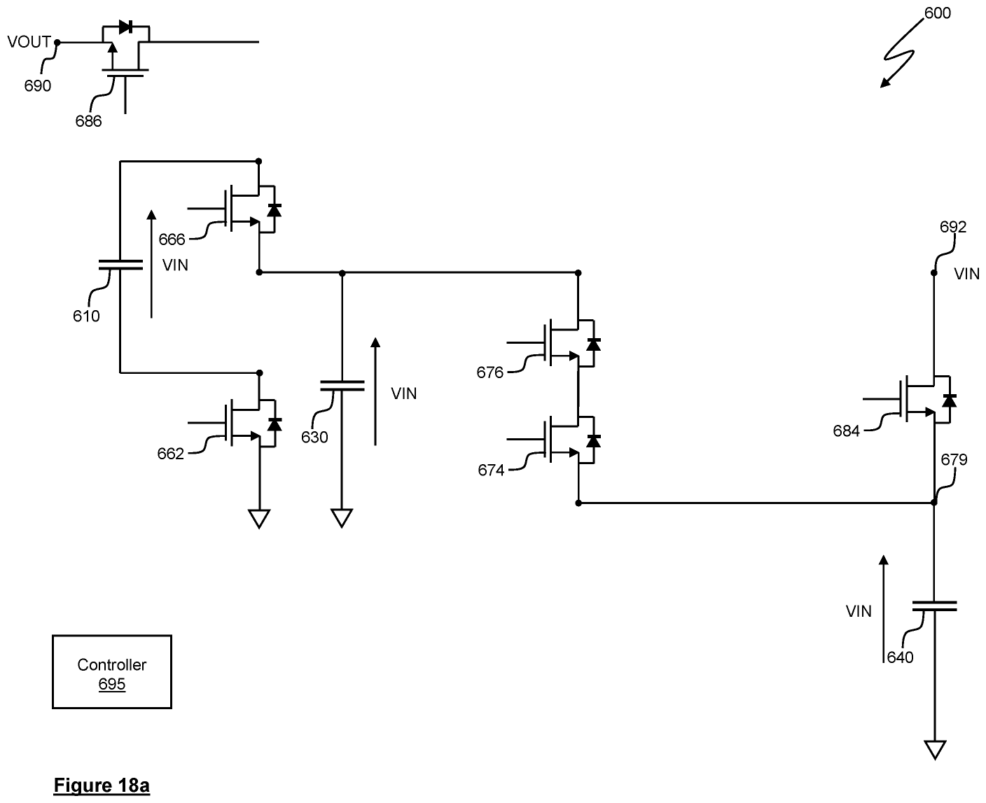

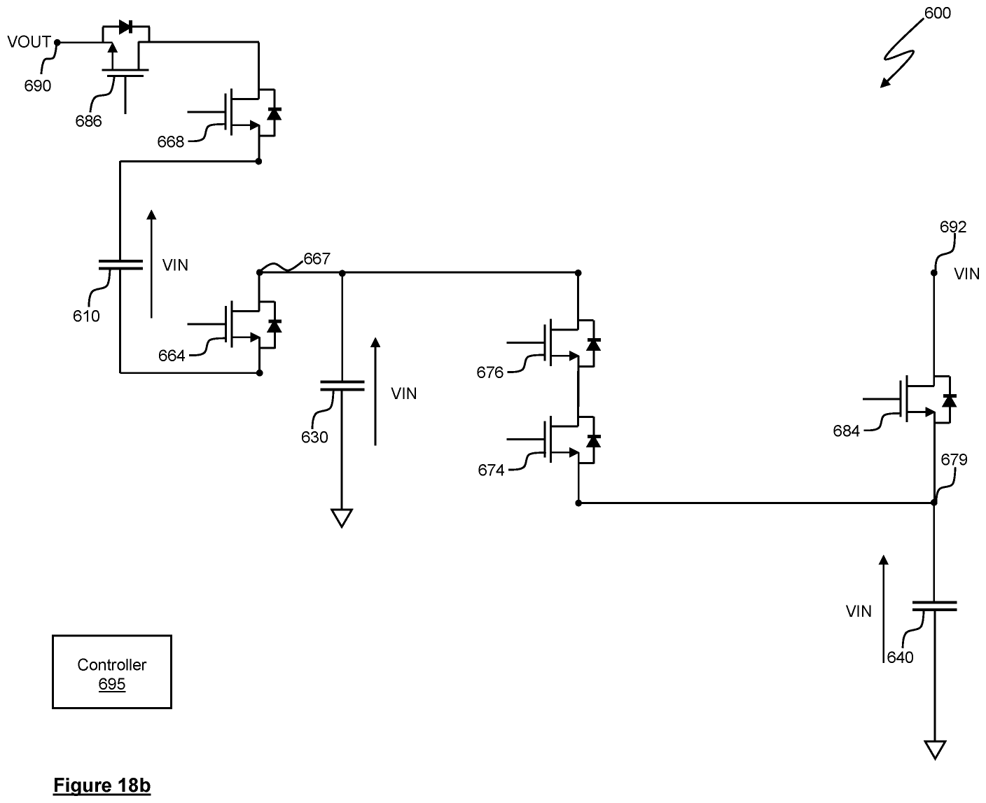

FIGS. 18a and 18b are schematic diagrams illustrating operation of the power converter circuitry 600 in the first reverse mode, as reverse switched capacitor power converter circuitry with a 1:2 input voltage to output voltage ratio (i.e. a step-up conversion factor of 2) to convert an input voltage VIN received at the output node 692 to a higher output voltage VOUT at the input node 690. In this mode, the power converter circuitry 600 operates with a fixed duty cycle of 0.5. In this first reverse mode the third and fourth capacitors 630, 640 may receive an input voltage, and may thus be referred to as first and second input capacitors 630, 640 respectively.

In a first phase of operation, shown in FIG. 18a, the first, third, seventh and eighth switches 662, 666, 674, 676 are closed (i.e. switched on) and the other switches 664, 668, 672, 678-682 are opened (i.e. switched off) in response to suitable control signals from the controller circuitry 695.

With the switch network in this configuration, the fourth capacitor 640, the third capacitor 630 and the first flying capacitor 610 are coupled in parallel with each other, between the output node 692 (at which an input voltage VIN is received from an external voltage source such as a battery in this first reverse mode) and the ground (or other reference voltage supply) terminal or coupling node. Thus, in the first phase of operation, the fourth capacitor 640, the third capacitor 630 and the first flying capacitor 610 charge up to the input voltage VIN.

In a second phase of operation, shown in FIG. 18b, the second, fourth, seventh and eighth switches 664, 668, 674, 676, the input switch 686 and the output switch 684 (if present), are closed (i.e. switched on) and the other switches 662, 666, 672, 678-682 are opened (i.e. switched off) in response to suitable control signals from the controller circuitry 695.

With the switch network in this configuration, the first and second output capacitors 630, 640 are coupled in parallel with each other between the ground (or other reference voltage supply) terminal or coupling node and the output node 692 (which is in turn coupled to the sixth node 667). The fourth capacitor 640 and the first flying capacitor 610 are coupled in series with each other, between the ground (or other reference voltage supply) terminal or coupling node and the input node 690 (at which an output voltage VOUT is supplied, in this first reverse mode). The first flying capacitor 610 is coupled in series with a parallel combination of the first and second output capacitors 630, 630, between the ground (or other reference voltage supply) terminal or coupling node and the input node 690.

Thus, in the second phase of operation, the first flying capacitor 610 acts as an additional voltage source in series with the parallel combination of the first and second output capacitors 630, 640, such that the voltage VIN across the first flying capacitor 610 combines with the voltage VIN across the parallel combination of the external voltage source and the first and second output capacitors 630, 640 to generate the output voltage VOUT. As the first and second output capacitors 630, 640 and the first flying capacitor 610 were each charged to the input voltage VIN during the first phase of operation, the output voltage VOUT at the input node 690 in the second phase of operation is equal to 2VIN.

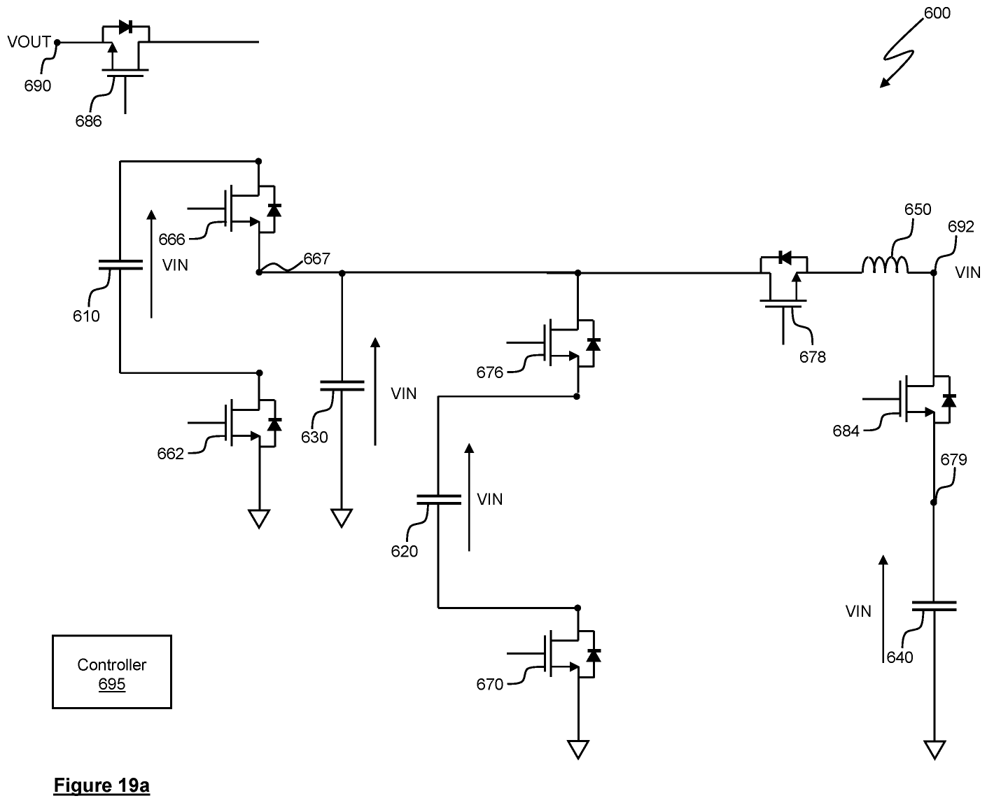

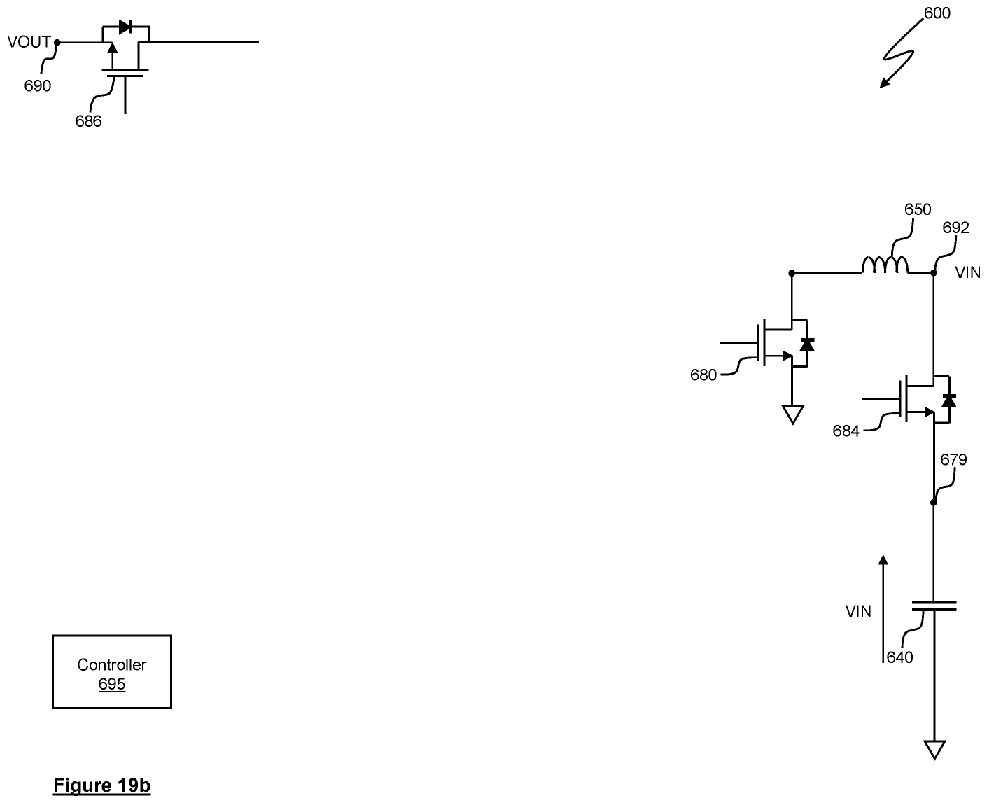

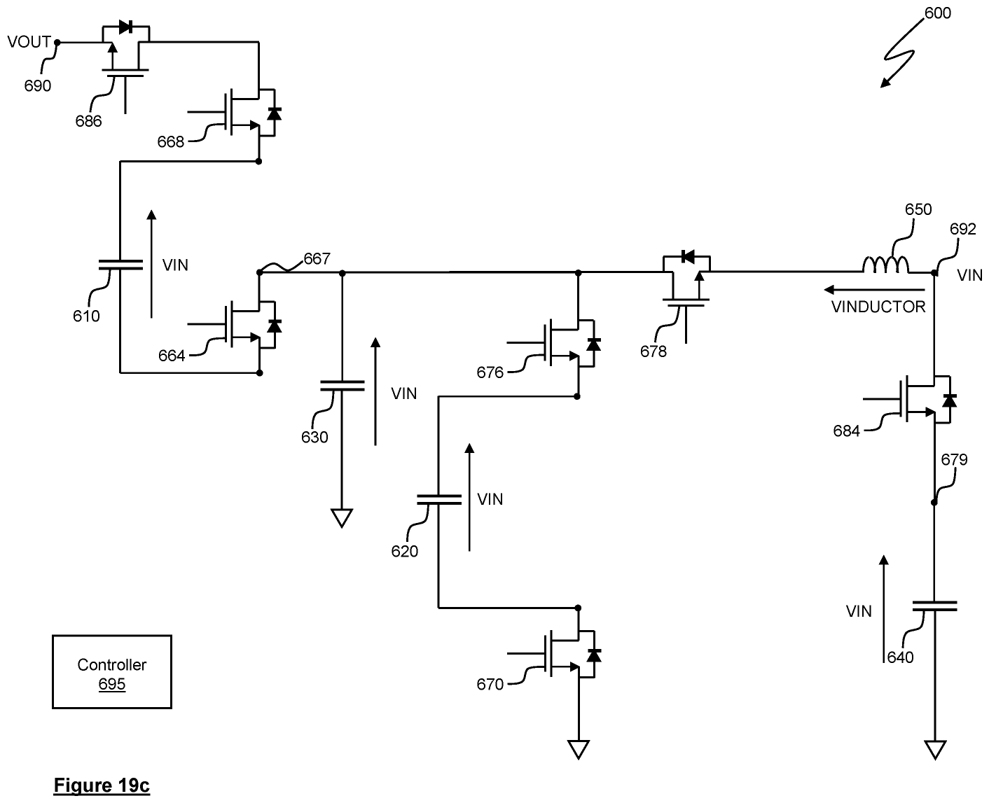

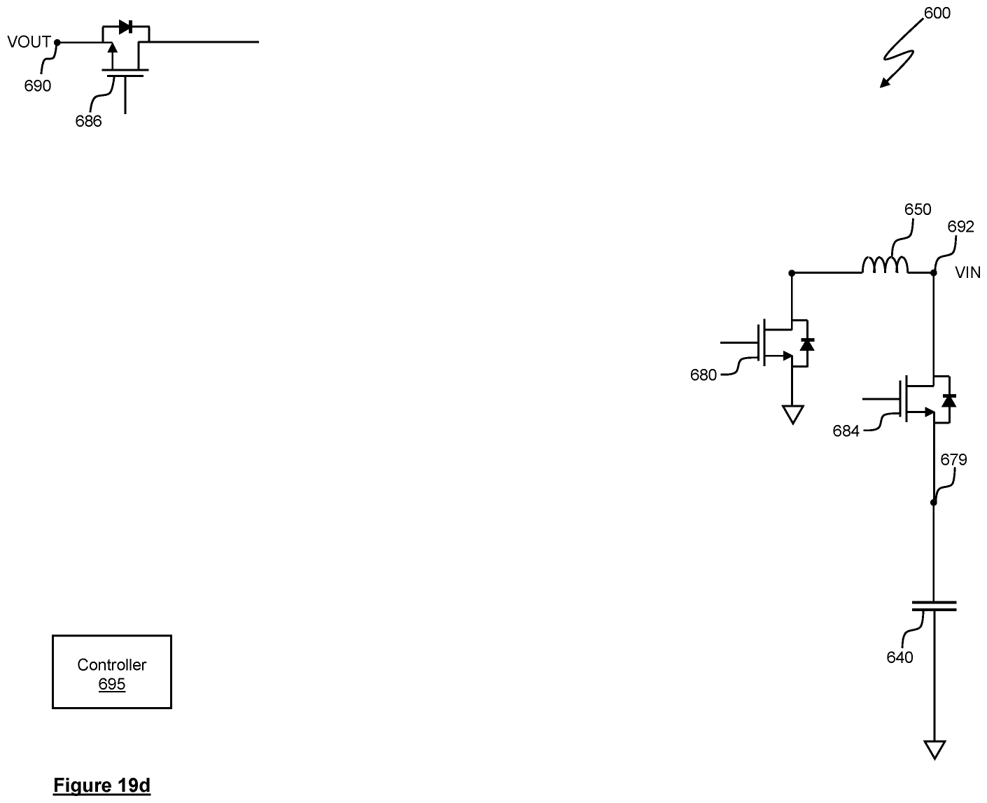

FIGS. 19a-19d are schematic diagrams illustrating operation of the power converter circuitry 600 in the second reverse mode as three-level inductive boost converter circuitry with a duty cycle (defined as a ratio of the input voltage to the output voltage) of less than 0.5, such that the output voltage is greater than twice the input voltage. In this mode the power converter circuitry may apply a non-integer step-up conversion factor to the input voltage VIN to generate the output voltage VOUT. In this second reverse mode the third and fourth capacitors 630, 640 may receive an input voltage, and may thus be referred to as first and second input capacitors 630, 640 respectively.

In a first phase of operation, shown in FIG. 19a, the first, third, fifth, eighth and ninth switches 662, 666, 670, 676, 678 and the output switch 684 (if present) are closed (i.e. switched on) and the other switches 664, 668, 672, 674, 680, 682 are opened (i.e. switched off) in response to suitable control signals from the controller circuitry 695.

With the switch network in this configuration, the fourth capacitor 640 is coupled between the output node 692 (at which an input voltage VIN is received from an external voltage source such as a battery 150 in this second reverse mode of operation) and the ground (or other reference voltage supply) terminal or coupling node. The inductor 650 is coupled between the output node 692 and the sixth node 667. The first and second flying capacitors 610, 620 and the third capacitor 630 are coupled in parallel with each other between the ground (or other reference voltage supply) terminal or coupling node and the sixth node 667.

Thus, in the first phase of operation the inductor 650 is coupled in series with a parallel combination of the first and second flying capacitors 610, 620 and the third capacitor 630 between the output node 692 and the ground (or other reference voltage supply) terminal or coupling node, and a series combination of the fourth capacitor 640 and the inductor 650 is coupled in parallel with the first and second flying capacitors 610, 620 and the third capacitor 630 between the ground (or other reference voltage supply) terminal or coupling node and the sixth node 667.

The input voltage VIN thus appears across the fourth capacitor 640, charging the fourth capacitor 640 to VIN and also causing an increasing current to flow through the inductor 650, which charges up the first and second flying capacitors 610, 620 and the third capacitor 630 to VIN.

In a second phase of operation, shown in FIG. 19b, the tenth switch 680 and the output switch 684 (if present) are closed (i.e. switched on) and the other switches 662-678, 682 are opened (i.e. switched off) in response to suitable control signals from the controller circuitry 695.

With the switch network in this configuration, the fourth capacitor 640 and the inductor 650 are coupled in parallel between the output node 692 and the ground (or other reference voltage supply) terminal or node.

The input voltage VIN thus appears across the fourth capacitor 640 and the inductor 650, causing the fourth capacitor 640 to charge up to VIN and an increasing current to flow through the inductor 650.

In a third phase of operation, shown in FIG. 19c, the second, fourth, fifth, eighth and ninth switches 664, 668, 670, 676, 678 and the output switch 684 (if present) are closed (i.e. switched on) and the other switches 662, 666, 672, 674, 680, 682 are opened (i.e. switched off) in response to suitable control signals from the controller circuitry 695. The input switch 686 is also closed (i.e. switched on) in response to a suitable control signal from the controller circuitry 695. The first and second flying capacitors 610, 620 are coupled in series between the ground (or other reference voltage supply) terminal or coupling node and the input node 690, and the series combination of the inductor 650 and the fourth capacitor 640 is coupled in parallel with the second flying capacitor 620, between the ground (or other reference voltage supply) terminal or coupling node and the output node 692.

With the switch network in this configuration, the inductor 650 and the first flying capacitor 610 are coupled in series between the output node 692 and the input node 690. The fourth capacitor 640 is coupled between the output node 692 and the ground (or other reference voltage supply) terminal or node. The second flying capacitor 620 and the third capacitor 630 are coupled in parallel between the ground (or other reference voltage supply) terminal or node and the sixth node 667.

Thus, in the third phase of operation, the fourth capacitor 640 acts as an additional voltage source in parallel with the external voltage source (e.g. battery 150) that is coupled to the output node 692, and the inductor 650 and first flying capacitor 610 act as additional voltage sources in series with the external voltage source. Thus, an output voltage VOUT, which is a combination of the input voltage VIN (from the parallel combination of the external voltage source and the fourth capacitor 640), the voltage VIN across the first flying capacitor 610, the voltage VIN across each of the second flying capacitor 620 and the third capacitor 630, and a voltage VINDUCTOR across the inductor 650 (which is dependent upon the duty cycle of the power converter circuitry 600) is supplied at the input node 690. VOUT is therefore equal to 2VIN+VINDUCTOR.

In a fourth phase of operation, shown in FIG. 19c, the switch network again adopts the configuration used in the second phase, with the tenth switch 680 and the output switch 684 (if present) being closed (i.e. switched on) and the other switches 662-678, 682 being opened (i.e. switched off) in response to suitable control signals from the controller circuitry 695.

With the switch network in this configuration, the fourth capacitor 640 and the inductor 650 are again coupled in parallel between the output node 692 and the ground (or other reference voltage supply) terminal or node.

The input voltage VIN thus appears across the fourth capacitor 640 and the inductor 650, maintaining the voltage of the fourth capacitor 640 at VIN and causing an increasing current to flow through the inductor 650.

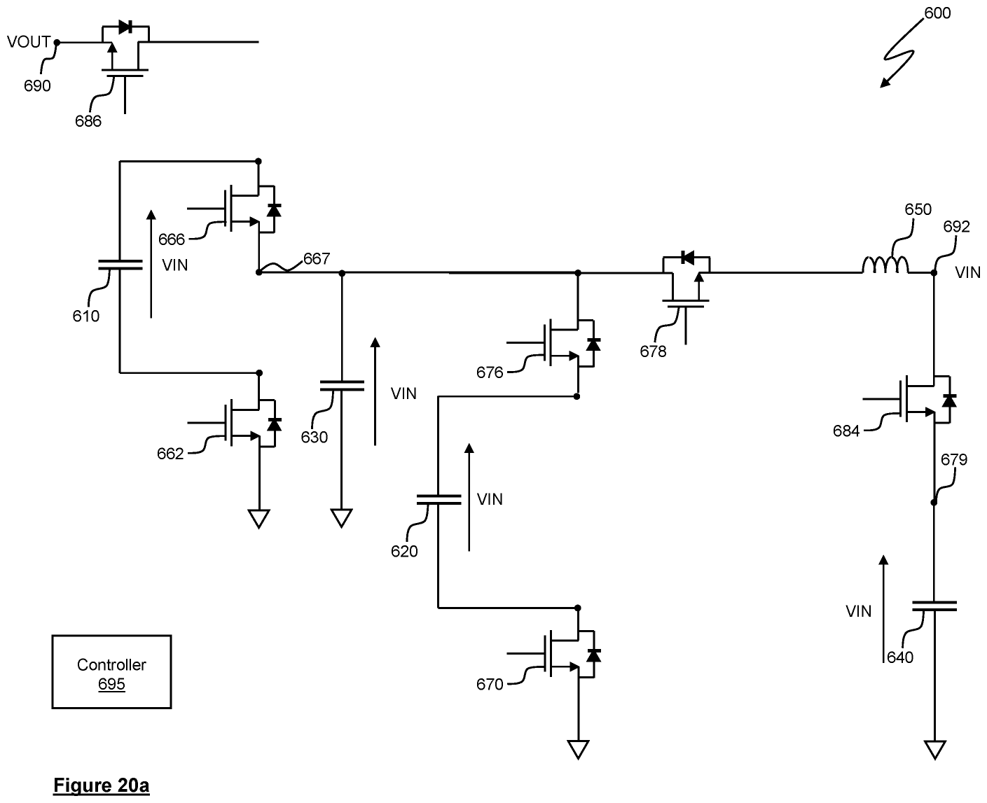

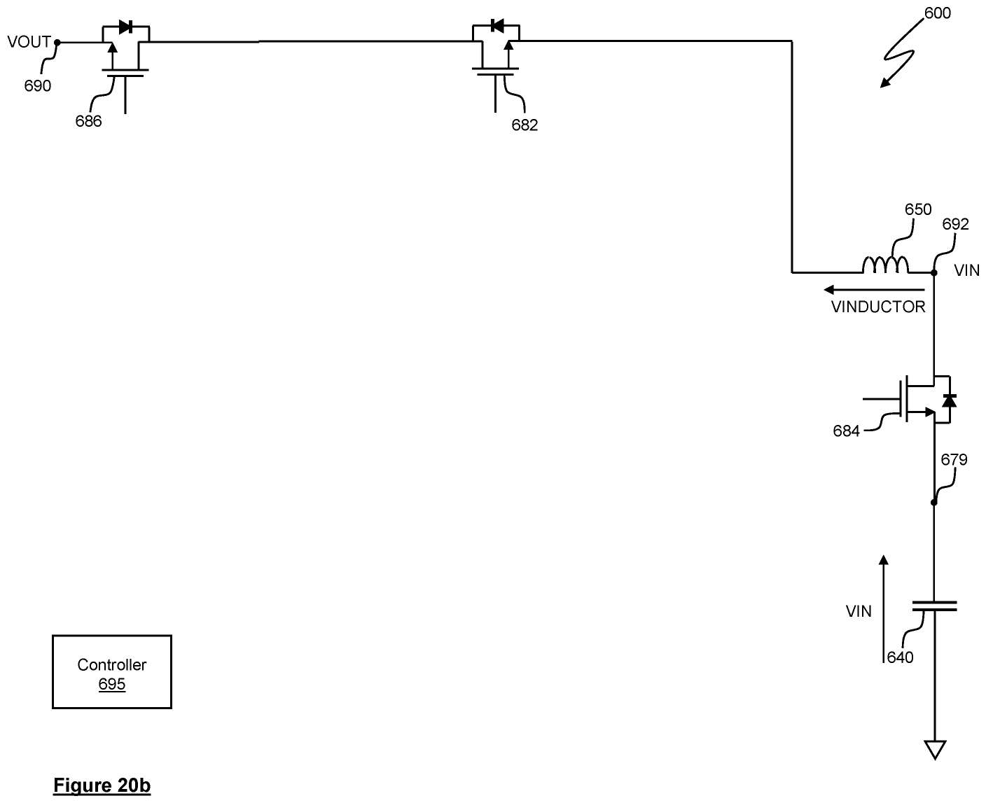

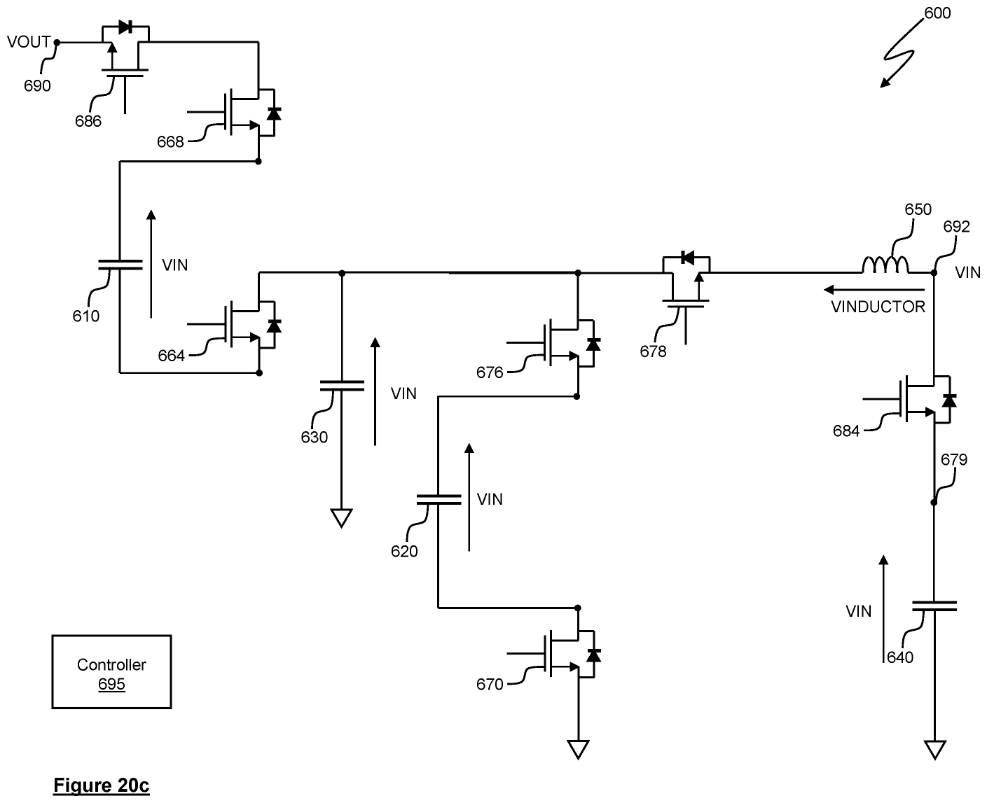

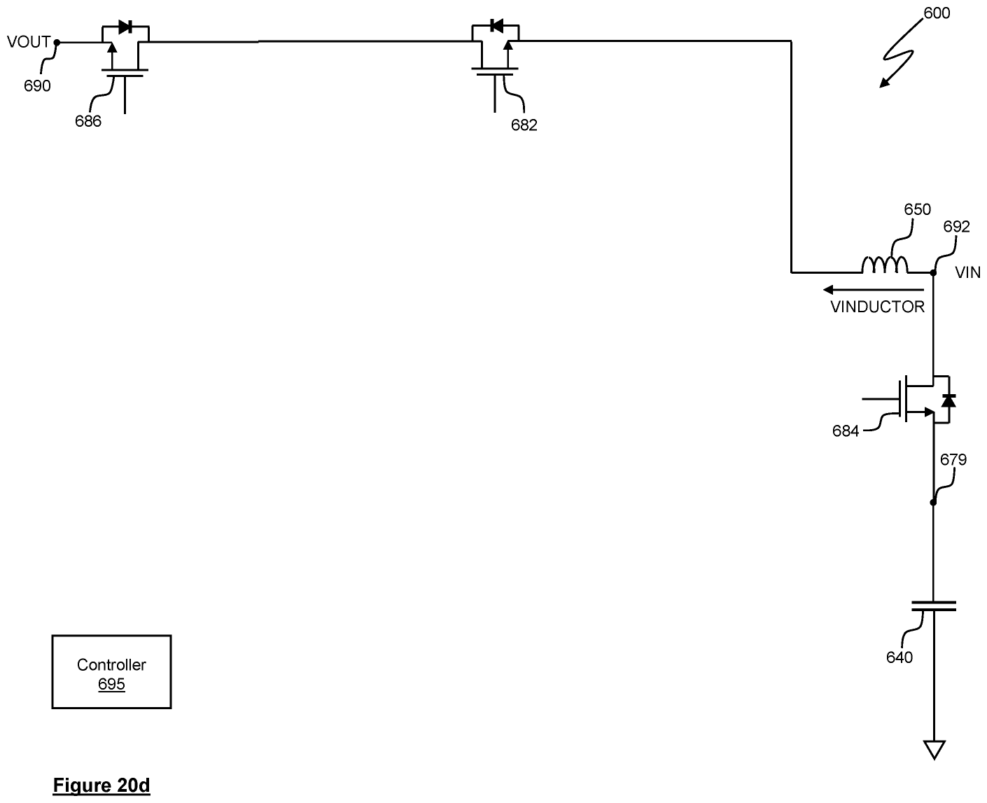

FIGS. 20a-20d are schematic diagrams illustrating operation of the power converter circuitry 600 in the second reverse mode as three-level inductive boost converter circuitry with a duty cycle (defined as a ratio of the input voltage to the output voltage) greater than 0.5, such that the output voltage is less than twice the input voltage. In this mode the power converter circuitry may apply a non-integer step-up conversion factor to the input voltage VIN to generate the output voltage VOUT. In this second reverse mode the third and fourth capacitors 630, 640 may receive an input voltage, and may thus be referred to as first and second input capacitors 630, 640 respectively.

In a first phase of operation, shown in FIG. 20a, the first, third, fifth, eighth and ninth switches 662, 666, 670, 676, 678 and the output switch 684 (if present) are closed (i.e. switched on) and the other switches 664, 668, 672, 674, 680, 682 are opened (i.e. switched off) in response to suitable control signals from the controller circuitry 695.

With the switch network in this configuration, the fourth capacitor 640 is coupled between the output node 692 (at which an input voltage VIN is received from an external voltage source such as a battery 150 is received, in this second reverse mode of operation) and the ground (or other reference voltage supply) terminal or coupling node. The inductor 650 is coupled between the output node 692 and the sixth node 667. The first and second flying capacitors 610, 620 and the third capacitor 630 are coupled in parallel with each other between the sixth node 667 and the ground (or other reference voltage supply) terminal or coupling node.

Thus, in the first phase of operation the inductor 650 is coupled in series with a parallel combination of the first and second flying capacitors 610, 620 and the third capacitor 630 between the output node 692 and the ground (or other reference voltage supply) terminal or coupling node, and a series combination of the fourth capacitor 640 and the inductor 650 is coupled in parallel with the first and second flying capacitors 610, 620 and the third capacitor 630 between the ground (or other reference voltage supply) terminal or coupling node and the sixth node 667.

The input voltage VIN thus appears across the fourth capacitor 640, causing the fourth capacitor 640 to charge up to VIN. An increasing current flows through the inductor 650 to the parallel coupled first and second flying capacitors 610, 620 and the third capacitor 630, which also charge up to VIN.

In a second phase of operation, shown in FIG. 20b, the input switch 686, the eleventh switch 682 and the output switch 582 (if present) are closed (i.e. switched on) and the other switches 662-680 are opened (i.e. switched off) in response to suitable control signals from the controller circuitry 695.

With the switch network in this configuration, the series combination of the inductor 650 and the fourth capacitor 640 is decoupled from the first and second flying capacitors 610, 620. The inductor 650 and the fourth capacitor 640 are coupled in series between the input node 690 and the ground (or other reference voltage supply) terminal or node and the inductor 650 is coupled in series between the input node 690 and the output node 692.

The voltage across the fourth capacitor 640 is thus maintained at VIN. The inductor 650 acts as an additional voltage source in series with the external voltage source, such that an output voltage VOUT equal to VIN+VINDUCTOR (where VINDUCTOR is a duty cycle dependent voltage across the inductor 650 in the second phase of operation) is supplied to the input node 690.

In a third phase of operation, shown in FIG. 20c, the input switch 686, the second, fourth, fifth, eighth and ninth switches 664, 668, 670, 676, 676, and the output switch 684 (if present) are closed (i.e. switched on) and the other switches 662, 666, 672, 674, 680, 682 are opened (i.e. switched off) in response to suitable control signals from the controller circuitry 695.

With the switch network in this configuration, the inductor 650 and the first flying capacitor 610 are coupled in series between the output node 692 and the input node 690. The fourth capacitor 640 is coupled between the output node 692 and the ground (or other reference voltage supply) terminal or node. The second flying capacitor 620 and the third capacitor 630 are coupled between the ground (or other reference voltage supply) terminal or node and the sixth node 667.

Thus, in the third phase of operation, the fourth capacitor 640 acts as an additional voltage source in parallel with the external voltage source (e.g. battery 150) that is coupled to the output node 692, and the inductor 650 and first flying capacitor 610 act as additional voltage sources in series with the external voltage source. Thus, an output voltage VOUT, which is a combination of the input voltage VIN (from the parallel combination of the external voltage source and the fourth capacitor 640), the voltage VIN across the first flying capacitor 610, the voltage VIN across the second flying capacitor 620 and third capacitor 630, and a voltage VINDUCTOR across the inductor 650 (which is dependent upon the duty cycle of the power converter circuitry 600) is supplied at the input node 690. VOUT is therefore equal to 2VIN+VINDUCTOR.

In a fourth phase of operation, shown in FIG. 20d, the switch network 440 adopts the same configuration as in the second phase, with the input switch 686, the eleventh switch 682 and the output switch 582 (if present) being closed (i.e. switched on) and the other switches 662-680 being opened (i.e. switched off) in response to suitable control signals from the controller circuitry 695.

With the switch network in this configuration, the series combination of the inductor 650 and the fourth capacitor 640 is again decoupled from the first and second flying capacitors 610, 620. The inductor 650 and the fourth capacitor 640 are again coupled in series between the input node 690 and the ground (or other reference voltage supply) terminal or node and the inductor 650 is coupled in series between the input node 690 and the output node 692.

The voltage across the fourth capacitor 640 is thus maintained at VIN. The inductor 650 acts as an additional voltage source in series with the external voltage source, such that an output voltage VOUT equal to VIN+VINDUCTOR (where VINDUCTOR is a duty cycle dependent voltage across the inductor 650 in the second phase of operation) is supplied to the input node 690.

As will be apparent from the foregoing discussion, the power converter circuitry 500, 600 of the present disclosure provides a single circuit that can operate in forward switched capacitor converter and inductive buck converter modes to generate a reduced output voltage from an input voltage. Thus, the power converter circuitry 500, 600 of the present disclosure can support the charging modes required in a charging system of the kind described above with respect to FIG. 1a in a single circuit, such that separate switched capacitor circuitry and inductive buck converter circuitry is not required. Accordingly, the present disclosure extends to a charging system comprising the power converter circuitry 500, 600.

By providing a single circuit that is operable in forward switched capacitor converter and inductive buck converter modes, a reduction in the number of switches and capacitors that are required can be achieved, compared to a system that uses separate switched capacitor circuitry and inductive buck converter circuitry. Additionally, the combined switched capacitor and inductive buck converter circuitry of the present disclosure can be implemented in a single integrated circuit.

Furthermore, the power converter circuitry 500, 600 of the present disclosure is also operable in reverse switched capacitor converter and inductive boost converter modes to generate an increased output voltage from an input voltage.

The circuitry described above with reference to the accompanying drawings may be incorporated in a host device such as a laptop, notebook, netbook or tablet computer, a gaming device such as a games console or a controller for a games console, a virtual reality (VR) or augmented reality (AR) device, a mobile telephone, a portable audio player or some other portable device, or may be incorporated in an accessory device for use with a laptop, notebook, netbook or tablet computer, a gaming device, a VR or AR device, a mobile telephone, a portable audio player or other portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog TM or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

Note that as used herein the term module shall be used to refer to a functional unit or block which may be implemented at least partly by dedicated hardware components such as custom defined circuitry and/or at least partly be implemented by one or more software processors or appropriate code running on a suitable general purpose processor or the like. A module may itself comprise other modules or functional units. A module may be provided by multiple components or sub-modules which need not be co-located and could be provided on different integrated circuits and/or running on different processors.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

1. A power converter integrated circuit comprising:
a switch network having coupling nodes for coupling the switch network to:
a first capacitor;
a second capacitor,
a third capacitor; and
an inductor,
wherein the power converter integrated circuit is operable in a first forward mode as switched capacitor power converter circuitry and in a second forward mode as inductive converter circuitry, wherein:
in the first forward mode, the switch network is operative to:
couple the first and second capacitors in series in a first phase of operation; and
couple the second capacitor and the third capacitor in parallel in a second phase of operation; and
in the second forward mode, the switch network is operative to:
couple the first and second capacitors in series and couple a series combination of the inductor and the third capacitor in parallel with the second capacitor in a phase of operation; and
couple the first and second capacitors in parallel with the series combination of the inductor and the third capacitor in a subsequent phase of operation.

2. The power converter integrated circuit of claim 1, wherein the switch network is operable with a duty cycle of less than 0.5 in the second forward mode.

3. The power converter integrated circuit of claim 2, wherein the switch network is operative to couple the inductor in parallel with the output capacitor in a further phase of operation.

4. The power converter integrated circuit of claim 1, wherein the switch network is operable with a duty cycle greater than 0.5 in the second forward mode.

5. The power converter integrated circuit of claim 4, wherein the switch network is operative to decouple the series combination of the inductor and the third capacitor from the first and second capacitors in a further phase of operation.

6. The power converter integrated circuit of claim 1, wherein the switch network is operable with a fixed duty cycle of 0.5 in the first forward mode.

7. The power converter integrated circuitry of claim 1, wherein the power converter integrated circuit is operable in a first reverse mode as switched capacitor converter circuitry and in a second reverse mode as inductive boost converter circuitry.

8. The power converter integrated circuit of claim 7, wherein in operation of the power converter integrated circuit in the first reverse mode, the switch network is operative to:
couple the second capacitor and the third capacitor in parallel in a first phase of operation; and
couple the second capacitor and the third capacitor in series in a second phase of operation.

9. The power converter integrated circuit of claim 7, wherein in operation of the power converter integrated circuit in the first reverse mode, the switch network is operative to:
couple the first and second capacitors and the third capacitor in parallel in a first phase of operation; and
couple the first capacitor in series with a parallel combination of the flying capacitor and the third capacitor in a second phase of operation.

10. The power converter integrated circuit of claim 7, wherein the switch network is operable with a fixed duty cycle of 0.5 in the first reverse mode.

11. The power converter integrated circuit of claim 7, wherein in operation of the power converter integrated circuit in the second reverse mode, the switch network is operative to:
couple the first and second capacitors in parallel with the series combination of the inductor and the third capacitor in a phase of operation; and
couple the first and second capacitors in series and couple the series combination of the inductor and the third capacitor in parallel with the second capacitor in a subsequent phase of operation.

12. The power converter integrated circuit of claim 11, wherein the switch network is operable with a duty cycle of less than 0.5 in the second reverse mode.

13. The power converter integrated circuit of claim 12, wherein the switch network is operative to couple the inductor in parallel with the third capacitor in a subsequent phase of operation.

14. The power converter integrated circuit of claim 11, wherein the switch network is operable with a duty cycle greater than 0.5 in the second reverse mode.

15. The power converter integrated circuit of claim 14, wherein the switch network is operative to decouple the series combination of the inductor and the third capacitor from the first and second capacitors in a further phase of operation.

16. The power converter integrated circuit of claim 1, wherein the switch network comprises first to ninth switches, and wherein, in use of the power converter integrated circuit:
the first switch is coupled between a reference voltage supply node of the switch network and the second switch;
the second switch is coupled between the first switch and the third switch;
the third switch is coupled between the second switch and the fourth switch;
the fourth switch is coupled between the third switch and a switch network input node;
the fifth switch is coupled between the reference voltage supply node of the switch network and the sixth switch;
the sixth switch is coupled between the fifth switch and the seventh switch;
the seventh switch is coupled between the sixth switch and a switch network node between the second switch and the third switch;
the eighth switch is coupled between the switch network node between the second switch and the third switch and a first terminal of the inductor;
the ninth switch is coupled between the first terminal of the inductor and the reference voltage supply node of the switch network;
a first terminal of the first capacitor is coupled to a first switch network node between the third and fourth switches;
a second terminal of the first capacitor is coupled to a second switch network node between the first and second switches;
a first terminal of the second capacitor is coupled to the switch network node between the second switch and the third switch;
a second terminal of the second capacitor is coupled to a third switch network node between the fifth and sixth switches;
a second terminal of the inductor is couplable to an output node of the power converter integrated circuit; and
the third capacitor is coupled to the output node of the power converter integrated circuit.

17. The power converter integrated circuit of claim 16, wherein the seventh switch comprises a first MOSFET device and a second MOSFET device, wherein a source terminal of the first MOSFET device is coupled to a source terminal of the second MOSFET device such that an anode of a body diode of the first MOSFET device is coupled to an anode of a body diode of the second MOSFET device.

18. The power converter integrated circuit of claim 1, wherein the switch network comprises first to eleventh switches and further comprises a set of one or more coupling nodes for coupling the switch network to a fourth capacitor, wherein, in use of the power converter integrated circuit:
the first switch is coupled between a reference voltage supply node of the switch network and the second switch;
the second switch is coupled between the first switch and the third switch;
the third switch is coupled between the second switch and the fourth switch;
the fourth switch is coupled between the third switch and a switch network input node;
the fifth switch is coupled between the reference voltage supply node of the switch network and the sixth switch;
the sixth switch is coupled between the fifth switch and the seventh switch;
the seventh switch is coupled between the sixth switch and the eighth switch;
the eighth switch is coupled between the seventh switch and a switch network node between the second switch and the third switch;
the ninth switch is coupled between the switch network node between the second switch and the third switch and a first terminal of the inductor;
the tenth switch is coupled between the first terminal of the inductor and the reference voltage supply node of the switch network;
the eleventh switch is coupled between the switch network input node and the first terminal of the inductor;
a first terminal of the first capacitor is coupled to a first switch network node between the third and fourth switches;
a second terminal of the first capacitor is coupled to a second switch network node between the first and second switches;
a first terminal of the second capacitor is coupled to a third switch network node between the seventh and eighth switches;
a second terminal of the second capacitor is coupled to a fourth switch network node between the fifth and sixth switches;
a second terminal of the inductor is couplable to an output node of the power converter integrated circuit;
the third capacitor is coupled to the output node of the power converter integrated circuit; and
the fourth capacitor is coupled to the switched network node between the second switch and the third switch and a first terminal of the inductor.

19. The power converter integrated circuit of claim 18, wherein the eighth switch and/or the ninth switch comprises a first MOSFET device and a second MOSFET device, wherein a source terminal of the first MOSFET device is coupled to a source terminal of the second MOSFET device such that an anode of a body diode of the first MOSFET device is coupled to an anode of a body diode of the second MOSFET device.

20. The power converter integrated circuit of claim 1, further comprising an input switch coupled between an input node of the power converter integrated circuit and the switch network.

21. Power converter circuitry comprising switched capacitor power converter circuitry and inductive buck or inductive boost converter circuitry, the power converter circuitry comprising:
a switch network configured to be coupled, in use of the power converter circuitry to:
first and second flying capacitors;
an output capacitor; and
an inductor,
wherein, in use of the power converter circuitry, the switch network, the first and second flying capacitors and the output capacitor are common to both the switched capacitor power converter circuitry and the inductive buck or inductive boost converter circuitry.

22. A battery charging system comprising the power converter integrated circuit of claim 1.

23. A host device comprising the power converter integrated circuit of claim 1, wherein the host device comprises a laptop, notebook, netbook or tablet computer, a gaming device, a games console, a controller for a games console, a virtual reality (VR) or augmented reality (AR) device, a mobile telephone, a portable audio player, a portable device, an accessory device for use with a laptop, notebook, netbook or tablet computer, a gaming device, a games console a VR or AR device, a mobile telephone, a portable audio player or other portable device.
